(19) United States
(12) Patent Application Publication
(10) Pub. No.: US 2023/0322972 A1
(43) Pub. Date: Oct. 12, 2023

(54) Supported Catalyst Systems and Processes for Use Thereof

(71) Applicant: ExxonMobil Chemical Patents Inc., Baytown, TX (US)

(72) Inventors: Matthew W. HOLTCAMP, Huffman, TX (US); Laughlin G. MCCULLOUGH, League City, TX (US); Kevin A. STEVENS, Houston, TX (US); Dongming LI, Houston, TX (US); Robert L. HALBACH, Baytown, TX (US); Ramyaa MATHIALAGAN, Mont Belvieu, TX (US); Charles J. HARLAN, Houston, TX (US); Timothy M. BOLLER, Houston, TX (US)

(21) Appl. No.: 18/043,088

(22) PCT Filed: Sep. 29, 2021
(86) PCT No.: PCT/US2021/052523

§ 371 Date: Feb. 27, 2023

Related U.S. Application Data
(60) Provisional application No. 63/089,349, filed on Oct. 8, 2020.

(51) Int. Cl. C08F 4/76; C08F 4/02; C08F 4/80; C08F 210/16; C08F 2/34

(52) U.S. Cl. CPC C08F 4/76; C08F 4/025; C08F 4/80; C08F 210/16; C08F 2/34; C08F 2410/06; C08F 2420/08

(57) ABSTRACT

This invention relates to a supported catalyst system comprising: (i) at least one first catalyst component comprising a group 4 metallocycle containing metallocene complex; (ii) at least one second catalyst component comprising a 2,6-bis(imino)pyridyl iron complex; (iii) activator; and (iv) support. The catalyst system may be used for preparing polyolefins, such a bimodal polyethylene, typically in a gas phase polymerization.

### CROSS-REFERENCE OF RELATED APPLICATIONS

This application claims the benefit of and priority to U.S. Provisional Application No. 63/089,349 filed Oct. 8, 2020, the disclosure of which is incorporated herein by reference.

This application is related to PCT Application No. PCT/US2020/043869, filed Jul. 20, 2020, the disclosure of which is incorporated herein by reference in its entirety.

### FIELD OF THE INVENTION

The present disclosure relates to mixed catalyst systems comprising a group 4 metallocycle containing metallocene complex and a 2,6-bis(imino)pyridyl iron complex, polyolefins, such polyethylene, compositions made therefrom and articles made therefrom.

### BACKGROUND OF THE INVENTION

Olefin polymerization catalysts are of great use in industry to produce olefin polymers. Hence, there is strong interest in finding new catalyst systems to use in polymerization processes that increase the commercial usefulness of the catalyst systems and allow the production of polyolefin polymers having improved properties or a new combination of properties.

Catalysts for olefin polymerization can be based on group 4 metallocene complexes as catalyst precursors, which are activated typically by an alumoxane or an activator containing a non-coordinating anion.

Gies, A. P. et al. (2017) “Mass Spectrometric Mechanistic Investigation of Ligand Modification in Hafnocene-Catalyzed Olefin Polymerization,” Organometallics, v.36(18), pp. 3443-3455 discloses a cyclometallated metallocene of Me₂Hf(nPrCp)² used for ethylene-hexene copolymerization.

Alt, H. G. et al. (2006) “Metallacyclic Metallocene Complexes as Catalysts for Olefin Polymerization,” Coordination Chemistry Reviews, v.250, pp. 2-17 provides a review on metallocycles with focus on zirconocene metallocycles.

Hafnocene metallocycles tend to broaden in molecular weight distribution in the presence of hexene. (See WO2021/025904, published Feb. 11, 2021, which claims priority to U.S. Ser. No. 62/882,091, filed Aug. 2, 2019).

Iron-containing catalysts have been shown to be high activity catalysts capable of forming polyethylene. Typical iron-containing catalysts have a nitrogen atom of a heterocyclic moiety (such as pyridine) that chelates the iron atom. More specifically, iron-containing catalysts are typically tridentate in that they have a pyridyl ligand and two imine ligands that each chelate the iron atom. Chelation of a nitrogen atom of the pyridyl and imine ligands to the iron atom occurs via the lone pair of π-electrons on each of the nitrogen atoms. Such iron-containing catalysts, for example 2,6-bis(imino)pyridyliron(II) dihalide, typically provide low molecular weight polymers. (Zhang, W. et al. (2013) “Tailoring Iron Complexes for Ethylene Oligomerization and/or Polymerization,” Dalton Trans., v.42, pp. 8988-8997; Small, B. L. (2015) “Discovery and Development of Pyridine-bis(imine) and Related Catalysts for Olefin Polymerization and Oligomerization,” Acc. Chem. Res., v.48, pp. 2599-2611). Other iron-containing catalysts include 2-[1-(2,6-dibenzhydryl-4-methylphenylimino)ethyl]-6-[1-(aryl-imino)-ethyl]pyridyl iron catalysts. Some of these catalysts have relatively high activity but produce low molecular weight polymers and don't incorporate linear alpha olefins with narrow molecular weight distribution. Commonly, such iron-containing catalysts have low/poor solubility in hydrophobic solvents used in polymerizations, such as gas phase polymerizations to form polyethylenes.

US2021/0179650, published Jun. 17, 2021 discloses 2,6-bis(imino)pyridyl iron compounds.

Catalysts are often combined with other catalysts to attempt to modify polymer properties. See, for example, U.S. Pat. Nos. 8,088,867 and 5,516,848 (which discloses the use of two different cyclopentadienyl based transition metal compounds activated with alumoxane or non-coordinating anions).

It is advantageous to use mixed catalyst systems on a support to produce in reactor polyethylene blends in which polymers of different comonomer content, molecular weight, and polydispersity are intimately combined on a molecular level. Superior performance properties can be achieved as well as lower energy paths to processing the polymers can be obtained.

There is a need for catalysts capable of forming polyolefins. In particular, there is a need to develop new and improved mixed catalysts systems capable of forming polymers having high or low molecular weight, low comonomer content, and controlled molecular weight distribution. The ability to slightly or dramatically alter the polydispersity index of polymers at a given comonomer content derived from particular catalysts families are of great need.

New mixed catalyst systems are provided herein as well as polymerization processes therewith, that provide new copolymers having good properties that can be produced with increased reactor throughput and at higher polymerization temperatures during polymer production.

There is still a need in the art for new and improved catalyst systems for the polymerization of olefins, in order to achieve increased activity or enhanced polymer properties, such as molecular weight control over a range of process conditions, to increase conversion or comonomer incorporation, or to alter comonomer distribution to improve upon a polymer's properties.

It is also an object of the present invention to provide novel supported catalysts systems and processes for the polymerization of olefins (such as ethylene) using such catalyst systems.

Additional references of interest include: U.S. Pat. Nos. 7,179,876; 8,227,557; 8,859,451; WO 2005/103095; WO 2005/103096; WO 2005/103100; U.S. Pat. Nos. 7,723,448; 9,000,113; 8,252,875; 8,999,875; 8,664,140; 8,722,833; US 2013/0345378; EP 2003166 A1; WO 2007/080081; US 2019/0144577; US 2018/0334517; US 2018/0237554; US 2018/0237558; US 2018/0237559; WO 2018/067259; KR 2015/066484; US 2018/0265605; KR 2015058054; WO2021/162745, Miyake, S. et al. (1998) “Synthesis, Molecular Structure. and Racemate-Meso Intercoversion for rac-(Mₑ₂Si)₂{^{η5}-_{C5}H-3-(CHMₑ₂)-5-Me}₂MC_{I2}(M+Ti and Zr),” Organometallics, v.17(25), pp. 5528-5533; Licht, A. I., et al. (2003) “CH-Aktivierungsreaktionen an substituierten Zirconocenkomplexen undderen Verwendung in der katalytischen Ethylenpolymerisation.” J. of Organometallic Chem., v.684, pp. 91-104; Siedle, A. R, et al. (1995) “Stereochemical Nonrigidity in Metallocenium Ions,” J. of Organometallic Chem., v.497, pp. 119-125; Baier, M. C. (2014) “Post-Metallocenes in the Industrial Production of Polyolefins,” Angew. Chem. Int. Ed., v.53, pp. 9722-9744; Cámpora, J., et al. (2005) “2,6-Diiminopyridine Iron(II) Dialkyl Complexes. Interaction with Aluminum Alkyls and Ethylene Polymerization Catalysis” Organometallics, v.24(21), pp. 4878-4881; Bradley, D. et al. (2010) “Drying of Organic Solvents: Quantitative Evaluation of the Efficiency of Several Desiccants,” J. Org. Chem., v.75(24), pp. 8351-8354; Britovsek, G. et al. (1999) “Iron and Cobalt Ethylene Polymerization Catalysts Bearing 2,6-Bis(Imino) Pyridyl Ligands: Synthesis. Structures. and Polymerization Studies.” J. Am. Chem. Soc., v.121(38), pp. 8728-8740; Ionkin, A. S. et al. (2006) “High-Temperature Catalysts for the Production of a-Olefins Based on Iron(II) and Iron(III) Tridentate Bis(imino)pyridine Complexes with Double Pattern of Substitution: ortho-Methyl plus meta-Aryl.” Organometallics. v.25(12), pp. 2978-2992; and Small, B. (2015) “Discovery and Development of Pyridine-bis(imine) and Related Catalysts for Olefin Polymerization and Oligomerization.” Acc. Chem. Res., v.48(9), pp. 2599-2611.

### SUMMARY OF INVENTION

This invention relates to a supported catalyst system comprising: (i) at least one first catalyst component comprising a group 4 metallocycle containing metallocene complex; (ii) at least one second catalyst component comprising a 2,6-bis(imino)pyridyl iron complex; (iii) activator; and (iv) a support; wherein, the group 4 metallocycle containing metallocene complex is preferably represented by Formula (A):

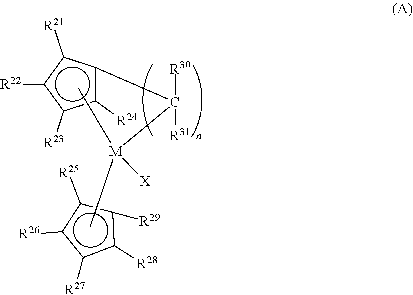

wherein:
M is hafnium;
each of R²¹, R²², R²³, R²⁴, R²⁵, R²⁶, R²⁷, R²⁸, and R²⁹ is independently hydrogen, alkoxide, C₁ to C₄₀ hydrocarbyl, or C₁ to C₄₀ substituted hydrocarbyl or any of two of R²¹, R²², R²³, and R²⁴, or any two of R²⁵, R²⁶, R²⁷, R²⁸, and R²⁹ may form a cyclic or multicyclic groups;
X is a univalent anionic ligand;
each of R³⁰ and R³¹ is independently hydrogen, a C₁-C₂₀ hydrocarbyl, a C₁-C₂₀ substituted hydrocarbyl, or R³⁰ and R³¹ join to form a C₂-C₄₀ substituted or unsubstituted, saturated, partially unsaturated, or unsaturated cyclic or polycyclic substituent;
n is 1, 2, 3, 4, 5, or 6; and
   the 2,6-bis(imino)pyridyl iron complex is preferably represented by Formula (I):

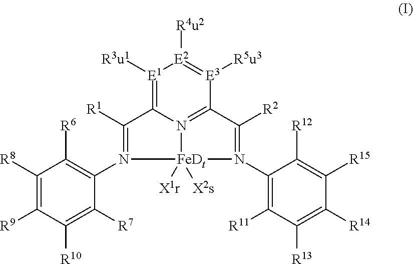

wherein:
each of R¹ and R² is independently hydrogen, C₁-C₂₂ alkyl, C₂-C₂₂ alkenyl, C₆-C₂₂ aryl, arylalkyl wherein alkyl has from 1 carbon atom to 10 carbon atoms and aryl has from 6 carbon atoms to 20 carbon atoms, or five-, or six-, or seven-membered heterocyclic ring comprising at least one atom selected from the group consisting of N, P, O and S; wherein each of RI and R² is optionally substituted by halogen, —OR¹⁶, —NR¹⁷₂, or —SiR¹⁸₃; wherein RI optionally bonds with R³, and R² optionally bonds with R⁵, in each case to independently form a five-, six-, or seven-membered ring;
each of R³, R⁴, R⁵, R⁸, R⁹, R¹⁰, R¹³, R¹⁴ and R¹⁵ is independently hydrogen, C₁-C₂₂ alkyl, C₂-C₂₂ alkenyl, C₆-C₂₂ aryl, arylalkyl wherein alkyl has from 1 to 10 carbon atoms and aryl has from 6 to 20 carbon atoms, —OR¹⁶, —NR¹⁷₂, halogen, —SiR¹⁸₃ or five-, six- or seven-membered heterocyclic ring comprising at least one atom selected from the group consisting of N, P, O and S;
wherein R³, R⁴, R⁵, R⁸, R⁹, R¹⁰, R¹³, R¹⁴, and R¹⁵ are optionally substituted by halogen, —OR¹⁶, —NR¹⁷₂, or —SiR¹⁸₃; wherein R³ optionally bonds with R⁴, R⁴ optionally bonds with R⁵, R⁷ optionally bonds with R¹⁰, R¹⁰ optionally bonds with R⁹, R⁹ optionally bonds with R⁸, R⁸ optionally bonds with R⁶, R¹⁵ optionally bonds with R¹⁴, R¹⁴ optionally bonds with R¹³, and R¹³ optionally bonds with R¹¹, in each case to independently form a five-, six- or seven-membered carbocyclic or heterocyclic ring, the heterocyclic ring comprising at least one atom from the group consisting of N, P, O and S;
each of R⁶, R⁷, R¹¹, and R¹² is independently C₁-C₂₂ alkyl, C₂-C₂₂ alkenyl, C₆-C₂₂ aryl, arylalkyl wherein alkyl has from 1 to 10 carbon atoms and aryl has from 6 to 20 carbon atoms, a heteroatom or a heteroatom-containing group (such as —OR¹⁶, —NR¹⁷₂, halogen, —SiR¹⁸₃ or five-, six- or seven-membered heterocyclic ring comprising at least one atom selected from the group consisting of N, P, O and S); wherein R⁶, R⁷, R¹¹, and R¹² are optionally substituted by halogen, —OR¹⁶, —NR¹⁷₂, or —SiR¹⁸₃, wherein R⁶ optionally bonds with R⁸, R¹¹ optionally bonds with R¹³, or R¹⁵ optionally bonds with R¹² in each case to independently form a five-, six- or seven-membered carbocyclic or heterocyclic ring, the heterocyclic ring comprising at least one atom from the group consisting of N, P, O and S; wherein at least one of R⁶, R⁷, R¹¹, and R¹² is independently a heteroatom or a heteroatom-containing group, or at least one of the R⁶, R⁷, R¹¹, and R¹² is not methyl, or if R¹¹ is H and R¹² is iPr, then at least one of R⁶ and R⁷ is not methyl;
each of R¹⁶, R¹⁷, and R¹⁸ is independently hydrogen, C₁-C₂₂ alkyl, C₂-C₂₂ alkenyl, C₆-C₂₂ aryl, arylalkyl where alkyl has from 1 to 10 carbon atoms and aryl has from 6 to 20 carbon atoms, or —SiR¹⁹₃, wherein each R¹⁶, R¹⁷, and R¹⁸ is independently optionally substituted by halogen, or two R¹⁶ radicals optionally bond to form a five- or six-membered ring, or two R¹⁷ radicals optionally bond to form a five- or six-membered ring, or two R¹⁸ radicals optionally bond to form a five- or six-membered ring;
each R¹⁹ is independently hydrogen, C₁-C₂₂ alkyl, C₂-C₂₂ alkenyl, C₆-C₂₂ aryl, arylalkyl where alkyl has from 1 to 10 carbon atoms and aryl has from 6 to 20 carbon atoms, or two R¹⁹ radicals optionally bond to form a five- or six-membered ring;
each of E¹, E², and E³ is independently carbon, nitrogen or phosphorus;
each of u¹, u², and u³ is independently 0 if E¹, E², or E³ is nitrogen or phosphorus, and each of u¹, u², and u³ is independently 1 if E¹, E², or E³ is carbon;
each of X¹ and X² is independently substituted hydrocarbyl, and the radicals X can be bonded with one another;
r is 1 or 2;
s is 1 or 2;
D is a neutral donor; and
t is 0 to 2.

This invention also relates to a process for polymerization of monomers (such as olefin monomers) comprising contacting one or more monomers with the above supported catalyst systems.

This invention also relates to a process to produce ethylene polymer compositions comprising: i) contacting in a single reaction zone, in the gas phase or slurry phase, ethylene and C₃ to C₂₀ comonomer with the catalyst system described above.

In another class of embodiments, the invention provides for articles made from the polyolefin composition and processes for making the same.

### BRIEF DESCRIPTION OF THE DRAWINGS

FIG. 1 (FIG. 1) is a plot of GPC results illustrating the molecular weight distribution and hexene comonomer (C₆) distribution of examples 1 and 2.

### DETAILED DESCRIPTION

### Definitions

For the purposes of this invention and the claims thereto, the new numbering scheme for the Periodic Table Groups is used as described in Chemical and Engineering News, v.63(5), pg. 27 (1985). Therefore, a “group 4 metal” is an element from group 4 of the Periodic Table, e.g. Hf, Ti, or Zr.

For purposes of this invention and the claims thereto, a “catalyst system” is a combination of at least two catalyst compounds, an activator, and a support material. The catalyst systems may further comprise one or more additional catalyst compounds. The terms “mixed catalyst system”, “dual catalyst system”, “mixed catalyst”, and “supported catalyst system” may be used interchangeably herein with “catalyst system.” For the purposes of this invention and the claims thereto, when catalyst systems are described as comprising neutral stable forms of the components, it is well understood by one of ordinary skill in the art, that the ionic form of the component is the form that reacts with the monomers to produce polymers.

The term “complex” is used to describe molecules in which an ancillary ligand is coordinated to a central transition metal atom. The ligand is bulky and stably bonded to the transition metal so as to maintain its influence during use of the catalyst, such as polymerization. The ligand may be coordinated to the transition metal by covalent bond and/or electron donation coordination or intermediate bonds. The transition metal complexes are generally subjected to activation to perform their polymerization function using an activator which is believed to create a cation as a result of the removal of an anionic group, often referred to as a leaving group, from the transition metal. “Complex,” as used herein, is also often referred to as “catalyst precursor”, “pre-catalyst”, “catalyst”, “catalyst compound”, “metal compound”, “transition metal compound”, or “transition metal complex”. These words are used interchangeably.

As used herein, “polymerization catalyst(s)” refers to any catalyst, typically an organometallic complex or compound that is capable of coordination polymerization, i.e., where successive monomers are added in a monomer chain at the organometallic active center to create and/or grow a polymer chain.

The terms “activator” and “cocatalyst” are used herein interchangeably and are defined to be any compound which can activate any one of the catalyst compounds herein by converting the neutral catalyst compound to a catalytically active catalyst compound cation.

The term “contact product” or “the product of the combination of” is used herein to describe compositions wherein the components are contacted together in any order, in any manner, and for any length of time. For example, the components can be contacted by blending or mixing. Further, contacting of any component can occur in the presence or absence of any other component of the compositions described herein. Combining additional materials or components can be done by any suitable method. Further, the term “contact product” includes mixtures, blends, solutions, slurries, reaction products, and the like, or combinations thereof. Although “contact product” can include reaction products, it is not required for the respective components to react with one another or react in the manner as theorized. Similarly, the term “contacting” is used herein to refer to materials which may be blended, mixed, slurried, dissolved, reacted, treated, or otherwise contacted in some other manner.

The terms “substituent,” “radical,” “group,” and “moiety” may be used interchangeably.

Unless otherwise specified, the term “Cn” means hydrocarbon(s) having n carbon atom(s) per molecule, wherein n is a positive integer.

As used herein, and unless otherwise specified, the term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of Cn.

The terms “hydrocarbyl,” “hydrocarbyl radical” and “hydrocarbyl group” are used interchangeably throughout this document. For purposes of this invention, “hydrocarbyl radical” is defined to be, a radical consisting of carbon and hydrogen, such as a C₁-C₁₀₀ radical, that may be linear, branched, or cyclic, and when cyclic, aromatic or non-aromatic. Examples of such radicals include, but are not limited to, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues.

For purposes of this invention and claims thereto, unless otherwise indicated (e.g., the definition of “substituted hydrocarbyl” below, etc.), the term “substituted” means that a hydrogen group has been replaced with at least one non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “ring atom” means an atom that is part of a cyclic ring structure. By this definition, a benzyl group has six ring atoms and tetrahydrofuran has 5 ring atoms.

A “ring carbon atom” is a carbon atom that is part of a cyclic ring structure. By this definition, a benzyl group has six ring carbon atoms and para-methylstyrene also has six ring carbon atoms.

The term “aryl” or “aryl group” means an aromatic ring (typically made of 6 carbon atoms) and the substituted variants thereof, such as phenyl, 2-methyl-phenyl, xylyl, 4-bromo-xylyl. Likewise, heteroaryl means an aryl group where a ring carbon atom (or two or three ring carbon atoms) has been replaced with a heteroatom, such as N, O, or S.

Unless otherwise indicated, the term “aromatic” refers to unsaturated cyclic hydrocarbons having a delocalized conjugated π system and having from 5 to 20 carbon atoms (aromatic C₅-C₂₀ hydrocarbon), particularly from 5 to 12 carbon atoms (aromatic C₅-C₁₂ hydrocarbon), and particularly from 5 to 10 carbon atoms (aromatic C₅-C₁₂ hydrocarbon). Exemplary aromatics include, but are not limited to benzene, toluene, xylenes, mesitylene, ethylbenzenes, cumene, naphthalene, methylnaphthalene, dimethylnaphthalenes, ethylnaphthalenes, acenaphthalene, anthracene, phenanthrene, tetraphene, naphthacene, benzanthracenes, fluoranthrene, pyrene, chrysene, triphenylene, and the like, and combinations thereof. As used herein, the term “aromatic” also refers to pseudoaromatic heterocycles which are heterocyclic substituents that have similar properties and structures (nearly planar) to aromatic heterocyclic ligands, but are not by definition (Hickle rule) aromatic.

A “heterocyclic ring” is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring.

The terms “alkoxy” or “alkoxide” and “aryloxy” or “aryloxide” mean an alkyl or aryl group bound to an oxygen atom, such as an alkyl ether or aryl ether group/radical connected to an oxygen atom and can include those where the alkyl group is a C₁ to C₁₀ hydrocarbyl. The alkyl group may be straight chain, branched, or cyclic. The alkyl group may be saturated or unsaturated. Examples of suitable alkoxy and aryloxy radicals can include methoxy, ethoxy, n-propoxy, iso-propoxy, n-butoxy, iso-butoxy, sec-butoxy, tert-butoxy, phenoxyl, and the like.

The terms “alkyl,” and “alkyl radical” are used interchangeably throughout this disclosure. For purposes of this disclosure, “alkyl radical” is defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues. Substituted alkyl radicals are radicals in which at least one hydrogen atom of the alkyl radical has been substituted with at least a non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

A “halocarbyl” is a halogen substituted hydrocarbyl group.

A “substituted phenolate” is a phenolate group where at least one, two, three, four or five hydrogen atoms in the 2, 3, 4, 5, and/or 6 positions has been replaced with at least one non-hydrogen group, such as a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)_{q}—SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), where the 1 position is the phenolate group (Ph-O—, Ph-S—, and Ph-N(R\hat{ })— groups, where R\hat{ } is hydrogen, C₁-C₄₀ hydrocarbyl, C₁-C₄₀ substituted hydrocarbyl, a heteroatom or a heteroatom-containing group). Preferably, a “substituted phenolate” group in the catalyst compounds described herein is represented by the formula:

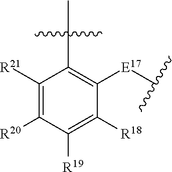

where R¹⁸ is hydrogen, C₁-C₄₀ hydrocarbyl (such as C₁-C₄₀ alkyl) or C₁-C₄₀ substituted hydrocarbyl, a heteroatom or a heteroatom-containing group, E¹⁷ is oxygen, sulfur, or NR¹⁷, and each of R¹⁷, R¹⁹, R²⁰, and R²¹ is independently selected from hydrogen, C₁-C₄₀ hydrocarbyl (such as C₁-C₄₀ alkyl) or C₁-C₄₀ substituted hydrocarbyl, a heteroatom or a heteroatom-containing group, or two or more of R¹⁸, R¹⁹, R²⁰, and R²¹ are joined together to form a C₄-C₆₂ cyclic or polycyclic ring structure, or a combination thereof, and the wavy lines show where the substituted phenolate group forms bonds to the rest of the catalyst compound.

An “alkyl substituted phenolate” is a phenolate group where at least one, two, three, four or five hydrogen atoms in the 2, 3, 4, 5, and/or 6 positions has been replaced with at least one alkyl group, such as a C₁ to C₄₀, alternately C₂ to C₂₀, alternately C₃ to C₁₂ alkyl, such as methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, adamantanyl and the like including their substituted analogues.

An “aryl substituted phenolate” is a phenolate group where at least one, two, three, four or five hydrogen atoms in the 2, 3, 4, 5, and/or 6 positions has been replaced with at least one aryl group, such as a Ci to C₄₀, alternately C₂ to C₂₀, alternately C₃ to C₁₂ aryl group, such as phenyl, 4-fluorophenyl, 2-methylphenyl, 2-propylphenyl, 2,6-dimethylphenyl, mesityl, 2-ethylphenyl, naphthalenyl and the like including their substituted analogues.

For purposes of the present disclosure, in relation to catalyst compounds (e.g., substituted metallocycle containing metallocene catalyst compounds), the term “substituted” means that a hydrogen group has been replaced with a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

An “anionic ligand” is a negatively charged ligand which donates one or more pairs of electrons to a metal ion. The term “anionic donor” is used interchangeably with “anionic ligand”. Examples of anionic donors in the context of the present invention include, but are not limited to, methyl, chloride, fluoride, alkoxide, aryloxide, alkyl, alkenyl, thiolate, carboxylate, amido, methyl, benzyl, hydrido, amidinate, amidate, and phenyl. Two anionic donors may be joined to form a dianionic group.

A “neutral Lewis base or “neutral donor group” is an uncharged (i.e. neutral) group which donates one or more pairs of electrons to a metal ion. Non-limiting examples of neutral Lewis bases include ethers, thioethers, amines, phosphines, ethyl ether, tetrahydrofuran, dimethylsulfide, triethylamine, pyridine, alkenes, alkynes, allenes, and carbenes. Lewis bases may be joined together to form bidentate or tridentate Lewis bases.

For purposes of this invention and the claims thereto, phenolate donors include Ph-O—, Ph-S—, and Ph-N(R\hat{ })— groups, where R\hat{ } is hydrogen, C₁-C₄₀ hydrocarbyl, C₁-C₄₀ substituted hydrocarbyl, a heteroatom or a heteroatom-containing group, and Ph is optionally substituted phenyl.

A tertiary hydrocarbyl group possesses a carbon atom bonded to three other carbon atoms. When the hydrocarbyl group is an alkyl group, tertiary hydrocarbyl groups are also referred to as tertiary alkyl groups. Examples of tertiary hydrocarbyl groups include tert-butyl, 2-methylbutan-2-yl, 2-methylhexan-2-yl, 2-phenylpropan-2-yl, 2-cyclohexylpropan-2-yl, 1-methylcyclohexyl, 1-adamantyl, bicyclo[2.2.1]heptan-1-yl and the like. Tertiary hydrocarbyl groups can be illustrated by Formula (A):

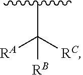

wherein R^{A}, R^{B} and R^{C} are hydrocarbyl groups or substituted hydrocarbyl groups that may optionally be bonded to one another, and the wavy line shows where the tertiary hydrocarbyl group forms bonds to other groups.

A cyclic tertiary hydrocarbyl group is defined as a tertiary hydrocarbyl group that forms at least one alicyclic (non-aromatic) ring. Cyclic tertiary hydrocarbyl groups are also referred to as alicyclic tertiary hydrocarbyl groups. When the hydrocarbyl group is an alkyl group, cyclic tertiary hydrocarbyl groups are also referred to as cyclic tertiary alkyl groups or alicyclic tertiary alkyl groups. Examples of cyclic tertiary hydrocarbyl groups include 1-adamantanyl, 1-methylcyclohexyl, 1-methylcyclopentyl, 1-methylcyclooctyl, 1-methylcyclodecyl, 1-methylcyclododecyl, bicyclo[3.3.1]nonan-1-yl, bicyclo[2.2.1]heptan-1-yl, bicyclo[2.3.3]hexan-1-yl, bicycle[1.1.1]pentan-1-yl, bicycle[2.2.2]octan-1-yl, and the like. Cyclic tertiary hydrocarbyl groups can be illustrated by Formula (B):

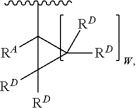

wherein R^{A} is a hydrocarbyl group or substituted hydrocarbyl group, each R¹¹ is independently hydrogen or a hydrocarbyl group or substituted hydrocarbyl group, w is an integer from 1 to about 30, and R^{A}, and one or more R^{D}, and or two or more R^{D} may optionally be bonded to one another to form additional rings.

When a cyclic tertiary hydrocarbyl group contains more than one alicyclic ring, it can be referred to as polycyclic tertiary hydrocarbyl group or if the hydrocarbyl group is an alkyl group, it may be referred to as a polycyclic tertiary alkyl group.

The term “continuous” means a system that operates without interruption or cessation. For example, a continuous process to produce a polymer would be one where the reactants are continually introduced into one or more reactors and polymer product is continually withdrawn.

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer.

The term “alpha-olefin” refers to an olefin having a terminal carbon-to-carbon double bond in the structure thereof ((R¹R²)—C═CH₂, where R¹ and R² can be independently hydrogen or any hydrocarbyl group; preferably R¹ is hydrogen and R² is an alkyl group). A “linear alpha-olefin” is an alpha-olefin defined in this paragraph wherein R¹ is hydrogen, and R² is hydrogen or a linear alkyl group.

For the purposes of this invention, ethylene shall be considered an α-olefin.

A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different” as used to refer to mer units indicates that the mer units differ from each other by at least one atom or are different isomerically. Accordingly, the definition of copolymer, as used herein, includes terpolymers and the like. An “ethylene polymer” or “ethylene copolymer” is a polymer or copolymer comprising at least 50 mol % ethylene derived units, a “propylene polymer” or “propylene copolymer” is a polymer or copolymer comprising at least 50 mol % propylene derived units, and so on.

For purposes of this invention and the claims thereto, an ethylene polymer having a density of 0.86 g/cm³ or less is referred to as an ethylene elastomer or elastomer; an ethylene polymer having a density of more than 0.86 to less than 0.910 g/cm³ is referred to as an ethylene plastomer or plastomer; an ethylene polymer having a density of 0.910 to 0.940 g/cm³ is referred to as a low density polyethylene; and an ethylene polymer having a density of more than 0.940 g/cm³ is referred to as a high density polyethylene (HDPE). Density is determined according to ASTM D 1505 using a density-gradient column on a compression-molded specimen that has been slowly cooled to room temperature (i.e., over a period of 10 minutes or more) and allowed to age for a sufficient time that the density is constant within +/−0.001 g/cm³).

Polyethylene in an overlapping density range, i.e., 0.890 to 0.930 g/cm³, typically from 0.915 to 0.930 g/cm³, which is linear and does not contain long chain branching is referred to as “linear low density polyethylene” (LLDPE) and can be produced with conventional Ziegler-Natta catalysts, vanadium catalysts, or with metallocene catalysts in gas phase reactors and/or in slurry reactors and/or in solution reactors. “Linear” means that the polyethylene has no long chain branches, typically referred to as a branching index (g′ᵥᵢₛ) of 0.97 or above, preferably 0.98 or above. Branching index, gᵥᵢₛ′, is determined by GPC as described below.

As used herein, Mn is number average molecular weight, Mw is weight average molecular weight, Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are reported in g/mol (g mol⁻¹).

The following abbreviations may be used herein: Me is methyl, Et is ethyl, Pr is propyl, cPr is cyclopropyl, nPr is n-propyl, iPr is isopropyl, Bu is butyl, nBu is normal butyl, iBu is isobutyl, sBu is sec-butyl, tBu is tert-butyl, Cy is cyclohexyl, Oct is octyl, Ph is phenyl, dme is 1,2-dimethoxyethane, p-tBu is para-tertiary butyl, TMS is trimethylsilyl, TIBAL is triisobutylaluminum, TNOAL is tri(n-octyl)aluminum, p-Me is para-methyl, Bz and Bn are benzyl (i.e., CH₂Ph), THF (also referred to as thf) is tetrahydrofuran, RT is room temperature (and is 23° C. unless otherwise indicated), tol is toluene, EtOAc is ethyl acetate, Cbz is Carbazole, Np is neopentyl, Cp is cyclopentadienyl, Cp* is pentamethyl cyclopentadienyl, Ind is indenyl, Flu is fluorenyl, and MAO is methylalumoxane.

### Description

This invention relates to catalyst systems and their use in polymerization processes to produce polyolefin polymers such as polyethylene polymers and polypropylene polymers.

In another class of embodiments, the present disclosure is directed to polymerization processes to produce polyolefin polymers from catalyst systems comprising the product of the combination of two or more olefin polymerization catalysts, at least one activator, and at least one support.

In particular, the present disclosure is directed to a polymerization process to produce an ethylene polymer, the process comprising contacting a catalyst system comprising the product of the combination of two or more catalysts, at least one activator, and at least one support, with ethylene and one or more C₃-C₁₀ alpha-olefin comonomers under polymerization conditions.

This invention also relates to a supported catalyst system comprising: (i) at least one first catalyst component comprising a group 4 metallocycle containing metallocene complex; (ii) at least one second catalyst component comprising a 2,6-bis(imino)pyridyl iron complex; (iii) activator; and (iv) a support; wherein, the group 4 metallocycle containing metallocene complex is preferably represented by Formula (A) as described herein; and the 2,6-bis(imino)pyridyl iron complex is preferably represented by Formula (I) as described herein.

### Group 4 Metallocycle Containing Metallocene Complexes

Group 4 metallocycle containing metallocene complexes useful herein include those represented by Formula (A):

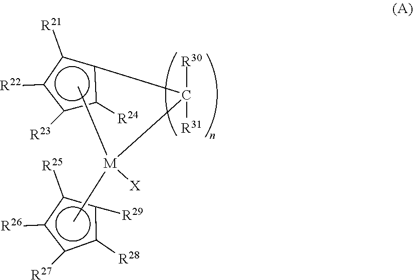

wherein:
M is hafnium;
each of R²¹, R²², R²³, R²⁴, R²⁵, R²⁶, R²⁷, R²⁸, and R²⁹ is independently hydrogen, alkoxide, C₁ to C₄₀ hydrocarbyl, or C₁ to C₄₀ substituted hydrocarbyl, or any of two of R²¹, R²², R²³, and R²⁴, or any two of R²⁵, R²⁶, R²⁷, R²⁸, and R²⁹ may form a cyclic or multicyclic groups;
X is a univalent anionic ligand, or X¹ and X² are joined to form a metallocycle ring;
each of R³⁰ and R³¹ is independently hydrogen, a C₁-C₂₀ hydrocarbyl, a C₁-C₂₀ substituted hydrocarbyl, or R³⁰ and R³¹ join to form a C₂-C₄₀ substituted or unsubstituted, saturated, partially unsaturated, or unsaturated cyclic or polycyclic substituent;
n is 1, 2, 3, 4, 5, or 6.

In embodiments, X is a halide (such as chloro, fluoro, bromo or iodo) or a C₁-C₂₀ hydrocarbyl (such as a C₁ to C₁₂ alkyl, such as methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, nonyl, decyl, undecyl, docecyl).

Preferably X is methyl, chloro, ethyl, hexyl, or butyl.

In at least one embodiment, at least one, two, three, or all four of R²¹, R²², R²³ and R²⁴ is independently hydrogen, a C₁ to C₄₀ (such as C₁ to C₂₀) hydrocarbyl (such as alkyl), or a C₁ to C₄₀ (such as C₁ to C₂₀) substituted hydrocarbyl (such as substituted alkyl). Alternately, at least one, two, three, or all four of R²¹, R²², R²³ and R²⁴ is independently hydrogen, methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, nonyl, decyl, undecyl, docecyl, adamantanyl or an isomer thereof.

Alternately, at least one, two, three or all four of R²¹, R²², R²³ and R²⁴ is hydrogen.

In at least one embodiment, each of R²¹ and R²² together do not form a ring and or each of R²² and R²³ together do not form a ring, or each of R²³ and R²⁴ together do not form a ring, or each of R²⁴ and R²⁵ together do not form a ring. In another embodiment, each of R²⁵ and R²⁶ together do not form a ring and or each of R²⁶ and R²⁷ together do not form a ring, or each of R²⁷ and R²⁸ together do not form a ring, or each of R²⁸ and R²⁹ together do not form a ring, or each of R²⁹ and R²⁵ together do not form a ring.

In at least one embodiment, R²¹, R²², R²³ and R²⁴ are hydrogen.

In at least one embodiment, R²¹, is C₁ to C₁₀ alkyl, such as methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, nonyl, decyl, such as n-propyl.

In at least one embodiment, R²¹, is C₁ to C₁₀ alkyl, such as methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, nonyl, decyl, such as n-propyl, and R²², R²³ and R²⁴ are hydrogen.

Alternately, at least one, two, three or all four of R²¹, R²², R²³ and R²⁴ is hydrogen.

In at least one embodiment, at least one, two, three, four or all five of R²⁵, R²⁶, R²⁷, R²⁸ and R²⁹ is independently hydrogen, a C₁ to C₄₀ (such as C₁ to C₂₀) hydrocarbyl (such as alkyl), or a C₁ to C₄₀ (such as C₁ to C₂₀) substituted hydrocarbyl (such as substituted alkyl). Alternately, at least one, two, three, four or all five of R²⁵, R²⁶, R²⁷, R²⁸ and R²⁹ is independently hydrogen, methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, nonyl, decyl, undecyl, docecyl, adamantanyl or an isomer thereof.

In at least one embodiment, at least one, two, three, or four of R²¹, R²², R²³, R²⁴, is not hydrogen and at least one, two, three, four or five of R²⁵, R²⁶, R²⁷, R²⁸, and R²⁹ is not hydrogen.

In embodiments, each of R³⁰ and R³¹ is independently hydrogen, a C₁-C₂₀ (such as a C₁ to C₁₂) hydrocarbyl, a C₁-C₂₀ (such as a C₁ to C₁₂) substituted hydrocarbyl, or R³⁰ and R³¹ join to form a C₂-C₄₀ substituted or unsubstituted, saturated, partially unsaturated, or unsaturated cyclic or polycyclic substituent. Alternately, each of R³⁰ and R³¹ is independently hydrogen or C₁ to C₁₀ alkyl, such as methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, nonyl, or decyl.

Further, n can be 1, 2, 3, 4, 5, or 6, such as n can be 1, 2, 3, 4 or 5, for example n can be 1, 2, or 3. In at least one embodiment, n is 3.

The group 4 metallocycle containing metallocene complex is preferably one or more of: (n-PrCp)(η5,κ1-C₅H₄CH₂CH₂CH₂—)Hf(n-Bu); (n-PrCp)(η5,κ1-C₅H₄CH₂CH₂CH₂—)Hf(n-Et); (Cp)(η5,κ1-C₅H₄CH₂CH₂CH₂—)Hf(n-Bu); (n-Me₃SiCH₂Cp)(η5,κ1-C₅H₄CH₂CH₂CH₂—)Hf(n-Bu); (n-PrCp)(η5,κ1-C₅H₄CH₂CH₂CH₂CH₂—)Hf(n-Bu); (n-BuCp)(η5,κ1-C₅H₄CH₂CH₂CH₂—)Hf(n-Bu); (1-Me,3-nBuCp)(η5,κ1-C₅H₄CH₂CH₂CH₂—)Hf(n-Bu); (Indenyl)(η5,κ1-C₅H₄CH₂CH₂CH₂—)Hf(n-Bu); and (Fluorenyl)(η5,κ1-C₅H₄CH₂CH₂CH₂—)Hf(n-Bu), where Cp is cyclopentadienyl.

### Methods to Prepare the Group 4 Metallocycle Containing Metallocene Complexes Ligand Synthesis

Metallocycles described herein can be prepared by means know in the art, such as by heating for longer time periods. The hafnocene metallocycles appear very robust requiring longer reaction times with heating and result in very distinct clean compounds. For example, a solution of a substituted or unsubstituted bis cyclopentadienyl hafnium compound having two C₁ to C₆ hydrocarbyl leaving groups (such as methyl, ethyl, propyl, butyl pentyl, hexyl or isomers thereof), such as, for example, a toluene solution of bis(n-propylcyclopentadienyl)hafnium dibutyl is heated to 90° C. or more with stirring for at least an hour, cooled, then solvent is removed to obtain the metallocycle complex n-butyl(propylcyclopentadienyl) (propylenecyclopentadienyl)hafnium.

### 2,6-Bis(imino)pyridyl Iron Complexes

As used herein, an “electron deficient side” or “electron withdrawing side” of a catalyst can be a portion of a catalyst that has one or more electron withdrawing groups (such as one, two, three, or more) such that the electron deficient side withdraws electron density toward it and away from an opposing (e.g., electron rich) side of the catalyst.

As used herein, an “electron rich side” or “electron donating side” of a catalyst can be a portion of a catalyst that has one or more electron donating groups (such as one, two, three, or more) such that the electron rich side donates electron density toward an opposing, electron deficient side of the catalyst.

In at least one embodiment, the present disclosure provides iron-containing catalysts having an aryl ligand, such as a 2,6-diiminoaryl ligand.

In at least one embodiment, iron catalyst compounds are also asymmetric, having an electron donating side of the catalyst and an electron deficient side of the catalyst. Furthermore, catalyst compounds of the present disclosure can produce polyolefin polymers with tailored molecular weight (e.g., high molecular weight polyolefin polymers, with an Mw value of 100,000 g/mol or more, or low molecular weight polyolefin polymers, with an Mw value of less than 100,000 g/mol).

The present disclosure relates to catalyst compounds represented by Formula (I):

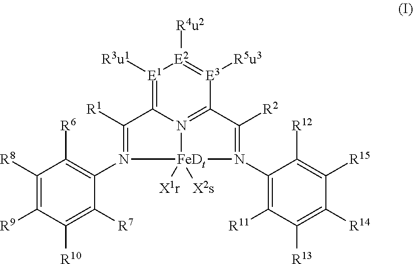

wherein:
each of R¹ and R² is independently hydrogen, C₁-C₂₂ alkyl, C₂-C₂₂ alkenyl, C₆-C₂₂ aryl, arylalkyl wherein alkyl has from 1 carbon atom to 10 carbon atoms and aryl has from 6 carbon atoms to 20 carbon atoms, or five-, or six-, or seven-membered heterocyclic ring comprising at least one atom selected from the group consisting of N, P, O and S; wherein each of R¹ and R² is optionally substituted by halogen, —OR¹⁶, —NR¹⁷₂, or —SiR¹⁸₃; wherein R¹ optionally bonds with R³, and R² optionally bonds with R⁵, in each case to independently form a five-, six-, or seven-membered ring;
each of R³, R⁴, R⁵, R⁸, R⁹, R¹⁰, R¹³, R¹⁴, and R¹⁵ is independently hydrogen, C₁-C₂₂ alkyl, C₂-C₂₂ alkenyl, C₆-C₂₂ aryl, arylalkyl wherein alkyl has from 1 to 10 carbon atoms and aryl has from 6 to 20 carbon atoms, —OR¹⁶, —NR¹⁷₂, halogen, —SiR¹⁸₃ or five-, six- or seven-membered heterocyclic ring comprising at least one atom selected from the group consisting of N, P, O and S;
wherein R³, R⁴, R⁵, R⁸, R⁹, R¹⁰, R¹³, R¹⁴, and R¹⁵ are optionally substituted by halogen, —OR¹⁶, —NR¹⁷₂, or —SiR¹⁸₃; wherein R³ optionally bonds with R⁴, R⁴ optionally bonds with R⁵, R⁷ optionally bonds with R¹⁰, R¹⁰ optionally bonds with R⁹, R⁹ optionally bonds with R⁸, R⁸ optionally bonds with R⁶, R¹⁵ optionally bonds with R¹⁴, R¹⁴ optionally bonds with R¹³, and R¹³ optionally bonds with R¹¹, in each case to independently form a five-, six- or seven-membered carbocyclic or heterocyclic ring, the heterocyclic ring comprising at least one atom from the group consisting of N, P, O and S;
each of R⁶, R⁷, R¹¹, and R¹² is independently C₁-C₂₂ alkyl, C₂-C₂₂ alkenyl, C₆-C₂₂ aryl, arylalkyl wherein alkyl has from 1 to 10 carbon atoms and aryl has from 6 to 20 carbon atoms, a heteroatom or a heteroatom-containing group (such as —OR¹⁶, —NR¹⁷₂, halogen, —SiR¹⁸₃ or five-, six- or seven-membered heterocyclic ring including at least one atom selected from the group consisting of N, P, O and S); wherein R⁶, R⁷, R¹¹, and R¹² are optionally substituted by halogen, —OR¹⁶, —NR¹⁷₂, or —SiR¹⁸₃, wherein R⁶ optionally bonds with R⁸, R¹¹ optionally bonds with R¹³, or R¹⁵ optionally bonds with R¹² in each case to independently form a five-, six- or seven-membered carbocyclic or heterocyclic ring, the heterocyclic ring including at least one atom from the group consisting of N, P, O and S; wherein at least one of R⁶, R⁷, R¹¹, and R¹² is independently a heteroatom or a heteroatom-containing group, or at least one of the R⁶, R⁷, R¹¹, and R¹² is not methyl;
each of R¹⁶, R¹⁷, and R¹⁸ is independently C₁-C₂₂ alkyl, C₂-C₂₂ alkenyl, C₆-C₂₂ aryl, arylalkyl where alkyl has from 1 to 10 carbon atoms and aryl has from 6 to 20 carbon atoms, or —SiR¹⁹₃, wherein each R¹⁶, R¹⁷, and R¹⁸ is independently optionally substituted by halogen, or two R¹⁶ radicals optionally bond to form a five- or six-membered ring, or two R¹⁷ radicals optionally bond to form a five- or six-membered ring, or two R¹⁸ radicals optionally bond to form a five- or six-membered ring;
each R¹⁹ is independently hydrogen, C₁-C₂₂ alkyl, C₂-C₂₂ alkenyl, C₆-C₂₂ aryl, arylalkyl where alkyl has from 1 to 10 carbon atoms and aryl has from 6 to 20 carbon atoms, or two R¹⁹ radicals optionally bond to form a five- or six-membered ring;
each of E¹, E², and E³ is independently carbon, nitrogen or phosphorus;
each of u¹, u², and u³ is independently 0 if E¹, E², or E³ is nitrogen or phosphorus, and each of u¹, u², and u³ is independently 1 if E¹, E², or E³ is carbon;
each of X¹ and X² is independently, halogen, substituted hydrocarbyl, and the radicals X can be bonded with one another;
r is 1 or 2;
s is 1 or 2;
D is a neutral donor; and
t is 0 to 2.

In at least one embodiment, each of R¹ and R² is independently C₁-C₂₂ alkyl or C₆-C₂₂ aryl wherein each of R¹ and R² is optionally substituted by halogen. One or more of R¹ and R² may be independently selected from methyl, ethyl, propyl, butyl, pentyl, hexyl, heptyl, octyl, nonyl, decyl, undecyl, dodecyl, phenyl, substituted phenyl, biphenyl or an isomer thereof, which may be halogenated (such as perfluoropropyl, perfluorobutyl, perfluoroethyl, perfluoromethyl), substituted hydrocarbyl radicals and all isomers of substituted hydrocarbyl radicals including trimethylsilylpropyl, trimethylsilylmethyl, trimethylsilylethyl, phenyl, or all isomers of hydrocarbyl substituted phenyl including methylphenyl, dimethylphenyl, trimethylphenyl, tetramethylphenyl, pentamethylphenyl, diethylphenyl, triethylphenyl, propylphenyl, dipropylphenyl, tripropylphenyl, dimethylethylphenyl, dimethylpropylphenyl, dimethylbutylphenyl, or dipropylmethylphenyl. In at least one embodiment, RI and R² are methyl.

In at least one embodiment, t is 0, in which case D is absent. In an alternate embodiment, D is a neutral donor such as a neutral Lewis base, such as, for example, amines, alcohols, ethers, ketones, aldehydes, esters, sulfides or phosphines, which can be bonded with the iron center or can still be contained in the complex as residual solvent from the preparation of the iron complexes.

In at least one embodiment, the catalyst compound represented by Formula (I) has an electron donating side. At least one of R⁶ or R⁷ is independently halogen, —CF₃, —OR¹⁶, —NR¹⁷₂, or —SiR¹⁸₃. For example, at least one of R⁶ or R⁷ can independently be selected from fluorine, chlorine, bromine, or iodine. R⁸, R⁹, and R¹⁰ can be independently hydrogen, C₁-C₂₂ alkyl, C₂-C₂₂ alkenyl, C₆-C₂₂ aryl, arylalkyl where alkyl has from 1 to 10 carbon atoms and aryl has from 6 to 20 carbon atoms, —OR¹⁶, —NR¹⁷₂, halogen, —SiR¹⁸₃ or five-, six- or seven-membered heterocyclic ring including at least one atom selected from the group consisting of N, P, O and S; wherein R⁸, R⁹, and R¹⁰ are optionally substituted by halogen, —OR¹⁶, —NR¹⁷₂, or —SiR¹⁸₃.

Each of R¹⁶ and R¹⁷ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or —SiR¹⁸₃, wherein R¹⁶ and or R¹⁷ is optionally substituted by halogen, or two R¹⁶ and R¹⁷ radicals optionally bond to form a five- or six-membered ring. Each R¹⁸ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or two R¹⁸ radicals optionally bond to form a five- or six-membered ring.

In at least one embodiment, each of R³, R⁴, R is independently selected from hydrogen, methyl, ethyl, propyl, butyl, pentyl, hexyl, heptyl, octyl, nonyl, decyl, dimethyl-pentyl, tert-butyl, isopropyl, or isomers thereof, such as R³, R⁴, and R are hydrogen.

In at least one embodiment, at least one of R⁶, R⁷, R¹¹, or R¹² is independently halogen, —CF₃, —OR¹⁶, —NR¹⁷₂, or —SiR¹⁸₃, such as at least one of the R⁶, R⁷, R¹¹, or R¹² is halogen, or at least one of the R⁶, R⁷, R¹¹, or R¹² is not methyl. For example, at least one of R⁶, R⁷, R¹¹, or R¹² is independently selected from fluorine, chlorine, bromine, or iodine. In at least one embodiment, R⁶, R⁷, R¹¹, and R¹² are independently selected from methyl, ethyl, tert-butyl, isopropyl, F, Br, C₁, and I. In at least one embodiment, at least one of R⁶, R⁷, R¹¹, or R¹² is Cl. R⁶, R⁷, R¹¹, or R² can be independently C₁-C₂₂ alkyl, C₂-C₂₂ alkenyl, C₆-C₂₂ aryl, arylalkyl where alkyl can have from 1 to 10 carbon atoms and aryl can have from 6 to 20 carbon atoms, or —SiR¹⁹₃, wherein R⁶, R⁷, R¹¹, R¹² can be independently substituted by halogen, —OR¹⁶, —NR¹⁷₂, -or SiR¹⁸₃; wherein R⁶ optionally bonds with R⁸, R⁸ optionally bonds with R⁹, R⁹ optionally bonds with R¹⁰, R¹⁰ optionally bonds with R⁷, R¹¹ optionally bonds with R¹³, R¹³ optionally bonds with R¹⁴, R¹⁴ optionally bonds with R¹⁵, and R¹⁵ optionally bonds with R¹², in each case to independently form a five-, six-, or seven-membered ring.

In at least one embodiment, the catalyst compound represented by Formula (I) has an electron withdrawing side. Each of R¹¹, R¹², R¹³, R¹⁴, and R¹⁵ can be independently hydrogen (except R¹¹ and R¹² are not H), C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —OR¹⁶, —NR¹⁷₂, or —SiR¹⁸₃, halogen, —NO₂, or five-, six-, or seven-membered heterocyclic ring including at least one atom selected from N, P, O, and S. R¹¹, R¹², R¹³, R¹⁴, and R¹⁵ can be independently substituted by —NO₂, —CF₃, —CF₂CF₃, —CH₂CF₃, halogen, —OR¹⁶, —NR¹⁷₂, or —SiR¹⁸₃. Furthermore, each of R¹, R¹², R¹³, R¹⁴, and R¹⁵ can be independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or alkylaryl where alkyl has from 1 to 10 carbon atoms and aryl has from 6 to 20 carbon atoms, where at least one of R¹, R¹², R¹³, R¹⁴, and R¹⁵ can be substituted by —NO₂, —CF₃, —CF₂CF₃, —CH₂CF₃, halogen, —OR¹⁶, —NR¹⁷₂, or —SiR¹⁸₃. In at least one embodiment, at least one of R¹, R¹², R¹³, R¹⁴, and R¹⁵ is halogen or C₁-C₂₂-alkyl substituted with one or more halogen atoms. In at least one embodiment, each of R¹¹, R¹², R¹³, R¹⁴, and R¹⁵ is independently hydrogen, halogen (such as fluorine, chlorine, bromine, or iodine), or trihalomethyl (such as trichloromethyl or trifluoromethyl), where at least one of R¹, R¹², R¹³, R¹⁴, and R¹⁵ is halogen or trihalomethyl.

Each of R⁶, R⁷, R⁸, R⁹, R¹⁰, R¹¹, R¹², R¹³, R¹⁴, and R¹⁵ can be independently selected from hydrogen (except R⁶, R⁷, R¹¹, and R¹² are not H), methyl, ethyl, propyl, butyl, pentyl, hexyl, heptyl, octyl, nonyl, decyl, undecyl, dodecyl, phenyl, substituted phenyl, biphenyl or an isomer thereof, which may be halogenated (such as perfluoropropyl, perfluorobutyl, perfluoroethyl, perfluoromethyl), substituted hydrocarbyl radicals and all isomers of substituted hydrocarbyl radicals including trimethylsilylpropyl, trimethylsilylmethyl, trimethylsilylethyl, phenyl, or all isomers of hydrocarbyl substituted phenyl including methylphenyl, dimethylphenyl, trimethylphenyl, tetramethylphenyl, pentamethylphenyl, diethylphenyl, triethylphenyl, propylphenyl, dipropylphenyl, tripropylphenyl, dimethylethylphenyl, dimethylpropylphenyl, dimethylbutylphenyl, or dipropylmethylphenyl, or isomers thereof.

In at least one embodiment, each of E¹, E², and E³ is independently carbon, nitrogen or phosphorus, such as each of u¹, u², and u³ is independently 0 if E¹, E², or E³ is nitrogen or phosphorus, and each of u¹, u², and u³ is independently 1 if E¹, E², or E³ is carbon. Each of R³, R⁴, and R⁵ can be independently hydrogen or C₁-C₂₂-alkyl. In at least one embodiment, E¹, E², and E³ are carbon, and each of R³, R⁴, and R⁵ is hydrogen. In another embodiment, R¹ and R² are methyl, and R³, R⁴, and R⁵ are hydrogen.

In at least one embodiment, each instance of X¹ and X² is independently substituted hydrocarbyl, and the radicals X₁ and X₂ can be bonded with one another. For example, r can be 1 or 2, such as r can be 1. In another example, s can be 1 or 2, such as s can be 1. In at least one embodiment, r and s are the same. For example, each instance of X¹ and X² can be any suitable silane, such as (trialkylsilyl)C₁-C₂₀ alkyl-, such as (trialkylsilyl)C₁-C₁₀ alkyl-, such as (trialkylsilyl)C₁-C₅ alkyl-. In at least one embodiment, one or more X¹ and X² is independently selected from (trimethylsilyl)methyl-, (trimethylsilyl)methyl-, (trimethylsilyl)ethyl-, (trimethylsilyl)propyl-, (trimethylsilyl)butyl-, (trimethylsilyl)pentyl-, (trimethylsilyl)hexyl-, (trimethylsilyl)heptyl-, (trimethylsilyl)octyl-, (trimethylsilyl)nonyl-, (trimethylsilyl)decyl-, (triethylsilyl)methyl-, (triethylsilyl)methyl-, (triethylsilyl)ethyl-, (triethylsilyl)propyl-, (triethylsilyl)butyl-, (triethylsilyl)pentyl-, (triethylsilyl)hexyl-, (triethylsilyl)heptyl-, (triethylsilyl)octyl-, (triethylsilyl)nonyl-, (triethylsilyl)decyl-, (triisopropylsilyl)methyl-, (triisopropylsilyl)methyl-, (triisopropylsilyl)ethyl-, (triisopropylsilyl)propyl-, (triisopropylsilyl)butyl-, (triisopropylsilyl)pentyl-, (triisopropylsilyl)hexyl-, (triisopropylsilyl)heptyl-, (triisopropylsilyl)octyl-, (triisopropylsilyl)nonyl-, (triisopropylsilyl)decyl-, (t-BuPh₂Si)methyl-, (t-BuPh₂Si)methyl-, (t-BuPh₂Si)ethyl-, (t-BuPh₂Si)propyl-, (t-BuPh₂Si)butyl-, (t-BuPh₂Si)pentyl-, (triethylsilyl)hexyl-, (t-BuPh₂Si)heptyl-, (t-BuPh₂Si)octyl-, (t-BuPh₂Si)nonyl-, (t-BuPh₂Si)decyl-, or isomers thereof.

In at least one embodiment, the iron catalyst may be an iron complex represented by Formula (IIa) and/or Formula (IIb):

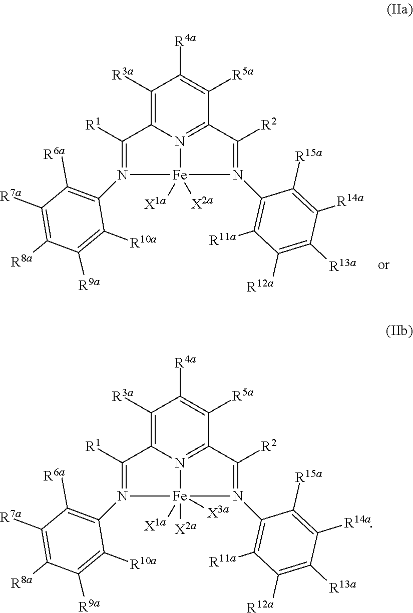

Formula (II), as used herein, refers to one or more of Formula (IIa) and/or Formula (IIb).

In at least one embodiment, each of R^{6a}, R^{10a}, R^{11a}, and R^{15a} are independently halogen, —CF₃, or C₁-C₂₂-alkyl, C₂-C₂₂-alkenyl, C₆-C₂₂-aryl, arylalkyl (wherein alkyl has from 1 to 10 carbon atoms and aryl has from 6 to 20 carbon atoms), NR′₂, —OR′, —SiR″₃ or five-, six- or seven-membered heterocyclyl comprising at least one atom selected from N, P, O and S. In at least one embodiment, each of R^{6a}, R^{10a}, R^{11a}, and R^{15a} are independently fluorine, chlorine, bromine, or iodine. In at least one embodiment, each of R^{6a}, R^{10a}, R^{11a}, and R^{15a} is independently optionally substituted by halogen, —NR′₂, —OR′ or —SiR″₃.

In at least one embodiment, each of R^{1a} and R^{2a} is independently hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, or five-, six- or seven-membered heterocyclyl comprising at least one atom selected from N, P, O and S, wherein each of R^{1a} and R^{2a} is optionally substituted by halogen, —NR′₂, —OR′ or —SiR″₃, wherein R^{1a} optionally bonds with R^{3a}, and R^{2a} optionally bonds with R^{5a}, in each case to independently form a five-, six- or seven-membered ring. In at least one embodiment, R^{1a} and R^{2a} are independently C₁-C₂₂-alkyl, substituted C₁-C₂₂-alkyl, unsubstituted phenyl, or substituted phenyl. In at least one embodiment, each of R^{1a} and R^{2a} is independently selected from methyl, ethyl, n-propyl, isopropyl, n-butyl, isobutyl, sec-butyl, tert-butyl, n-pentyl, isopentyl, sec-pentyl, tert-pentyl, n-hexyl, isohexyl, sec-hexyl, tert-hexyl, n-heptyl, isoheptyl, sec-heptyl, tert-heptyl, n-octyl, isooctyl, sec-octyl, tert-octyl, n-nonyl, isononyl, sec-nonyl, tert-nonyl, n-decyl, isodecyl, sec-decyl, and tert-decyl.

In at least one embodiment, each of R^{3a}, R^{4a}, R^{5a}, R^{7a}, R^{8a}, R^{9a}, R^{12a}, R^{13a}, and R^{14a} is independently hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, halogen, —NR′₂, —OR′, —SiR″₃ or five-, six- or seven-membered heterocyclyl comprising at least one atom selected from N, P, O and S. Each of R^{3a}, R^{4a}, R^{5a}, R^{7a}, R^{8a}, R^{9a}, R^{12a}, R^{13a}, and R^{14a} is independently optionally substituted by halogen, —NR′₂, —OR′, or —SiR″₃.

In at least one embodiment, each of R^{8a} and R^{13a} is independently selected from C₁-C₂₂-alkyl, wherein each of R^{8a} and R^{13a} is independently optionally substituted by halogen, —NR′₂, —OR′, or —SiR″₃. In at least one embodiment, R^{7a}, R^{9a}, R^{12a}, and R^{14a} is hydrogen. In at least one embodiment, each of R^{3a}, R^{4a}, and R^{5a} is hydrogen.

In at least one embodiment, each of X^{1a}, X^{2a}, and X^{3a} is independently halogen, hydrogen, C₁-C₂₀-alkyl, C₂-C₁₀-alkenyl, C₆-C₂₀-aryl, arylalkyl wherein alkyl has from 1 to 10 carbon atoms and aryl has from 6 to 20 carbon atoms, —NR′₂, —OR′, —SR′, —SO₃R′, —OC(O)R′, —CN, —SCN, β-diketonate, —CO, —BF₄—, —PF₆— or bulky non-coordinating anion, or X^{1a} and X²a optionally bond to form a five- or six-membered ring. Each R′ is independently hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, or —SiR″₃, wherein R′ is optionally substituted by halogen or nitrogen- or oxygen-containing groups, or two R′ radicals optionally bond to form a five- or six-membered ring. Each R″ is independently hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, wherein each R″ is optionally substituted by halogen or nitrogen- or oxygen-containing groups, or two R″ radicals optionally bond to form a five- or six-membered ring. In at least one embodiment, X^{1a} and X^{2a} are chlorine.

In at least one embodiment, each of R^{6a}, R^{10a}, R^{11a}, and R^{15a} is chlorine; each of Ria and R^{2a} is C₁-C₂₀ hydrocarbyl; each of R^{3a}, R^{4a}, and R^{5a} is hydrogen; each of R^{8a} and R^{13a} is C₁-C₂₀ hydrocarbyl; each of R^{7a}, R^{9a}, R^{12a} and R^{14a} is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, halogen, —NR′₂, —OR′, —SiR″₃ or five-, six- or seven-membered heterocyclyl comprising at least one atom selected from the group consisting of N, P, O and S; Ria, R^{2a}, R^{3a}, R^{4a}, R^{5a}, R^{7a}, R^{8a}, R^{9a}, R^{12a}, and R^{13a} are optionally substituted by halogen, —NR′₂, —OR′ or —SiR″₃; each R′ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or —SiR″₃, wherein R′ is optionally substituted by halogen, or two R′ radicals optionally bond to form a five- or six-membered ring; each R″ is independently hydrogen, C₁-C₂₂-alkyl, C₂-C₂₂-alkenyl, C₆-C₂₂-aryl or arylalkyl where alkyl has from 1 to 10 carbon atoms and aryl has from 6 to 20 carbon atoms, or two R″ radicals optionally bond to form a five- or six-membered ring.

In at least one embodiment, an iron catalyst represented by Formula (II) is one or more of:

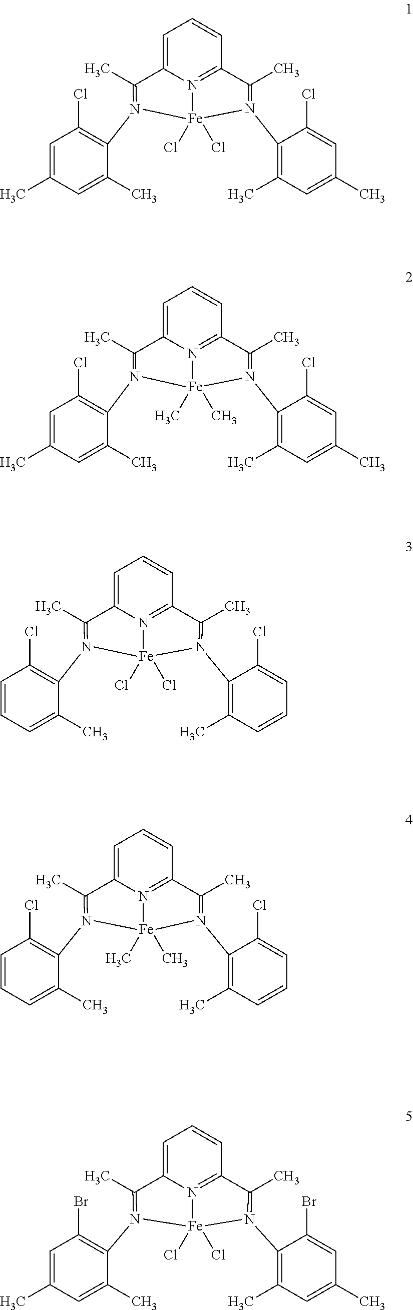

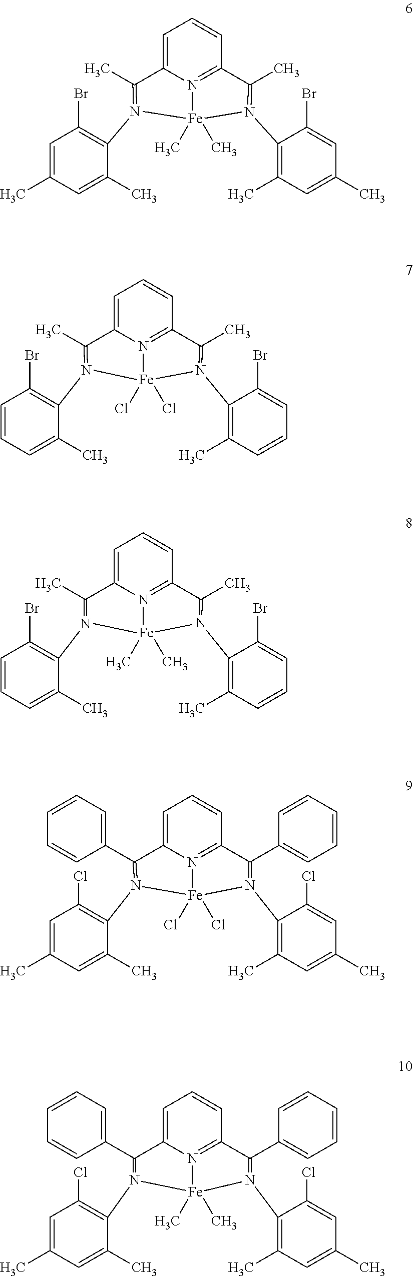

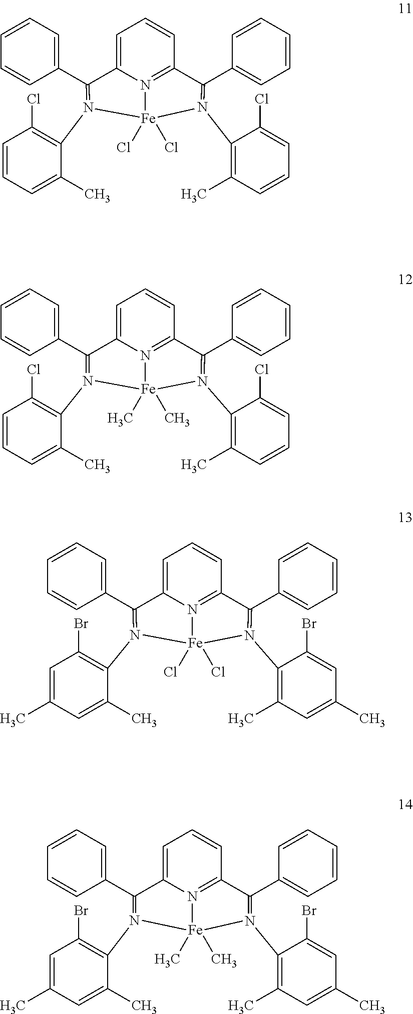

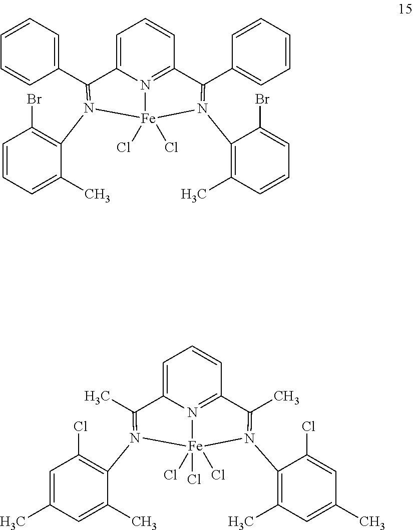

In at least one embodiment, an iron catalyst represented by Formula (II) is one or more of:

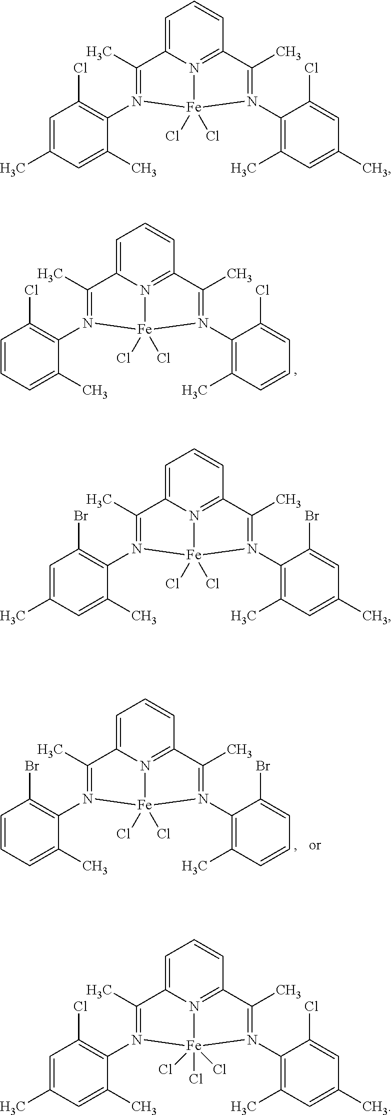

In at least one embodiment, an iron catalyst represented by Formula (II) is one or more of:

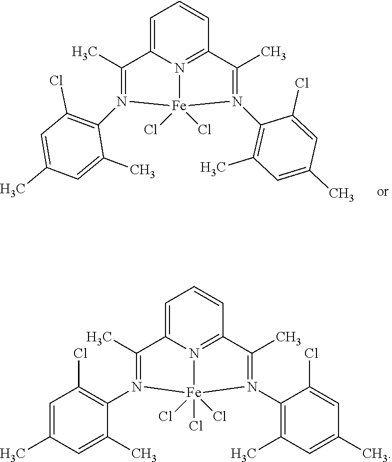

In at least one embodiment, the iron catalyst may be an iron complex represented by Formula (IIIa) and/or Formula (IIIb):

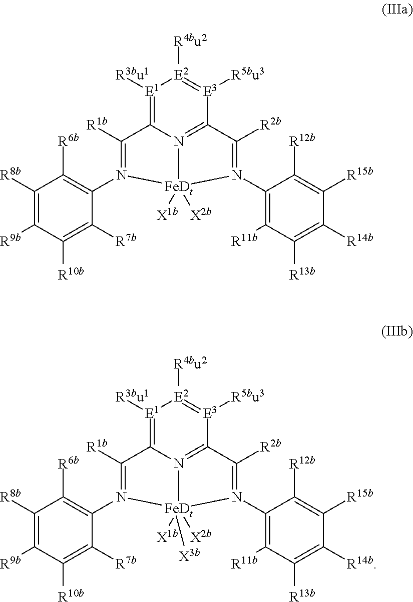

Formula (III), as used herein, refers to one or more of Formula (IIIa) and/or Formula (IIIb).

In at least one embodiment, each of R^{1b} and R^{2b} is independently hydrogen, C₁-C₂₂ alkyl, C₂-C₂₂ alkenyl, C₆-C₂₂ aryl, arylalkyl wherein alkyl has from 1 carbon atom to 10 carbon atoms and aryl has from 6 carbon atoms to 20 carbon atoms, or five-, or six-, or seven-membered heterocyclic ring comprising at least one atom selected from the group consisting of N, P, O and S; wherein each of R^{1b} and R^{2b} is optionally substituted by halogen, —OR^{16b}, —NR^{17b}₂, or —SiR^{18b}₃; wherein R^{1b} optionally bonds with R^{3b}, and R^{2b} optionally bonds with R^{5b}, in each case to independently form a five-, six-, or seven-membered ring.

In at least one embodiment, each of R^{3b}, R^{4b}, R^{5b}, R^{8b}, R^{9b}, R_{10b}, R^{13b}, R^{14b}, and R^{15b} is independently hydrogen, C₁-C₂₂ alkyl, C₂-C₂₂ alkenyl, C₆-C₂₂ aryl, arylalkyl wherein alkyl has from 1 to 10 carbon atoms and aryl has from 6 to 20 carbon atoms, —OR^{16b}, —NR^{17b}₂, halogen, —SiR^{18b}₃ or five-, six- or seven-membered heterocyclic ring comprising at least one atom selected from the group consisting of N, P, O and S.

In at least one embodiment, the catalyst compound represented by Formula (III) has an electron withdrawing side. Each of R^{13b}, R^{14b}, and R^{15b} can be independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —OR^{16b}, —NR^{17b}₂, or —SiR^{18b}₃, halogen, —NO₂, or five-, six-, or seven-membered heterocyclic ring including at least one atom selected from N, P, O, and S. R^{13b}, R^{14b}, and R^{15b} can be independently substituted by —NO₂, —CF₃, —CF₂CF₃, —CH₂CF₃, halogen, —OR^{16b}, —NR^{17b}₂, or —SiR^{18b}₃. Furthermore, each of R^{13b}, R^{14b}, and R^{15b} can be independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or alkylaryl where alkyl has from 1 to 10 carbon atoms and aryl has from 6 to 20 carbon atoms, where at least one of R^{13b}, R^{14b}, and R^{15b} can be substituted by —NO₂, —CF₃, —CF₂CF₃, —CH₂CF₃, halogen, —OR^{16b}, —NR^{17b}₂, or —SiR^{18b}₃. In at least one embodiment, at least one of R^{13b}, R^{14b}, and R^{15b} is halogen or C₁-C₂₂-alkyl substituted with one or more halogen atoms. In at least one embodiment, each of R^{13b}, R^{14b}, and R^{15b} is independently hydrogen, halogen (such as fluorine, chlorine, bromine, or iodine), or trihalomethyl (such as trichloromethyl or trifluoromethyl), where at least one of R^{13b}, R^{14b}, and R^{18b} is halogen or trihalomethyl.

In at least one embodiment, each of R^{3b}, R^{4b}, R^{5b}, R^{8b}, R^{9b}, R^{10b}, R^{13b}, R^{14b}, and R^{15b} are optionally substituted by halogen, —OR^{16b}, —NR^{17b}₂, halogen, —SiR^{18b}₃; wherein R^{3b} optionally bonds with R^{4b}, R^{4b} optionally bonds with R^{5b}, R^{7b} optionally bonds with R^{10b}, R^{10b} optionally bonds with R^{9b}, R^{9b} optionally bonds with R^{8b}, R^{15b} optionally bonds with R^{14b}, R^{14b} optionally bonds with R^{13b}, and R^{13b} optionally bonds with R^{11b}, in each case to independently form a five-, six- or seven-membered carbocyclic or heterocyclic ring, the heterocyclic ring comprising at least one atom from the group consisting of N, P, O and S.

In some embodiments, each of R^{6b}, R^{7b}, R^{11b}, and R^{12b} is independently C₁-C₂₂ alkyl, C₂-C₂₂ alkenyl, C₆-C₂₂ aryl, arylalkyl wherein alkyl has from 1 to 10 carbon atoms and aryl has from 6 to 20 carbon atoms, a heteroatom or a heteroatom-containing group (such as —OR^{16b}, —NR^{17b}₂, halogen, —SiR^{18b}₃ or five-, six- or seven-membered heterocyclic ring including at least one atom selected from the group consisting of N, P, O and S); wherein R^{6b}, R^{7b}, R^{11b}, and R^{12b} are optionally substituted by halogen, —OR^{16b}, —NR^{17b}₂, —SiR^{18b}₃, wherein R^{6b} optionally bonds with R^{8b}, R^{11b} optionally bonds with R^{13b}, or R^{18b} optionally bonds with R^{12b} in each case to independently form a five-, six- or seven-membered carbocyclic or heterocyclic ring, the heterocyclic ring including at least one atom from the group consisting of N, P, O and S; wherein at least one of R^{6b}, R^{7b}, R^{11b} and R^{12b} is independently a heteroatom or a heteroatom-containing group. In at least one embodiment, each of R^{16b}, R^{17b}, and R^{18b} is independently hydrogen, C₁-C₂₂ alkyl, C₂-C₂₂ alkenyl, C₆-C₂₂ aryl, arylalkyl where alkyl has from 1 to 10 carbon atoms and aryl has from 6 to 20 carbon atoms, or —SiR¹⁹₃, wherein each R^{16b}, R^{17b}, and R^{18b} is independently optionally substituted by halogen, or two R^{16b} radicals optionally bond to form a five- or six-membered ring, or two R^{17b} radicals optionally bond to form a five- or six-membered ring, or two R^{18b} radicals optionally bond to form a five- or six-membered ring. Each R^{18b} can be independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or two R^{18b} radicals optionally bond to form a five- or six-membered ring.

In at least one embodiment, R^{19b} is independently hydrogen, C₁-C₂₂ alkyl, C₂-C₂₂ alkenyl, C₆-C₂₂ aryl, arylalkyl where alkyl has from 1 to 10 carbon atoms and aryl has from 6 to 20 carbon atoms, or two R¹⁹ radicals optionally bond to form a five- or six-membered ring.

In some embodiments each of E¹, E², and E³ is independently carbon, nitrogen or phosphorus. In at least one embodiment, each of u¹, u², and u³ is independently 0 if E¹, E², or E³ is nitrogen or phosphorus, and each of u¹, u², and u³ is independently 1 if E¹, E², or E³ is carbon.

In at least one embodiment, each of X^{1b} and X^{2b} is independently substituted hydrocarbyl, and the radicals X^{1b} and X^{2b} can be bonded with one another. In some embodiments, D is a neutral donor; and/or t is 0 to 2.

In at least one embodiment, each of R^{1b} and R^{2b} is independently C₁-C₂₂ alkyl or C₆-C₂₂ aryl wherein each of R^{1b} and R^{2b} is optionally substituted by halogen. One or more of R^{1b} and R^{2b} may be independently selected from methyl, ethyl, propyl, butyl, pentyl, hexyl, heptyl, octyl, nonyl, decyl, undecyl, dodecyl, phenyl, substituted phenyl, biphenyl or an isomer thereof, which may be halogenated (such as perfluoropropyl, perfluorobutyl, perfluoroethyl, perfluoromethyl), substituted hydrocarbyl radicals and all isomers of substituted hydrocarbyl radicals including trimethylsilylpropyl, trimethylsilylmethyl, trimethylsilylethyl, phenyl, or all isomers of hydrocarbyl substituted phenyl including methylphenyl, dimethylphenyl, trimethylphenyl, tetramethylphenyl, pentamethylphenyl, diethylphenyl, triethylphenyl, propylphenyl, dipropylphenyl, tripropylphenyl, dimethylethylphenyl, dimethylpropylphenyl, dimethylbutylphenyl, or dipropylmethylphenyl.

In at least one embodiment, R^{1b} and R^{2b} are methyl.

In at least one embodiment, t is 0, in which case D is absent. In an alternate embodiment, D is a neutral donor such as a neutral Lewis base, such as, for example, amines, alcohols, ethers, ketones, aldehydes, esters, sulfides or phosphines, which can be bonded with the iron center or can still be contained in the complex as residual solvent from the preparation of the iron complexes.

In at least one embodiment, the catalyst compound represented by Formula (III) has an electron donating side. At least one of R^{6b} or R^{7b} is independently halogen, —CF₃, —OR^{16b}, —NR^{17b}₂, or —SiR^{18b}₃. For example, at least one of R^{6b} or R^{7b} can independently be selected from fluorine, chlorine, bromine, or iodine. R^{8b}, R^{9b}, and R^{10b} can be independently hydrogen, C₁-C₂₂ alkyl, C₂-C₂₂ alkenyl, C₆-C₂₂ aryl, arylalkyl where alkyl has from 1 to 10 carbon atoms and aryl has from 6 to 20 carbon atoms, —OR^{16b}, —NR^{17b}₂, or —SiR¹⁸₃, halogen, or five-, six- or seven-membered heterocyclic ring including at least one atom selected from the group consisting of N, P, O and S; wherein R^{8b}, R^{9b}, and R^{10b} are optionally substituted by halogen, —OR^{16b}, —NR^{17b}₂, or —SiR^{18b}₃.

In at least one embodiment, each of R^{3b}, R^{4b}, R^{5b} is independently selected from hydrogen, methyl, ethyl, propyl, butyl, pentyl, hexyl, heptyl, octyl, nonyl, decyl, dimethyl-pentyl, tert-butyl, isopropyl, or isomers thereof, such as R^{3b}, R^{4b}, R^{5b} are hydrogen.

In some embodiments, each of R^{6b}, R^{7b}, R^{8b}, R^{9b}, R^{10b}, R^{11b}, R^{12b}, R^{13b}, R^{14b}, and R^{15b} can be independently selected from methyl, ethyl, propyl, butyl, pentyl, hexyl, heptyl, octyl, nonyl, decyl, undecyl, dodecyl, phenyl, substituted phenyl, biphenyl or an isomer thereof, which may be halogenated (such as perfluoropropyl, perfluorobutyl, perfluoroethyl, perfluoromethyl), substituted hydrocarbyl radicals and all isomers of substituted hydrocarbyl radicals including trimethylsilylpropyl, trimethylsilylmethyl, trimethylsilylethyl, phenyl, or all isomers of hydrocarbyl substituted phenyl including methylphenyl, dimethylphenyl, trimethylphenyl, tetramethylphenyl, pentamethylphenyl, diethylphenyl, triethylphenyl, propylphenyl, dipropylphenyl, tripropylphenyl, dimethylethylphenyl, dimethylpropylphenyl, dimethylbutylphenyl, or dipropylmethylphenyl, or isomers thereof. In at least one embodiment, each of R^{8b}, R^{9b}, R^{10b}, R^{11b}, R^{12b}, R^{13b}, R^{14b}, and R^{15b} can be independently hydrogen.

In at least one embodiment, each instance of X^{1b} and X^{2b} is independently substituted hydrocarbyl, and the radicals X^{1b} and X^{2b} can be bonded with one another. For example, r can be 1 or 2, such as r can be 1. In another example, s can be 1 or 2, such as s can be 1. In at least one embodiment, r and s are the same. For example, each instance of X^{1b} and X^{2b} can be any suitable silane, such as (trialkylsilyl)C₁-C₂₀ alkyl-, such as (trialkylsilyl)C₁-C₁₀ alkyl-, such as (trialkylsilyl)C₁-C₅ alkyl-. In at least one embodiment, one or more X^{1b} and X^{2b} is independently selected from (trimethylsilyl)methyl-, (trimethylsilyl)methyl-, (trimethylsilyl)ethyl-, (trimethylsilyl)propyl-, (trimethylsilyl)butyl-, (trimethylsilyl)pentyl-, (trimethylsilyl)hexyl-, (trimethylsilyl)heptyl-, (trimethylsilyl)octyl-, (trimethylsilyl)nonyl-, (trimethylsilyl)decyl-, (triethylsilyl)methyl-, (triethylsilyl)methyl-, (triethylsilyl)ethyl-, (triethylsilyl)propyl-, (triethylsilyl)butyl-, (triethylsilyl)pentyl-, (triethylsilyl)hexyl-, (triethylsilyl)heptyl-, (triethylsilyl)octyl-, (triethylsilyl)nonyl-, (triethylsilyl)decyl-, (triisopropylsilyl)methyl-, (triisopropylsilyl)methyl-, (triisopropylsilyl)ethyl-, (triisopropylsilyl)propyl-, (triisopropylsilyl)butyl-, (triisopropylsilyl)pentyl-, (triisopropylsilyl)hexyl-, (triisopropylsilyl)heptyl-, (triisopropylsilyl)octyl-, (triisopropylsilyl)nonyl-, (triisopropylsilyl)decyl-, (t-BuPh₂Si)methyl-, (t-BuPh₂Si)methyl-, (t-BuPh₂Si)ethyl-, (t-BuPh₂Si)propyl-, (t-BuPh₂Si)butyl-, (t-BuPh₂Si)pentyl-, (triethylsilyl)hexyl-, (t-BuPh₂Si)heptyl-, (t-BuPh₂Si)octyl-, (t-BuPh₂Si)nonyl-, (t-BuPh₂Si)decyl-, or isomers thereof. For example, X¹ and X² can be (trimethylsilyl)methyl.

In embodiments, the 2,6-bis(imino)pyridyl iron complex is one or more of (1E,1′E)-1,1′-(pyridine-2,6-diyl)bis(N-(2-chloro-4,6-dimethylphenyl)ethan-1-imine)FeCl₃, (1E,1′E)-1,1′-(pyridine-2,6-diyl)bis(N-(2-chloro-4,6-dimethylphenyl)ethan-1-imine)FeCl₂, (1E,1′E)-1,1′-(pyridine-2,6-diyl)bis(N-(2-chloro-4,6-isopropylphenyl)ethan-1-imine)FeCl₂, (1E,1′E)-1,1′-(pyridine-2,6-diyl)bis(N-(2-chloro-4-methyl-6-tert-butylphenyl)ethan-1-imine)FeCl₂, (1E,1′E)-1,1′-(pyridine-2,6-diyl)bis(N-(2-chloro-6-methyl-phenyl)ethan-1-imine)FeCl₂, and (1E,1′E)-1,1′-(pyridine-2,6-diyl)bis(N-(2-chloro-6-methyl-phenyl)ethan-1-imine)FeCl₃.

### Methods to Prepare the Iron Compounds.

The following is a generic description to prepare a catalyst compound described herein and further exemplified in the examples. All air sensitive syntheses can be carried out in nitrogen purged dry boxes. All solvents are available from commercial sources. Substituted anilines; substituted pyridines; Grignard reagents; iron (II) chloride; and formic acid may be available from commercial sources. To a mixture of a diacetyl aryl ((e.g., 2,6-diacetylpyridine) and a polar protic solvent (e.g., MeOH), can be added an aniline (e.g., 2-chloro-4,6-dimethylaniline) and an acid (e.g., formic acid). The resulting compound can then be treated with iron(II) chloride to form an iron-chelated compound, which can be further treated with a substituted hydrocarbyl Grignard reagent, such as a silyl-containing alkylating reagent (e.g., Me₃SiCH₂MgCl), in order to form the iron bis(imino) aryl catalyst compound represented by Formula (I) including the substituted hydrocarbyl moiety described above.

Additionally or alternatively, synthesis of ligands, such as 1,1′-(pyridine-2,6-diyl)(N-(2-chloro-4,6-dimethylphenyl)ethan-1-imine)(N-(2,4,6-trimethylphenyl)ethan-1-imine), can be made using procedure described in WO 2007/080081.

### Catalyst System

In at least one embodiment, two or more different catalyst compounds are present in a catalyst system. In at least one embodiment, two or more different catalyst compounds are present in the reaction zone where the process(es) described herein occur. When two transition metal compound based catalysts are used in one reactor as a mixed catalyst system, the two transition metal compounds can be chosen such that the two are compatible. A simple screening method such as by ¹H or ¹³C NMR, known to those of ordinary skill in the art, can be used to determine which transition metal compounds are compatible. The same activator can be used for the transition metal compounds, however, two different activators, such as a non-coordinating anion activator and an alumoxane, can be used in combination. If one or more transition metal compounds contain an anionic ligand (such as X¹ or X² in Formula (I) or X in Formula (A)) which is not a hydride, hydrocarbyl, or substituted hydrocarbyl, then the alumoxane or an alkyl aluminum compound is typically contacted with the transition metal compounds prior to addition of the non-coordinating anion activator.

The catalyst system useful herein may also be a mixed catalyst system comprising one, two or more different catalyst compounds represented by Formula (A), one, two or more different catalyst compounds represented by Formula (I), at least one activator, and at least one support.

Typically, the two or more different catalyst compounds can be present in the reaction zone where the process(es) described herein occur. The same activator can be used for the transition metal compounds, however, two different activators, such as a non-coordinating anion activator and an alumoxane, can be used in combination.

The two transition metal compounds (represented by Formulas (A) and (I)) may be used in any ratio. Molar ratios of (A) transition metal compound to (I) transition metal compound can be (A:I) of from 1:1000 to 1000:1, alternatively 1:100 to 500:1, alternatively 1:10 to 200:1, alternatively 1:1 to 100:1, alternatively 1:1 to 75:1, and alternatively 5:1 to 50:1. The suitable ratio chosen will depend on the exact pre-catalysts chosen, the method of activation, and the end product desired. In at least one embodiment, when using the two pre-catalysts, where both are activated with the same activator, mole percentages, based upon the molecular weight of the pre-catalysts, can be from 10% to 99.9% A to 0.1% to 90% I, alternatively 25% to 99% A to 0.5% to 75% I, alternatively 50% to 99% A to 1% to 50% I, and alternatively 75% to 99% A to T % to 10% I.

Alternately, the group 4 metallocycle containing metallocene complex is present a molar ratio of about 1% to about 99%, and the 2,6-bis(imino)pyridyl iron complex is present at a molar ratio of about 99% to about 1%, based on the combination of the catalyst compounds. Alternately, the group 4 metallocycle containing metallocene complex is present a molar ratio of about 40% to about 99%, and the 2,6-bis(imino)pyridyl iron complex is present at a molar ratio of about 1% to about 60%, based on the combination of the catalyst compounds. Alternately, the group 4 metallocycle containing metallocene complex is present a molar ratio of about 50% to about 99%, and the 2,6-bis(imino)pyridyl iron complex is present at a molar ratio of about 1% to about 50%, based on the combination of the catalyst compounds.

The above two catalyst components can be chosen to have different hydrogen responses (each having a different reactivity toward hydrogen) during the polymerization process. Hydrogen is often used in olefin polymerization to control the final properties of the polyolefin. The iron catalyst component can show a more negative response to changes of hydrogen concentration in reactor than the group 4 catalyst component. Owing to the differing hydrogen response of the catalyst components in the supported catalyst systems, the properties of resulting polymer are controllable. Changes of hydrogen concentration in reactor may affect molecular weight, molecular weight distributions, and other properties of the resulting polyolefin when using a combination of such two catalyst components. Thus, this invention further provides a multi-modal polyolefin obtained from polymerizations using the above supported catalyst systems. In embodiments of the invention, the catalyst system is absent metallocene catalyst compound not represented by Formula (A). A metallocene catalyst compound is a group 3 to 12 (typically group 4) transition metal catalyst compound having one, two or three, typically one or two, substituted or unsubstituted cyclopentadienyl ligands bound to the transition metal, typically a metallocene catalyst is an organometallic compound containing at least one π-bound cyclopentadienyl moiety (or substituted cyclopentadienyl moiety). Substituted or unsubstituted cyclopentadienyl ligands include substituted or unsubstituted indenyl, fluorenyl, tetrahydro-s-indacenyl, tetrahydro-as-indacenyl, benz[/]indenyl, benz[e]indenyl, tetrahydrocyclopenta[b]naphthalene, tetrahydrocyclopenta[a]naphthalene, and the like.

Two or more of the catalysts as described herein (preferably at least one catalyst compound represented by Formula (A) and at least one catalyst compound represented by Formula (I)) may be used in a mixed catalyst system (also known as a dual catalyst system). The catalyst compounds are preferably co-supported, that is disposed on the same support material, optionally and in addition to, injected into the reactor(s) separately (with or without a support) or in different combinations and proportions together to “trim” or adjust the polymer product properties according to its target specification. This approach is very useful in controlling polymer product properties and insuring uniformity in high volume production of polyolefin polymers.

For example, catalyst combinations such as (propylcyclopentadienyl) (propylenecyclopentadienyl)hafnium n-butyl with 2,6-bis-[1-(2-chloro-4,6-dimethylphenylimino)ethyl]pyridine iron dichloride, may be used in a catalyst system herein. Particularly preferred catalyst systems comprise (propylcyclopentadienyl) (propylenecyclopentadienyl)hafnium n-butyl with 2,6-bis-[1-(2-chloro-4,6-dimethylphenylimino)ethyl]pyridine iron dichloride, a support such as silica, and an activator such as an alumoxane (typically, methylalumoxane).

### Activators

The catalyst systems described herein typically comprise two catalyst complexes, as described above, a support and an activator such as alumoxane or a non-coordinating anion activator. These catalyst systems may be formed by combining the catalyst components described herein with activators in any manner known from the literature. Catalyst systems of the present disclosure may have one or more activators and two or more catalyst components. Activators are any compound which can activate any one of the catalyst compounds described above by converting the neutral metal compound to a catalytically active metal compound cation. Non-limiting activators, for example, include alumoxanes, ionizing activators, which may be neutral or ionic, and conventional-type co-catalysts. Preferred activators typically include alumoxane compounds, modified alumoxane compounds, and ionizing anion precursor compounds that abstract a reactive metal ligand making the metal compound cationic and providing a charge-balancing non-coordinating or weakly coordinating anion, e.g. a non-coordinating anion.

### Alumoxane Activators

Alumoxane activators are utilized as activators in the catalyst systems described herein. Alumoxanes are generally oligomeric compounds containing —Al(R¹)—O— sub-units, where R¹ is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, particularly when the abstractable ligand is an alkyl, halide, alkoxide or amide. Mixtures of different alumoxanes and modified alumoxanes may also be used. It may be preferable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584). Another useful alumoxane is solid polymethylaluminoxane as described in U.S. Pat. Nos. 9,340,630; 8,404,880; and 8,975,209.

When the activator is an alumoxane (modified or unmodified), typically the maximum amount of activator is at up to a 5,000-fold molar excess Al/M over the catalyst compound(s) (per metal catalytic site). The minimum activator-to-catalyst-compound is a 1:1 molar ratio. Alternate preferred ranges include from 1:1 to 500:1, alternately from 1:1 to 200:1, alternately from 1:1 to 100:1, or alternately from 1:1 to 50:1.

In an alternate embodiment, little or no alumoxane is used in the polymerization processes described herein. Preferably, alumoxane is present at zero mole %, alternately the alumoxane is present at a molar ratio of aluminum to catalyst compound transition metal less than 500:1, preferably less than 300:1, preferably less than 100:1, preferably less than 1:1.

### Ionizing/Non Coordinating Anion Activators

The term “non-coordinating anion” (NCA) means an anion which either does not coordinate to a cation or which is only weakly coordinated to a cation thereby remaining sufficiently labile to be displaced, typically by a neutral Lewis base. Further, the anion will not transfer an anionic substituent or fragment to the cation so as to cause it to form a neutral transition metal compound and a neutral by-product from the anion. Non-coordinating anions useful in accordance with this invention are those that are compatible, stabilize the transition metal cation in the sense of balancing its ionic charge at +1, and yet retain sufficient lability to permit displacement during polymerization. The term NCA is also defined to include multicomponent NCA-containing activators, such as N,N-dimethylanilinium tetrakis(pentafluorophenyl)borate, that contain an acidic cationic group and the non-coordinating anion. The term NCA is also defined to include neutral Lewis acids, such as tris(pentafluorophenyl)boron, that can react with a catalyst to form an activated species by abstraction of an anionic group. Any metal or metalloid that can form a compatible, weakly coordinating complex may be used or contained in the non-coordinating anion. Suitable metals include, but are not limited to, aluminum, gold, and platinum. Suitable metalloids include, but are not limited to, boron, aluminum, phosphorus, and silicon.

It is within the scope of this invention to use an ionizing activator, neutral or ionic. It is also within the scope of this invention to use neutral or ionic activators alone or in combination with alumoxane or modified alumoxane activators.

In embodiments of the invention, the activator is represented by the Formula (III):

(Z)_{d}⁺(A^{d-}) (III)

wherein Z is (L-H) or a reducible Lewis Acid, L is an neutral Lewis base; H is hydrogen; (L-H)⁺ is a Bronsted acid; A^{d-} is a non-coordinating anion having the charge d-; and d is an integer from 1 to 3 (such as 1, 2 or 3). Optionally, Z is (Ar₃C⁺), where Ar is aryl or aryl substituted with a heteroatom, a C₁ to C₄₀ hydrocarbyl, or a substituted C₁ to C₄₀ hydrocarbyl. The anion component A^{d-} includes those having the formula [M^{k+}Qₙ]^{d-} wherein k is 1, 2, or 3; n is 1, 2, 3, 4, 5, or 6 (preferably 1, 2, 3, or 4); n−k=d; M is an element selected from Group 13 of the Periodic Table of the Elements, preferably boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 40 carbon atoms (optionally with the proviso that in not more than 1 occurrence is Q a halide). Preferably, each Q is a fluorinated hydrocarbyl group having 1 to 40 (such as 1 to 30, such as 1 to 20) carbon atoms, more preferably each Q is a fluorinated aryl group, such as a perfluorinated aryl group and most preferably each Q is a pentafluoryl aryl group or perfluoronaphthalenyl group. Examples of suitable A^{d-} also include diboron compounds as disclosed in U.S. Pat. No. 5,447,895, which is fully incorporated herein by reference.

In particularly useful embodiments of the invention, the activator is soluble in non-aromatic-hydrocarbon solvents, such as aliphatic solvents.

In embodiments of the invention, the activators described herein have a solubility of more than 10 mM (or more than 20 mM, or more than 50 mM) at 25° C. (stirred 2 hours) in methylcyclohexane and/or of more than 1 mM (or more than 10 mM, or more than 20 mM) at 25° C. (stirred 2 hours) in isohexane.

Non-coordinating anion activator compounds that are useful in this invention include one or more of: N,N-di(hydrogenated tallow)methylammonium[tetrakis(pentafluorophenyl)borate], N,N-di(octadecyl)tolylammonium [tetrakis(pentafluorophenyl)borate], N,N-di(hydrogenated tallow)methylammonium[tetrakis(pentafluoronaphthyl)borate], N,N-di(octadecyl)tolylammonium [tetrakis(pentafluoronaphthyl)borate], N,N-dimethyl-anilinium [tetrakis(perfluorophenyl)borate], N,N-dimethyl-anilinium [tetrakis(perfluoronaphthyl)borate], N-methyl-4-nonadecyl-N-octadecylanilinium [tetrakis(perfluorophenyl)borate], N-methyl-4-hexadecyl-N-octadecylanilinium [tetrakis(perfluorophenyl)borate], N-methyl-4-tetradecyl-N-octadecylanilinium [tetrakis(perfluorophenyl)borate], N-methyl-4-dodecyl-N-octadecylanilinium [tetrakis(perfluorophenyl)borate], N-methyl-4-decyl-N-octadecylanilinium [tetrakis(perfluorophenyl)borate], N-methyl-4-octyl-N-octadecylanilinium [tetrakis(perfluorophenyl)borate], N-methyl-4-hexyl-N-octadecylanilinium [tetrakis(perfluorophenyl)borate], N-methyl-4-butyl-N-octadecylanilinium [tetrakis(perfluorophenyl)borate], N-methyl-4-octadecyl-N-decylanilinium [tetrakis(perfluorophenyl)borate], N-methyl-4-nonadecyl-N-dodecylanilinium [tetrakis(perfluorophenyl)borate], N-methyl-4-nonadecyl-N-tetradecylanilinium [tetrakis(perfluorophenyl)borate], N-methyl-4-nonadecyl-N-hexadecylanilinium [tetrakis(perfluorophenyl)borate], N-ethyl-4-nonadecyl-N-octadecylanilinium [tetrakis(perfluorophenyl)borate], N-methyl-N,N-dioctadecylammonium [tetrakis(perfluorophenyl)borate], N-methyl-N,N-dihexadecylammonium [tetrakis(perfluorophenyl)borate], N-methyl-N,N-ditetradecylammonium [tetrakis(perfluorophenyl)borate], N-methyl-N,N-didodecylammonium [tetrakis(perfluorophenyl)borate], N-methyl-N,N-didecylammonium [tetrakis(perfluorophenyl)borate], N-methyl-N,N-dioctylammonium [tetrakis(perfluorophenyl)borate], N-ethyl-N,N-dioctadecylammonium [tetrakis(perfluorophenyl)borate], N,N-di(octadecyl)tolylammonium [tetrakis(perfluorophenyl)borate], N,N-di(hexadecyl)tolylammonium [tetrakis(perfluorophenyl)borate], N,N-di(tetradecyl)tolylammonium [tetrakis(perfluorophenyl)borate], N,N-di(dodecyl)tolylammonium [tetrakis(perfluorophenyl)borate], N-octadecyl-N-hexadecyl-tolylammonium [tetrakis(perfluorophenyl)borate], N-octadecyl-N-hexadecyl-tolylammonium [tetrakis(perfluorophenyl)borate], N-octadecyl-N-tetradecyl-tolylammonium [tetrakis(perfluorophenyl)borate], N-octadecyl-N-dodecyl-tolylammonium [tetrakis(perfluorophenyl)borate], N-octadecyl-N-decyl-tolylammonium [tetrakis(perfluorophenyl)borate], N-hexadecyl-N-tetradecyl-tolylammonium [tetrakis(perfluorophenyl)borate], N-hexadecyl-N-dodecyl-tolylammonium [tetrakis(perfluorophenyl)borate], N-hexadecyl-N-decyl-tolylammonium [tetrakis(perfluorophenyl)borate], N-tetradecyl-N-dodecyl-tolylammonium [tetrakis(perfluorophenyl)borate], N-tetradecyl-N-decyl-tolylammonium [tetrakis(perfluorophenyl)borate], N-dodecyl-N-decyl-tolylammonium [tetrakis(perfluorophenyl)borate], N-methyl-N-octadecylanilinium [tetrakis(perfluorophenyl)borate], N-methyl-N-hexadecylanilinium [tetrakis(perfluorophenyl)borate], N-methyl-N-tetradecylanilinium [tetrakis(perfluorophenyl)borate], N-methyl-N-dodecylanilinium [tetrakis(perfluorophenyl)borate], N-methyl-N-decylanilinium [tetrakis(perfluorophenyl)borate], and N-methyl-N-octylanilinium [tetrakis(perfluorophenyl)borate].

Preferred activators for use herein also include N-methyl-4-nonadecyl-N-octadecylbenzenaminium tetrakis(pentafluorophenyl)borate, N-methyl-4-nonadecyl-N-octadecylbenzenaminium tetrakis(perfluoronaphthalenyl)borate, N,N-dimethylanilinium tetrakis(perfluoronaphthalenyl)borate, N,N-dimethylanilinium tetrakis(perfluorobiphenyl)borate, N,N-dimethylanilinium tetrakis(perfluorophenyl)borate, N,N-dimethylanilinium tetrakis(3,5-bis(trifluoromethyl)phenyl)borate, triphenylcarbenium tetrakis(perfluoronaphthalenyl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, [Me₃NH⁺][B(C₆F₅)₄⁻]; 1-(4-(tris(pentafluorophenyl)borate)-2,3,5,6-tetrafluorophenyl)pyrrolidinium; and tetrakis(pentafluorophenyl)borate, 4-(tris(pentafluorophenyl)borate)-2,3,5,6-tetrafluoropyridine.

In a preferred embodiment, the activator comprises a triaryl carbenium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthalenyl)borate, triphenylcarbenium tetrakis(perfluorobiphenyl)borate, triphenylcarbenium tetrakis(3,5-bis(trifluoromethyl)phenyl)borate).

In another embodiment, the activator comprises one or more of trialkylammonium tetrakis(pentafluorophenyl)borate, N,N-dialkylanilinium tetrakis(pentafluorophenyl)borate, dioctadecylmethylammonium tetrakis(pentafluorophenyl)borate, dioctadecylmethylammonium tetrakis(perfluoronaphthalenyl)borate, N,N-dimethyl-(2,4,6-trimethylanilinium) tetrakis(pentafluorophenyl)borate, trialkylammonium tetrakis-(2,3,4,6-tetrafluorophenyl) borate, N,N-dialkylanilinium tetrakis-(2,3,4,6-tetrafluorophenyl)borate, trialkylammonium tetrakis(perfluoronaphthalenyl)borate, N,N-dialkylanilinium tetrakis(perfluoronaphthalenyl)borate, trialkylammonium tetrakis(perfluorobiphenyl)borate, N,N-dialkylanilinium tetrakis(perfluorobiphenyl)borate, trialkylammonium tetrakis(3,5-bis(trifluoromethyl)phenyl)borate, N,N-dialkylanilinium tetrakis(3,5-bis(trifluoromethyl)phenyl)borate, N,N-dialkyl-(2,4,6-trimethylanilinium) tetrakis(3,5-bis(trifluoromethyl)phenyl)borate, di-(i-propyl)ammonium tetrakis(pentafluorophenyl)borate, (where alkyl is methyl, ethyl, propyl, n-butyl, sec-butyl, or t-butyl).

The typical activator-to-catalyst ratio, e.g., all NCA activators-to-all catalysts ratio is about a 1:1 molar ratio. Alternate preferred ranges include from 0.1:1 to 100:1, alternately from 0.5:1 to 200:1, alternately from 1:1 to 500:1 alternately from 1:1 to 1000:1. A particularly useful range is from 0.5:1 to 10:1, preferably 1:1 to 5:1.

Additional useful activators and the synthesis of non-aromatic-hydrocarbon soluble activators, are described in U.S. Ser. No. 16/394,166 filed Apr. 25, 2019, U.S. Ser. No. 16/394,186, filed Apr. 25, 2019, and U.S. Ser. No. 16/394,197, filed Apr. 25, 2019, which are incorporated by reference herein. For a more detailed description of activators useful herein please see U.S. Pat. Nos. 8,658,556, 6,211,105, WO 2004/026921 page 72, paragraph [00119] to page 81 paragraph [00151]. A list of additionally particularly useful activators that can be used in the practice of this invention may be found at page 72, paragraph [00177] to page 74, paragraph [00178] of WO 2004/046214.

It is also within the scope of the present disclosure that the catalyst compounds can be combined with combinations of alumoxanes and NCA's (see for example, U.S. Pat. Nos. 5,153,157; 5,453,410; EP 0 573 120 B1; WO 1994/007928; and WO 1995/014044 (the disclosures of which are incorporated herein by reference in their entirety) which discuss the use of an alumoxane in combination with an ionizing activator).

### Support Material

In embodiments of the invention herein, the catalyst systems comprise a support material. Preferably, the support material is a porous support material, for example, talc, and inorganic oxides. Other support materials include zeolites, clays, organoclays, or any other organic or inorganic support material, or mixtures thereof. As used herein, “support” and “support material” are used interchangeably.

Preferably, the support material is an inorganic oxide in a finely divided form. Suitable inorganic oxide materials for use in the supported catalyst systems herein include Groups 2, 4, 13, and 14 metal oxides such as silica, alumina, and mixtures thereof. Other inorganic oxides that may be employed, either alone or in combination, with the silica or alumina are magnesia, titania, zirconia, and the like. Other suitable support materials, however, can be employed, for example, finely divided functionalized polyolefins such as finely divided polyethylene. Particularly useful supports include magnesia, titania, zirconia, montmorillonite, phyllosilicate, zeolites, talc, clays, and the like. Also, combinations of these support materials may be used, for example, silica-chromium, silica-alumina, silica-titania, and the like. Preferred support materials include Al₂O₃, ZrO₂, SiO₂, and combinations thereof, more preferably, SiO₂, Al₂O₃, or SiO₂/Al₂O₃.

The support material, such as an inorganic oxide, typically has a surface area in the range of from about 10 m²/g to about 700 m²/g, pore volume in the range of from about 0.1 cc/g to about 4.0 cc/g, and average particle size in the range of from about 5 μm to about 500 μm. More preferably, the surface area of the support material is in the range of from about 50 m²/g to about 500 m²/g, pore volume of from about 0.5 cc/g to about 3.5 cc/g, and average particle size of from about 10 m to about 200 m. Most preferably, the surface area of the support material is in the range of from about 100 m²/g to about 400 m²/g, pore volume from about 0.8 cc/g to about 3.0 cc/g, and average particle size is from about 5 μm to about 100 μm. The average pore size of the support material useful in the invention is in the range of from 10 to 1,000 Å, preferably, 50 to about 500 Å, and most preferably, 75 to about 350 Å. In some embodiments, the support material is a high surface area, amorphous silica (surface area of 300 m²/gm or more, pore volume of 1.65 cm³/gm or more), and is available under the tradenames of DAVISON 952 or DAVISON 955 by the Davison Chemical Division of W. R. Grace and Company, are particularly useful. In other embodiments, DAVIDSON 948 is used. Alternately, the support material, such as an inorganic oxide, such as silica, has a surface area of about 300 m²/g to about 800 m²/g, alternately from 400 m²/g to 700 m²/g.

In some embodiments of this invention, the support material may be dry, that is, free of absorbed water. Drying of the support material can be achieved by heating or calcining at about 100° C. to about 1,000° C., preferably, at least about 600° C. When the support material is silica, it is typically heated to at least 200° C., preferably, about 200° C. to about 850° C., and most preferably, at about 600° C.; and for a time of about 1 minute to about 100 hours, from about 12 hours to about 72 hours, or from about 24 hours to about 60 hours. The calcined support material, preferably, has at least some reactive hydroxyl (OH) groups.

In a particularly useful embodiment, the support material is fluorided. Fluoriding agent containing compounds may be any compound containing a fluorine atom. Particularly desirable are inorganic fluorine containing compounds are selected from the group consisting of NH₄BF₄, (NH₄)₂SiF₆, NH₄PF₆, NH₄F, (NH₄)₂TaF₇, NH₄NbF₄, (NH₄)₂GeF₆, (NH₄)₂SmF₆, (NH₄)₂TiF₆, (NH₄)₂ZrF₆, MoF₆, ReF₆, GaF₃, SO₂ClF, F₂, SiF₄, SF₆, ClF₃, ClF 5, BrFs, IF₇, NF₃, HF, BF₃, NHF₂ and NH₄HF₂. Of these, ammonium hexafluorosilicate and ammonium tetrafluoroborate are useful. Combinations of these compounds may also be used.

Ammonium hexafluorosilicate and ammonium tetrafluoroborate fluorine compounds are typically solid particulates as are the silicon dioxide supports. A desirable method of treating the support with the fluorine compound is to dry mix the two components by simply blending at a concentration of from 0.01 to 10.0 millimole F/g of support, desirably in the range of from 0.05 to 6.0 millimole F/g of support, and most desirably in the range of from 0.1 to 3.0 millimole F/g of support. The fluorine compound can be dry mixed with the support either before or after charging to a vessel for dehydration or calcining the support. Accordingly, the fluorine concentration present on the support is in the range of from 0.1 to 25 wt %, alternately 0.19 to 19 wt %, alternately from 0.6 to 3.5 wt %, based upon the weight of the support.

The above two metal catalyst components described herein are generally deposited on the support material at a loading level of 10-100 micromoles of metal per gram of solid support; alternately 20-80 micromoles of metal per gram of solid support; or 40-60 micromoles of metal per gram of support. But greater or lesser values may be used provided that the total amount of solid complex does not exceed the support's pore volume.

Scavengers, Chain Transfer Agents and/or Co-Activators

In addition to the activator compounds, scavengers, chain transfer agents or co-activators may also be used. Aluminum alkyl or organoaluminum compounds which may be utilized as scavengers or co-activators include, for example, one or more of those represented by the formula AlR₃, where each R is, independently, a C₁-C₈ aliphatic radical, preferably methyl, ethyl, propyl, butyl, pentyl, hexyl octyl or an isomer thereof), especially trimethylaluminum, triethylaluminum, triisobutylaluminum, tri-n-hexylaluminum, tri-n-octylaluminum or mixtures thereof.

In some embodiments, the catalyst systems will additionally comprise one or more scavenging compounds. Here, the term “scavenger” means a compound that removes polar impurities from the reaction environment. These impurities adversely affect catalyst activity and stability. Typically, the scavenging compound will be an organometallic compound such as the Group-13 organometallic compounds of U.S. Pat. Nos. 5,153,157; 5,241,025; and WO 1991/009882; WO 1994/003506; WO 1993/014132; and that of WO 1995/007941. Exemplary compounds include triethyl aluminum, triethyl borane, tri-iso-butyl aluminum, methyl alumoxane, iso-butyl alumoxane, and tri-n-octyl aluminum. Those scavenging compounds having bulky or C₆-C₂₀ linear hydrocarbyl substituents connected to the metal or metalloid center usually minimize adverse interaction with the active catalyst. Examples include triethyl aluminum, but more preferably, bulky compounds such as tri-iso-butyl aluminum, tri-iso-prenyl aluminum, and long-chain linear alkyl-substituted aluminum compounds, such as tri-n-hexyl aluminum, tri-n-octyl aluminum, or tri-n-dodecyl aluminum. When alumoxane is used as the activator, any excess over that needed for activation will scavenge impurities and additional scavenging compounds may be unnecessary. Alumoxanes also may be added in scavenging quantities with other activators, e.g., methylalumoxane, [Me₂HNPh]⁺[B(pfp)₄]⁻ or B(pfp)₃ (perfluorophenyl=pfp=C₆F₅).

Preferred aluminum scavengers useful in the invention include those where there is oxygen present. That is, the material per se or the aluminum mixture used as a scavenger, includes an aluminum/oxygen species, such as an alumoxane or alkylaluminum oxides, e.g., dialkyaluminum oxides, such as bis(diisobutylaluminum) oxide. In one aspect, aluminum containing scavengers can be represented by the formula ((R_{z}—Al—)_{y}O—)ₓ, wherein z is 1-2, y is 1-2, x is 1-100, and R is a C₁-C₁₂ hydrocarbyl group. In another aspect, the scavenger has an oxygen to aluminum (O/Al) molar ratio of from about 0.25 to about 1.5, more particularly from about 0.5 to about 1.

### Preparation of Mixed Catalyst Systems

The above two or more metal compound components can be combined to form a mixed catalyst system.

The two or more metal compounds can be added together in a desired ratio when combined, contacted with an activator, or contacted with a support material or a supported activator. The metal compounds may be added to the mixture sequentially or at the same time.

More complex procedures are possible, such as addition of a first metal compound to a slurry including a support or a supported activator mixture for a specified reaction time, followed by the addition of the second metal compound solution, mixed for another specified time, after which the mixture may be recovered for use in a polymerization reactor, such as by spray drying. Lastly, another additive, such as 1-hexene in about 10 vol % can be present in the mixture prior to the addition of the first metal catalyst compound.

The first metal compound may be supported via contact with a support material for a reaction time. The resulting supported catalyst composition may then be mixed with mineral oil to form a slurry, which may or may not include an activator. The slurry may then be admixed with a second metal compound prior to introduction of the resulting mixed catalyst system to a polymerization reactor. The second metal compounds may be admixed at any point prior to introduction to the reactor, such as in a polymerization feed vessel or in-line in a catalyst delivery system.

The mixed catalyst system may be formed by combining a first metal compound (for example a metal compound useful for producing a first polymer attribute, such as a high molecular weight polymer fraction or high comonomer content) with a support and activator, desirably in a first diluent such as an alkane or toluene, to produce a supported, activated catalyst compound. The supported activated catalyst compound, either isolated from the first diluent or not, is then combined in one embodiment with a high viscosity diluent such as mineral or silicon oil, or an alkane diluent comprising from 5 to 99 wt % mineral or silicon oil to form a slurry of the supported metal compound, followed by, or simultaneous to combining with a second metal compound (for example a metal compound useful for producing a second polymer attribute, such as a low molecular weight polymer fraction or low comonomer content), either in a diluent or as the dry solid compound, to form a supported activated mixed catalyst system (“mixed catalyst system”). The mixed catalyst system thus produced may be a supported and activated first metal compound in a slurry, the slurry comprising mineral or silicon oil, with a second metal compound that is not supported and not combined with additional activator, where the second metal compound may or may not be partially or completely soluble in the slurry. In one embodiment, the diluent consists of mineral oil.

Mineral oil, or “high viscosity diluents,” as used herein refers to petroleum hydrocarbons and mixtures of hydrocarbons that may include aliphatic, aromatic, and/or paraffinic components that are liquids at 23° C. and above, and typically have a molecular weight of at least 300 amu to 500 amu or more, and a viscosity at 40° C. of from 40 to 300 cSt or greater, or from 50 to 200 cSt in a particular embodiment. The term “mineral oil” includes synthetic oils or liquid polymers, polybutenes, refined naphthenic hydrocarbons, and refined paraffins known in the art, such as disclosed in Blue Book 2001, Materials, Compounding Ingredients, Machinery And Services For Rubber 189 247 (J. H. Lippincott, D. R. Smith, K. Kish & B. Gordon eds. Lippincott & Peto Inc. 2001). Preferred mineral and silicon oils useful in the present invention are those that exclude moieties that are reactive with the catalysts used herein, examples of which include hydroxyl and carboxyl groups.

The diluent may comprise a blend of a mineral, silicon oil, and/or and a hydrocarbon selected from the group consisting of C₁ to C₁₀ alkanes, C₆ to C₂₀ aromatic hydrocarbons, C₇ to C₂₁ alkyl-substituted hydrocarbons, and mixtures thereof. When the diluent is a blend comprising mineral oil, the diluent may comprise from 5 to 99 wt % mineral oil. In some embodiments, the diluent may consist essentially of mineral oil.

In one embodiment, the first metal compound is combined with an activator and a first diluent to form a catalyst slurry that is then combined with a support material. Until such contact is made, the support particles are preferably, not previously activated. The first metal compound can be in any desirable form such as a dry powder, suspension in a diluent, solution in a diluent, liquid, etc. The catalyst slurry and support particles are then mixed thoroughly, in one embodiment at an elevated temperature, so that both the first metal compound and the activator are deposited on the support particles to form a support slurry.

After the first metal compound and activator are deposited on the support, a second metal compound may then be combined with the supported first metal compound, wherein the second is combined with a diluent comprising mineral or silicon oil by any suitable means either before, simultaneous to, or after contacting the second metal compound with the supported first metal compound. In one embodiment, the first metal compound is isolated form the first diluent to a dry state before combining with the second metal compound. Preferably, the second metal compound is not activated, that is, not combined with any activator, before being combined with the supported first metal compound. The resulting solids slurry (including both the supported first and second metal compounds) is then preferably, mixed thoroughly at an elevated temperature.

A wide range of mixing temperatures may be used at various stages of making the mixed catalyst system. For example, in a specific embodiment, when the first metal compound and at least one activator, such as methylalumoxane, are combined with a first diluent to form a mixture, the mixture is preferably, heated to a first temperature of from 25° C. to 150° C., preferably, from 50° C. to 125° C., more preferably, from 75° C. to 100° C., most preferably, from 80° C. to 100° C. and stirred for a period of time from 30 seconds to 12 hours, preferably, from 1 minute to 6 hours, more preferably, from 10 minutes to 4 hours, and most preferably, from 30 minutes to 3 hours.

Next, that mixture is combined with a support material to provide a first support slurry. The support material can be heated, or dehydrated if desired, prior to combining. In one or more embodiments, the first support slurry is mixed at a temperature greater than 50° C., preferably, greater than 70° C., more preferably, greater than 80° C. and most preferably, greater than 85° C., for a period of time from 30 seconds to 12 hours, preferably, from 1 minute to 6 hours, more preferably, from 10 minutes to 4 hours, and most preferably, from 30 minutes to 3 hours. Preferably, the support slurry is mixed for a time sufficient to provide a collection of activated support particles that have the first metal compound deposited thereto. The first diluent can then be removed from the first support slurry to provide a dried supported first catalyst compound. For example, the first diluent can be removed under vacuum or by nitrogen purge.

Next, the second metal compound is combined with the activated first metal compound in the presence of a diluent comprising mineral or silicon oil in one embodiment. Preferably, the second metal compound is added in a molar ratio to the first metal compound in the range from 1:1 to 3:1. Most preferably, the molar ratio is approximately 1:1. The resultant slurry (or first support slurry) is preferably, heated to a first temperature from 25° C. to 150° C., preferably, from 50° C. to 125° C., more preferably, from 75° C. to 100° C., most preferably, from 80° C. to 100° C. and stirred for a period of time from 30 seconds to 12 hours, preferably, from 1 minute to 6 hours, more preferably, from 10 minutes to 4 hours, and most preferably, from 30 minutes to 3 hours.

The first diluent is an aromatic or alkane, preferably, hydrocarbon diluent having a boiling point of less than 200° C. such as toluene, xylene, hexane, etc., may be removed from the supported first metal compound under vacuum or by nitrogen purge to provide a supported mixed catalyst system. Even after addition of the oil and/or the second (or other) catalyst compound, it may be desirable to treat the slurry to further remove any remaining solvents such as toluene. This can be accomplished by an N₂ purge or vacuum, for example. Depending upon the level of mineral oil added, the resultant mixed catalyst system may still be a slurry or may be a free flowing powder that comprises an amount of mineral oil. Thus, the mixed catalyst system, while a slurry of solids in mineral oil in one embodiment, may take any physical form such as a free flowing solid. For example, the mixed catalyst system may range from 1 to 99 wt % solids content by weight of the mixed catalyst system (mineral oil, support, all catalyst compounds and activator(s)) in one embodiment.

### Polymerization Processes

In embodiments herein, the invention relates to polymerization processes where monomer (such as ethylene and or propylene), and optionally comonomer, are contacted with a catalyst system comprising at least one activator, at least one support and at least two catalyst compounds, such as the catalyst compounds described above. The support, catalyst compounds, and activator may be combined in any order, and are combined typically prior to contacting with the monomers.

Monomers useful herein include substituted or unsubstituted C₂ to C₄₀ olefins, preferably substituted or unsubstituted C₂ to C₄₀ alpha olefins, preferably C₂ to C₂₀ alpha olefins, preferably C₂ to C₁₂ alpha olefins, preferably ethylene, propylene, butene, pentene, hexene, heptene, octene, nonene, decene, undecene, dodecene and isomers thereof.

In an embodiment of the invention, the monomer comprises propylene and an optional comonomers comprising one or more of ethylene and C₄ to C₄₀ olefins, preferably C₄ to C₂₀ olefins, or preferably C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and/or one or more functional groups.

In another embodiment of the invention, the monomer comprises ethylene and optional comonomers comprising one or more C₃ to C₄₀ olefins, preferably C₄ to C₂₀ olefins, or preferably C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and/or one or more functional groups.

Exemplary C₂ to C₄₀ olefin monomers and optional comonomers include ethylene, propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, preferably hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, preferably norbornene, norbornadiene, and dicyclopentadiene.

In a preferred embodiment one or more dienes are present in the polymer produced herein at up to 10 wt %, preferably at 0.00001 to 1.0 wt %, preferably 0.002 to 0.5 wt %, even more preferably 0.003 to 0.2 wt %, based upon the total weight of the composition. In some embodiments 500 ppm or less of diene is added to the polymerization, preferably 400 ppm or less, preferably or 300 ppm or less. In other embodiments at least 50 ppm of diene is added to the polymerization, or 100 ppm or more, or 150 ppm or more.

Diolefin monomers useful in this invention include any hydrocarbon structure, preferably C₄ to C₃₀, having at least two unsaturated bonds, wherein at least two of the unsaturated bonds are readily incorporated into a polymer by either a stereospecific or a non-stereospecific catalyst(s). It is further preferred that the diolefin monomers be selected from alpha, omega-diene monomers (i.e., di-vinyl monomers). More preferably, the diolefin monomers are linear di-vinyl monomers, most preferably those containing from 4 to 30 carbon atoms. Examples of preferred dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (M_{w} less than 1000 g/mol). Preferred cyclic dienes include cyclopentadiene, vinylnorbornene, norbornadiene, ethylidene norbornene, divinylbenzene, dicyclopentadiene or higher ring containing diolefins with or without substituents at various ring positions.

In a particularly preferred embodiment the process of the invention relates to the polymerization of ethylene and at least one comonomer having from 3 to 8 carbon atoms, preferably, 4 to 8 carbon atoms. Particularly, the comonomers are on or more of propylene, 1-butene, 4-methyl-1-pentene, 3-methyl-1-pentene, 1-hexene and 1-octene, the most preferred being 1-hexene, 1-butene and/or 1-octene.

Polymerization processes according to the present disclosure can be carried out in any manner known in the art. Any suspension, slurry, high pressure tubular or autoclave process, or gas phase polymerization process known in the art can be used under polymerizable conditions. Such processes can be run in a batch, semi-batch, or continuous mode. Heterogeneous polymerization processes (such as gas phase and slurry phase processes) are useful. A heterogeneous process is defined to be a process where the catalyst system is not soluble in the reaction media. Alternatively, in other embodiments, the polymerization process is not homogeneous. A homogeneous polymerization process is defined to be a process where preferably at least 90 wt % of the product is soluble in the reaction media. Alternatively, the polymerization process is not a bulk process. A bulk process is defined to be a process where monomer concentration in all feeds to the reactor is preferably 70 vol % or more. Alternatively, no solvent or diluent is present or added in the reaction medium, (except for the small amounts used as the carrier for the catalyst system or other additives, or amounts typically found with the monomer; e.g., propane in propylene). In another embodiment, the process is a slurry process. As used herein the term “slurry polymerization process” means at least 95 wt % of polymer products derived from the supported catalyst are in granular form as solid particles (not dissolved in the diluent).

Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C₄₋₁₀ alkanes, chlorobenzene, and aromatic and alkyl substituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In a preferred embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, preferably aromatics are present in the solvent at less than 1 wt %, preferably less than 0.5 wt %, preferably less than 0 wt % based upon the weight of the solvents.

### Gas Phase Polymerization

In a preferred embodiment, the feed concentration of the monomers and comonomers for the polymerization is 60 vol % solvent or less, preferably 40 vol % or less, or preferably 20 vol % or less, based on the total volume of the feedstream. Preferably the polymerization is run in a bulk process.

Preferred polymerizations can be run at any temperature and/or pressure suitable to obtain the desired ethylene polymers and as described above. Typical pressures include pressures in the range of from about 0.35 MPa to about 10 MPa, preferably from about 0.45 MPa to about 6 MPa, or preferably from about 0.5 MPa to about 4 MPa in some embodiments.

In some embodiments, hydrogen is present in the polymerization reactor at a partial pressure of 0.001 to 50 psig (0.007 to 345 kPa), preferably from 0.01 to 25 psig (0.07 to 172 kPa), more preferably 0.1 to 10 psig (0.7 to 70 kPa).

In a class of embodiments, the polymerization is performed in the gas phase, preferably, in a fluidized bed gas phase process. Generally, in a fluidized bed gas phase process used for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. (See, for example, U.S. Pat. Nos. 4,543,399; 4,588,790; 5,028,670; 5,317,036; 5,352,749; 5,405,922; 5,436,304; 5,453,471; 5,462,999; 5,616,661; and 5,668,228; all of which are fully incorporated herein by reference.)

### Slurry Phase

In another embodiment of the invention, the polymerization is performed in the slurry phase. A slurry polymerization process generally operates between 1 to about 50 atmosphere pressure range (15 psi to 735 psi, 103 kPa to 5,068 kPa) or even greater and temperatures in the range of 0° C. to about 120° C. In a slurry polymerization, a suspension of solid, particulate polymer is formed in a liquid polymerization diluent medium to which monomer and comonomers, along with catalysts, are added. The suspension including diluent is intermittently or continuously removed from the reactor where the volatile components are separated from the polymer and recycled, optionally after a distillation, to the reactor. The liquid diluent employed in the polymerization medium is typically an alkane having from 3 to 7 carbon atoms, preferably a branched alkane. The medium employed should be liquid under the conditions of polymerization and relatively inert. When a propane medium is used, the process is typically operated above the reaction diluent critical temperature and pressure. Often, a hexane or an isobutane medium is employed.

In an embodiment, a preferred polymerization technique useful in the invention is referred to as a particle form polymerization, or a slurry process where the temperature is kept below the temperature at which the polymer goes into solution. Such technique is known in the art, and described in for instance U.S. Pat. No. 3,248,179. A preferred temperature in the particle form process is within the range of about 85° C. to about 110° C. Two preferred polymerization methods for the slurry process are those employing a loop reactor and those utilizing a plurality of stirred reactors in series, parallel, or combinations thereof. Non-limiting examples of slurry processes include continuous loop or stirred tank processes. Also, other examples of slurry processes are described in U.S. Pat. No. 4,613,484, which is herein fully incorporated by reference.

In another embodiment, the slurry process is carried out continuously in a loop reactor. The catalyst, as a slurry in isobutane or as a dry free flowing powder, is injected regularly to the reactor loop, which is itself filled with circulating slurry of growing polymer particles in a diluent of isobutane containing monomer and comonomer. Hydrogen, optionally, may be added as a molecular weight control. In one embodiment 500 ppm or less of hydrogen is added, or 400 ppm or less or 300 ppm or less. In other embodiments at least 50 ppm of hydrogen is added, or 100 ppm or more, or 150 ppm or more.

Reaction heat is removed through the loop wall since much of the reactor is in the form of a double-jacketed pipe. The slurry is allowed to exit the reactor at regular intervals or continuously to a heated low pressure flash vessel, rotary dryer and a nitrogen purge column in sequence for removal of the isobutane diluent and all unreacted monomer and comonomers. The resulting hydrocarbon free powder is then compounded for use in various applications.

In a preferred embodiment, the catalyst system used in the polymerization comprises no more than two catalyst compounds. A “reaction zone” also referred to as a “polymerization zone” is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In a preferred embodiment, the polymerization occurs in one reaction zone.

Useful reactor types and/or processes for the production of polyolefin polymers include, but are not limited to, UNIPOL™ Gas Phase Reactors (available from Univation Technologies); INEOS™ Gas Phase Reactors and Processes; Continuous Flow Stirred-Tank (CSTR) reactors (solution and slurry); Plug Flow Tubular reactors (solution and slurry); Slurry: (e.g., Slurry Loop (single or double loops)) (available from Chevron Phillips Chemical Company) and (Series Reactors) (available from Mitsui Chemicals)); BORSTAR™ Process and Reactors (slurry combined with gas phase); and Multi-Zone Circulating Reactors (MZCR) such as SPHERIZONE™ Reactors and Process available from Lyondell Basell.

In embodiments, the catalyst activity of the polymerization reaction is 2,000 g/g*cat or greater, 3,000 g/g*cat or greater, 4,250 g/g*cat or greater, 4,750 g/g*cat or greater, 5,000 g/g*cat or greater, 6,250 g/g*cat or greater, 8,500 g/g*cat or greater, 9,000 g/g*cat or greater, 9,500 g/g*cat or greater, or 9,700 g/g*cat or greater.

In a preferred embodiment, the polymerization:
1) is conducted at temperatures of 0 to 300° C. (preferably 25 to 150° C., preferably 40 to 120° C., preferably 45 to 80° C.);
2) is conducted at a pressure of atmospheric pressure to 10 MPa (preferably 0.35 to 10 MPa, preferably from 0.45 to 6 MPa, preferably from 0.5 to 4 MPa);
3) is conducted in an aliphatic hydrocarbon solvent (such as isobutane, butane, pentane, isopentane, hexane, isohexane, heptane, octane, dodecane, and mixtures thereof, cyclic and alicyclic hydrocarbons, such as cyclohexane, cycloheptane, methylcyclohexane, methylcycloheptane, and mixtures thereof; preferably where aromatics are preferably present in the solvent at less than 1 wt %, preferably less than 0.5 wt %, preferably at 0 wt % based upon the weight of the solvents);
4) wherein the catalyst system used in the polymerization preferably comprises at least one catalyst compound represented by Formula (I) and at least one catalyst compound represented by Formula (A), (such as(propylcyclopentadienyl)(propylenecyclopentadienyl) hafnium n-butyl, and (1E,1′E)-1,1′-(pyridine-2,6-diyl)bis(N-(2-chloro-4,6-dimethylphenyl)ethan-1-imine)FeCl₂), a support such as silica, and an activator (such as methylalumoxane, N,N-dimethylanilinium tetrakis(pentafluorophenyl)borate, or N,N-dimethylanilinium tetrakis(perfluoronaphthyl)borate);
5) the polymerization preferably occurs in one reaction zone;
6) the productivity of the catalyst compound is at least 3,000 g/g*cat or greater, at least 4,250 g/g*cat or greater, at least 4,750 g/g*cat or greater, at least 5,000 g/g*cat or greater, at least 6,250 g/g*cat or greater, at least 8,500 g/g*cat or greater, at least 9,000 g/g*cat or greater, at least 9,500 g/g*cat or greater, or at least 9,700 g/g*cat or greater;
7) optionally scavengers (such as trialkyl aluminum compounds) are absent (e.g. present at zero mol %, alternately the scavenger is present at a molar ratio of scavenger metal to transition metal of less than 100:1, preferably less than 50:1, preferably less than 15:1, preferably less than 10:1); and
8) optionally hydrogen is present in the polymerization reactor at a partial pressure of 0.001 to 50 psig (0.007 to 345 kPa) (preferably from 0.01 to 25 psig (0.07 to 172 kPa), more preferably 0.1 to 10 psig (0.7 to 70 kPa)).

### Polyolefin Products

This invention also relates to compositions of matter produced by the methods described herein.

In a preferred embodiment, the process described herein produces ethylene homopolymers or ethylene copolymers, such as ethylene-alpha-olefin (preferably C₃ to C₂₀) copolymers (such as ethylene-butene copolymers, ethylene-hexene and/or ethylene-octene copolymers).

In a preferred embodiment, the ethylene copolymers produced herein have 100 to 75 mol % ethylene and from 0 to 25 mole % (alternately from 0.5 to 20 mole %, alternately from 1 to 15 mole %, preferably from 3 to 10 mole %) of one, two, three, four or more C₃ to C₄₀ olefin monomers, for example, C₃ to C₂₀ α-olefin monomers (such as propylene, butene, hexene, octene, decene, dodecene, preferably propylene, butene, hexene, octene, or a mixture thereof).

The polyethylene composition may comprise from 99.0 to about 80.0 wt %, 99.0 to 85.0 wt %, 99.0 to 87.5 wt %, 99.0 to 90.0 wt %, 99.0 to 92.5 wt %, 99.0 to 95.0 wt %, or 99.0 to 97.0 wt %, of polymer units derived from ethylene and about 1.0 to about 20.0 wt %, 1.0 to 15.0 wt %, 0.5 to 12.5 wt %, 1.0 to 10.0 wt %, 1.0 to 7.5 wt %, 1.0 to 5.0 wt %, or 1.0 to 3.0 wt % of polymer units derived from one or more C₃ to C₂₀ α-olefin comonomers, preferably C₃ to C₁₀ α-olefins, and more preferably C₄ to C₈ α-olefins, such as hexene and octene. The α-olefin comonomer may be linear or branched, and two or more comonomers may be used, if desired.

Examples of suitable comonomers include propylene, butene, 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene. Particularly suitable comonomers include 1-butene, 1-hexene, and 1-octene, 1-hexene, and mixtures thereof.

The polyethylene composition may have a melt index (MI, I_{2.16}, ASTM 1238, 2.16 kg, 190° C.) of about 0.10 g/10 min or more, alternately 0.15 g/10 min or more, alternately about 0.18 g/10 min or more, alternately 0.20 g/10 min or more, alternately 0.22 g/10 min or more, alternately 0.25 g/10 min or more, alternately 0.28 g/10 min or more, alternately 0.30 g/10 min or more, alternately 30 g/10 min or less, alternately 20 g/10 min or less, alternately 10 g/10 min or less, alternately 1 g/10 min or less, alternately about 0.1 to about 30 g/10 min, 0.15 to 20 g/10 min, about 0.18 to about 20 g/10 min, 0.22 to 10 g/10 min, 0.25 to 10 g/10 min.

The polyethylene composition may have a high load melt index (HLMI, I_{21.6}, (ASTM 1238, 21.6 kg, 190° C.) of, from 1 to 100 g/10 min, from 1 to 60 g/10 min, 5 to 40 g/10 min, 5 to 50 g/10 min, 15 to 50 g/10 min, or 20 to 50 g/10 min.

The polyethylene composition may have a melt index ratio (MIR), from 10 to 150, alternately from 15 to 150, alternately from 20 to 100, alternately from 25 to 60, alternately from 30 to 55, alternately from 35 to 55, and alternately from 35 to 50 or 35 to 45. MIR is defined as I_{21.6}/I_{2.16}.

The polyethylene composition may have a density of 0.910 g/cc or more, alternately 0.915 g/cc or more; alternately 0.92 g/cc or more; alternately 0.935 g/cc or more, alternately 0.938 g/cc or more, alternately the polyethylene composition has a density of 0.910 to 0.967 g/cc, alternately 0.915 to 0.967, alternately 0.915 to 0.960, alternately 0.915 to 0.950, alternately 0.915 to 0.940 g/cc. Density is determined according to ASTM D 1505 using a density-gradient column on a compression-molded specimen that has been slowly cooled to room temperature (i.e., over a period of 10 minutes or more) and allowed to age for a sufficient time that the density is constant within +/−0.001 g/cm³).

The polyethylene composition may have a a weight average molecular weight, Mw, as determined by gel permeation chromatography “GPC” (see GPC procedure described below), of 100,000 to 1,000,000 g/mol, such as from 50,000 to 800,000 g/mol, such as form 70,000 to 700,000 g/mol.

The polyethylene composition may have a molecular weight distribution (MWD, defined as M_{w}/Mₙ) of about 2 to about 50, about 5 to about 50.

“BOCD” refers to a Broad Orthogonal Composition Distribution in which the comonomer of a copolymer is incorporated predominantly in the high molecular weight chains or species of a polyolefin polymer or composition. The distribution of the short chain branches can be measured, for example, using GPC (see procedure described below) to indicate a level of the BOCD.

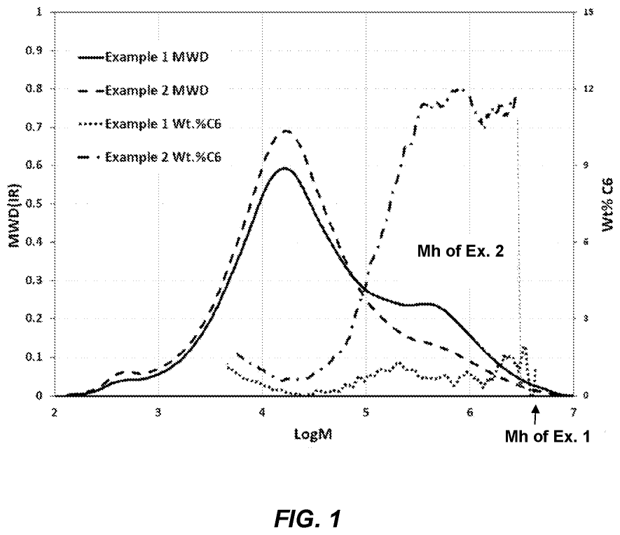

Alternately, Comonomer Distribution Index (CDI) can be used to indicate a level of the BOCD nature. Comonomer Distribution Index (CDI) is defined as follows:

$$CDI = \frac{\begin{matrix}Comonomer content of high molecular \\ weight fractions [ Mw , Mh ]\end{matrix}}{Average comonomer content [ M = 3162 , Mh ]}$$

where the high molecular weight fractions are defined as molecules above the weight average molecular weight (M_{w}) as determined by GPC (see procedure described below). Comonomer content in either weight or molar basis can be used, as long as the same basis is used in the numerator and denominator. To address comonomer content measurement noise at both ends of the molecular weight distribution, the unreliable comonomer content results at both low and high end of the molecular weight distribution are excluded in the calculation, i.e., M=3162 g/mol is chosen as the low end of molecular weight distribution (and data below 3162 g/mol are excluded) and Mₕ is the molecular weight above the Mw, beyond which no reliable comonomer content data are obtained using the GPC procedure below, this typically occurs when the polymer concentration in the sample becomes too small (for example, see FIG. 1 for Mh of Examples 1 and 2). The comonomer content over the limited full distribution range and the high molecular weight region are both weight average values. When CDI is equal or very close to 1, the comonomer distribution is considered uniform, indicating the high molecular and low weight fractions have comonomer contents close to the overall average. When CDI is significantly different from 1, the comonomer distribution is not uniform. A CDI higher than 1 indicates the comonomer content is higher on the high molecular fractions or BOCD in nature. On the other hand, a CDI lower than 1 would indicate the comonomer content is lower on the high molecular fractions and the distribution is so-called conventional type. Polymers prepared herein preferably have a CDI of 1.3 or more, alternately 1.5 or more, alternately 2 or more, alternately 3 or more, alternately 3.5 or more.

In any of the embodiments described herein, the polyethylene composition may be a multimodal polyethylene composition such as a bimodal polyethylene composition. As used herein, “multimodal” means that there are at least two distinguishable peaks in a molecular weight distribution curve (as determined using GPC, see GPC procedure described below) of a polyethylene composition. For example, if there are two distinguishable peaks in the molecular weight distribution curve such composition may be referred to as bimodal composition. Typically, if there is only one peak (e.g., monomodal), no obvious valley between the peaks, either one of the peaks is not considered as a distinguishable peak, or both peaks are not considered as distinguishable peaks, then such a composition may be referred to as non-bimodal. For example, in U.S. Pat. Nos. 8,846,841 and 8,691,715, FIGS. 1-5 illustrate representative bimodal molecular weight distribution curves. In these figures, there is a valley between the peaks, and the peaks can be separated or deconvoluted. Often, a bimodal molecular weight distribution is characterized as having an identifiable high molecular weight component (or distribution) and an identifiable low molecular weight component (or distribution). In contrast, in U.S. Pat. Nos. 8,846,841 and 8,691,715, FIGS. 6 to 11 illustrate representative non-bimodal molecular weight distribution curves. These include unimodal molecular weight distributions as well as distribution curves containing two peaks that cannot be easily distinguished, separated, or deconvoluted.

### Blends

In another embodiment, the polymer (preferably the ethylene homo- or co-polymer) produced herein is combined with one or more additional polymers in a blend prior to being formed into a film, molded part, or other article. As used herein, a “blend” may refer to a dry or extruder blend of two or more different polymers, and in-reactor blends, including blends arising from the use of multi or mixed catalyst systems in a single reactor zone, and blends that result from the use of one or more catalysts in one or more reactors under the same or different conditions (e.g., a blend resulting from in series reactors (the same or different) each running under different conditions and/or with different catalysts).

Useful additional polymers include other polyethylenes, isotactic polypropylene, highly isotactic polypropylene, syndiotactic polypropylene, random copolymer of propylene and ethylene, and/or butene, and/or hexene, polybutene, ethylene vinyl acetate, LDPE, LLDPE, HDPE, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

In a preferred embodiment, the polymer (preferably the ethylene-homo- or co-polymer) is present in the above blends, at from 10 to 99 wt %, based upon the weight of the polymers in the blend, preferably 20 to 95 wt %, even more preferably at least 30 to 90 wt %, even more preferably at least 40 to 90 wt %, even more preferably at least 50 to 90 wt %, even more preferably at least 60 to 90 wt %, even more preferably at least 70 to 90 wt %.

The blends described above may be produced by mixing the polymers of the invention with one or more polymers (as described above), by connecting reactors together in series to make reactor blends or by using more than one catalyst in the same reactor to produce multiple species of polymer. The polymers can be mixed together prior to being put into the extruder or may be mixed in an extruder.

The blends may be formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifners, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc; and the like.

### End Uses

Any of the foregoing polymers and compositions in combination with optional additives (see, for example, US Patent Application Publication No. 2016/0060430, paragraphs [0082]-[0093]) may be used in a variety of end-use applications. Such end uses may be produced by methods known in the art. Exemplary end uses are films, film-based products, sheets, wire and cable coating compositions, articles formed by molding techniques, e.g., injection or blow molding, extrusion coating, foaming, casting, and combinations thereof. Preferred end use applications include fiber extrusion and co-extrusion, including melt spinning, solution spinning and melt blown fiber operations for use in woven or non-woven form to make filters, diaper fabrics, medical garments, geotextiles, etc. Preferred end use applications also include gas-assisted injection molding, extrusion blow molding, injection blow molding, injection stretch blow molding, compression molding, rotational molding, foam molding, thermoforming, sheet extrusion, and profile extrusion. Additional end uses also include products made from films or sheets, e.g., bags, packaging, housewrap and personal care films, diaper backsheets, pouches, medical products, such as for example, medical films and intravenous (IV) bags.

### Films

Films include monolayer or multilayer films. Films include those film structures and film applications known to those skilled in the art. Specific end use films include, for example, blown films, cast films, stretch films, stretch/cast films, stretch cling films, stretch handwrap films, machine stretch wrap, shrink films, shrink wrap films, green house films, laminates, and laminate films. Exemplary films are prepared by any conventional technique known to those skilled in the art, such as for example, techniques utilized to prepare blown, extruded, and/or cast stretch and/or shrink films (including shrink-on-shrink applications).

In one embodiment, multilayer films or multiple-layer films may be formed by methods well known in the art. The total thickness of multilayer films may vary based upon the application desired. A total film thickness of about 5-100 μm, more typically about 10-50 μm, is suitable for most applications. Those skilled in the art will appreciate that the thickness of individual layers for multilayer films may be adjusted based on desired end-use performance, resin or copolymer employed, equipment capability, and other factors. The materials forming each layer may be coextruded through a coextrusion feedblock and die assembly to yield a film with two or more layers adhered together but differing in composition. Coextrusion can be adapted for use in both cast film or blown film processes. Exemplary multilayer films have at least two, at least three, or at least four layers. In one embodiment the multilayer films are composed of five to ten layers.

To facilitate discussion of different film structures, the following notation is used herein. Each layer of a film is denoted “A” or “B”. Where a film includes more than one A layer or more than one B layer, one or more prime symbols (′, ″, ′″, etc.) are appended to the A or B symbol to indicate layers of the same type that can be the same or can differ in one or more properties, such as chemical composition, density, melt index, thickness, etc. Finally, the symbols for adjacent layers are separated by a slash (/). Using this notation, a three-layer film having an inner layer disposed between two outer layers would be denoted A/B/A′. Similarly, a five-layer film of alternating layers would be denoted A/B/A′/B′/A″. Unless otherwise indicated, the left-to-right or right-to-left order of layers does not matter, nor does the order of prime symbols; e.g., an A/B film is equivalent to a B/A film, and an A/A′/B/A″ film is equivalent to an A/B/A′/A″ film, for purposes described herein. The relative thickness of each film layer is similarly denoted, with the thickness of each layer relative to a total film thickness of 100 (dimensionless) indicated numerically and separated by slashes; e.g., the relative thickness of an A/B/A′ film having A and A′ layers of 10 μm each and a B layer of 30 μm is denoted as 20/60/20.

The thickness of each layer of the film, and of the overall film, is not particularly limited, but is determined according to the desired properties of the film. Typical film layers have a thickness of from about 1 to about 1,000 μm, more typically from about 5 to about 100 μm, and typical films have an overall thickness of from about 10 to about 100 μm.

In some embodiments, and using the nomenclature described above, the present invention provides for multilayer films with any of the following exemplary structures: (a) two-layer films, such as A/B and B/B′; (b) three-layer films, such as A/B/A′, A/A′/B, B/A/B′ and B/B′/B″; (c) four-layer films, such as A/A′/A″/B, A/A′/B/A″, A/A′/B/B′, A/B/A′/B′, A/B/B′/A′, B/A/A′/B′, A/B/B′/B″, B/A/B′/B″ and BB/B/B″′; (d) five-layer films, such as A/A′/A″/A′/B, A/A′/A″/B/A″′, A/A′/B/A″/A″′, A/A′/A″/B/B′, A/A′/B/A″/B′, A/A′/B/B′/A″, A/B/A′/B′/A″, A/B/A′/A″/B, B/A/A′/A″/B′, A/A′/B/B′/B″, A/B/A′/B′/B″, A/BB/B″/A′, B/A/A′/B′/B″, B/A/B′/A′/B″, B/A/B′/B″/A′, A/B/B′/B″/B″′, B/A/B′/B″/B″′, B/B′/A/B″/B″′, and B/B′/B″/B″′/B″″; and similar structures for films having six, seven, eight, nine, twenty-four, forty-eight, sixty-four, one hundred, or any other number of layers. It should be appreciated that films having still more layers.

In any of the embodiments above, one or more A layers can be replaced with a substrate layer, such as glass, plastic, paper, metal, etc., or the entire film can be coated or laminated onto a substrate. Thus, although the discussion herein has focused on multilayer films, the films may also be used as coatings for substrates such as paper, metal, glass, plastic, and other materials capable of accepting a coating.

The films can further be embossed, or produced or processed according to other known film processes. The films can be tailored to specific applications by adjusting the thickness, materials and order of the various layers, as well as the additives in or modifiers applied to each layer.

### Stretch Films

The polymers and compositions as described above may be utilized to prepare stretch films. Stretch films are widely used in a variety of bundling and packaging applications. The term “stretch film” indicates films capable of stretching and applying a bundling force, and includes films stretched at the time of application as well as “pre-stretched” films, i.e., films which are provided in a pre-stretched form for use without additional stretching. Stretch films can be monolayer films or multilayer films, and can include conventional additives, such as cling-enhancing additives such as tackifiers, and non-cling or slip additives, to tailor the slip/cling properties of the film.

### Shrink Films

The polymers and compositions as described above may be utilized to prepare shrink films. Shrink films, also referred to as heat-shrinkable films, are widely used in both industrial and retail bundling and packaging applications. Such films are capable of shrinking upon application of heat to release stress imparted to the film during or subsequent to extrusion. The shrinkage can occur in one direction or in both longitudinal and transverse directions. Conventional shrink films are described, for example, in WO 2004/022646.

Industrial shrink films are commonly used for bundling articles on pallets. Typical industrial shrink films are formed in a single bubble blown extrusion process to a thickness of about 80 to 200 μm, and provide shrinkage in two directions, typically at a machine direction (MD) to transverse direction (TD) ratio of about 60:40.

Retail films are commonly used for packaging and/or bundling articles for consumer use, such as, for example, in supermarket goods. Such films are typically formed in a single bubble blown extrusion process to a thickness of about 35 to 80, pm, with a typical MD:TD shrink ratio of about 80:20.

Films may be used in “shrink-on-shrink” applications. “Shrink-on-shrink,” as used herein, refers to the process of applying an outer shrink wrap layer around one or more items that have already been individually shrink wrapped (herein, the “inner layer” of wrapping). In these processes, it is desired that the films used for wrapping the individual items have a higher melting (or shrinking) point than the film used for the outside layer. When such a configuration is used, it is possible to achieve the desired level of shrinking in the outer layer, while preventing the inner layer from melting, further shrinking, or otherwise distorting during shrinking of the outer layer. Some films described herein have been observed to have a sharp shrinking point when subjected to heat from a heat gun at a high heat setting, which indicates that they may be especially suited for use as the inner layer in a variety of shrink-on-shrink applications.

### Greenhouse Films

The polymers and compositions as described above may be utilized to prepare stretch to prepare greenhouse films. Greenhouse films are generally heat retention films that, depending on climate requirements, retain different amounts of heat. Less demanding heat retention films are used in warmer regions or for spring time applications. More demanding heat retention films are used in the winter months and in colder regions.

### Bags

Bags include those bag structures and bag applications known to those skilled in the art. Exemplary bags include shipping sacks, trash bags and liners, industrial liners, produce bags, and heavy duty bags.

### Packaging

Packaging includes those packaging structures and packaging applications known to those skilled in the art. Exemplary packaging includes flexible packaging, food packaging, e.g., fresh cut produce packaging, frozen food packaging, bundling, packaging and unitizing a variety of products. Applications for such packaging include various foodstuffs, rolls of carpet, liquid containers, and various like goods normally containerized and/or palletized for shipping, storage, and/or display.

### Blow Molded Articles

The polymers and compositions described above may also be used in blow molding processes and applications. Such processes are well known in the art, and involve a process of inflating a hot, hollow thermoplastic preform (or parison) inside a closed mold. In this manner, the shape of the parison conforms to that of the mold cavity, enabling the production of a wide variety of hollow parts and containers.

In a typical blow molding process, a parison is formed between mold halves and the mold is closed around the parison, sealing one end of the parison and closing the parison around a mandrel at the other end. Air is then blown through the mandrel (or through a needle) to inflate the parison inside the mold. The mold is then cooled and the part formed inside the mold is solidified. Finally, the mold is opened and the molded part is ejected. The process lends itself to any design having a hollow shape, including but not limited to bottles, tanks, toys, household goods, automobile parts, and other hollow containers and/or parts.

Blow molding processes may include extrusion and/or injection blow molding. Extrusion blow molding is typically suited for the formation of items having a comparatively heavy weight, such as greater than about 12 ounces, including but not limited to food, laundry, or waste containers. Injection blow molding is typically used to achieve accurate and uniform wall thickness, high quality neck finish, and to process polymers that cannot be extruded. Typical injection blow molding applications include, but are not limited to, pharmaceutical, cosmetic, and single serving containers, typically weighing less than 12 ounces.

### Injection Molded Articles

The polymers and compositions described above may also be used in injection molded applications. Injection molding is a process commonly known in the art, and is a process that usually occurs in a cyclical fashion. Cycle times generally range from 10 to 100 seconds and are controlled by the cooling time of the polymer or polymer blend used.

In a typical injection molding cycle, polymer pellets or powder are fed from a hopper and melted in a reciprocating screw type injection molding machine. The screw in the machine rotates forward, filling a mold with melt and holding the melt under high pressure. As the melt cools in the mold and contracts, the machine adds more melt to the mold to compensate. Once the mold is filled, it is isolated from the injection unit and the melt cools and solidifies. The solidified part is ejected from the mold and the mold is then closed to prepare for the next injection of melt from the injection unit.

Injection molding processes offer high production rates, good repeatability, minimum scrap losses, and little to no need for finishing of parts. Injection molding is suitable for a wide variety of applications, including containers, household goods, automobile components, electronic parts, and many other solid articles.

### Extrusion Coating

The polymers and compositions described above may be used in extrusion coating processes and applications. Extrusion coating is a plastic fabrication process in which molten polymer is extruded and applied onto a non-plastic support or substrate, such as paper or aluminum in order to obtain a multi-material complex structure. This complex structure typically combines toughness, sealing and resistance properties of the polymer formulation with barrier, stiffness or aesthetics attributes of the non-polymer substrate. In this process, the substrate is typically fed from a roll into a molten polymer as the polymer is extruded from a slot die, which is similar to a cast film process. The resultant structure is cooled, typically with a chill roll or rolls, and would into finished rolls.

Extrusion coating materials are typically used in food and non-food packaging, pharmaceutical packaging, and manufacturing of goods for the construction (insulation elements) and photographic industries (paper).

Tubing or pipe may be obtained by profile extrusion for uses in medical, potable water, land drainage applications or the like. Tubing or pipe may be unvulcanized or vulcanized. Vulcanization can be performed using, for example, a peroxide or silane during extrusion of the pipe. The profile extrusion process involves the extrusion of molten polymer through a die. The extruded tubing or pipe is then solidified by chill water or cooling air into a continuous extruded article.

### Foamed Articles

The polymers and compositions described above may be used in foamed applications. In an extrusion foaming process, a blowing agent, such as, for example, carbon dioxide, nitrogen, or a compound that decomposes to form carbon dioxide or nitrogen, is injected into a polymer melt by means of a metering unit. The blowing agent is then dissolved in the polymer in an extruder, and pressure is maintained throughout the extruder. A rapid pressure drop rate upon exiting the extruder creates a foamed polymer having a homogenous cell structure. The resulting foamed product is typically light, strong, and suitable for use in a wide range of applications in industries such as packaging, automotive, aerospace, transportation, electric and electronics, and manufacturing.

### Wire and Cable Applications

Also provided are electrical articles and devices including one or more layers formed of or comprising the polymers and compositions described above. Such devices include, for example, electronic cables, computer and computer-related equipment, marine cables, power cables, telecommunications cables or data transmission cables, and combined power/telecommunications cables.

Electrical devices described herein can be formed by methods well known in the art, such as by one or more extrusion coating steps in a reactor/extruder equipped with a cable die. Such cable extrusion apparatus and processes are well known. In a typical extrusion method, an optionally heated conducting core is pulled through a heated extrusion die, typically a cross-head die, in which a layer of melted polymer composition is applied. Multiple layers can be applied by consecutive extrusion steps in which additional layers are added, or, with the proper type of die, multiple layers can be added simultaneously. The cable can be placed in a moisture curing environment, or allowed to cure under ambient conditions.

This invention further relates to:
1. A supported catalyst system comprising: (i) at least one first catalyst component comprising a group 4 metallocycle containing metallocene complex; (ii) at least one second catalyst component comprising a 2,6-bis(imino)pyridyl iron complex; (iii) activator; and (iv) support; wherein, the group 4 metallocycle containing metallocene complex is represented by Formula (A):

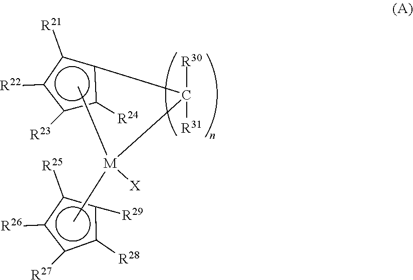

wherein:
M is hafnium;
each of R²¹, R²², R²³, R²⁴, R²⁵, R²⁶, R²⁷, R²⁸, and R²⁹ is independently hydrogen, alkoxide, C₁ to C₄₀ hydrocarbyl, or C₁ to C₄₀ substituted hydrocarbyl;
X is a univalent anionic ligand;
each of R³⁰ and R³¹ is independently hydrogen, a C₁-C₂₀ hydrocarbyl, a C₁-C₂₀ substituted hydrocarbyl, or R³⁰ and R³¹ join to form a C₂-C₄₀ substituted or unsubstituted, saturated, partially unsaturated, or unsaturated cyclic or polycyclic substituent;
n is 1, 2, 3, 4, 5, or 6; and
   the 2,6-bis(imino)pyridyl iron complex is represented by Formula (I):

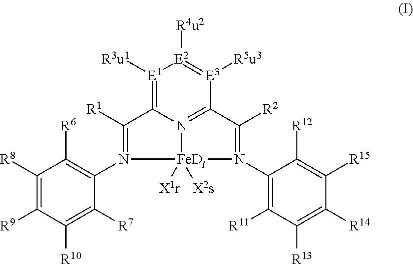

wherein:
each of R¹ and R² is independently hydrogen, C₁-C₂₂ alkyl, C₂-C₂₂ alkenyl, C₆-C₂₂ aryl, arylalkyl wherein alkyl has from 1 carbon atom to 10 carbon atoms and aryl has from 6 carbon atoms to 20 carbon atoms, or five-, or six-, or seven-membered heterocyclic ring comprising at least one atom selected from the group consisting of N, P, O and S; wherein each of RI and R² is optionally substituted by halogen, —OR¹⁶, —NR¹⁷₂, or —SiR¹⁸₃; wherein R¹ optionally bonds with R³, and R² optionally bonds with R⁵, in each case to independently form a five-, six-, or seven-membered ring;
each of R³, R⁴, R⁵, R⁸, R⁹, R¹⁰, R¹³, R¹⁴, and R¹⁵ is independently hydrogen, C₁-C₂₂ alkyl, C₂-C₂₂ alkenyl, C₆-C₂₂ aryl, arylalkyl wherein alkyl has from 1 to 10 carbon atoms and aryl has from 6 to 20 carbon atoms, —OR¹⁶, —NR¹⁷₂, halogen, —SiR¹⁸₃ or five-, six- or seven-membered heterocyclic ring comprising at least one atom selected from the group consisting of N, P, O and S;
wherein R³, R⁴, R⁵, R⁸, R⁹, R¹⁰, R¹³, R¹⁴, and R¹⁵ are optionally substituted by halogen, —OR¹⁶, —NR¹⁷₂, or —SiR¹⁸₃; wherein R³ optionally bonds with R⁴, R⁴ optionally bonds with R⁵, R⁷ optionally bonds with R¹⁰, R¹⁰ optionally bonds with R⁹, R⁹ optionally bonds with R⁸, R⁸ optionally bonds with R⁶, R¹⁵ optionally bonds with R¹⁴, R¹⁴ optionally bonds with R¹³, and R¹³ optionally bonds with R¹¹, in each case to independently form a five-, six- or seven-membered carbocyclic or heterocyclic ring, the heterocyclic ring comprising at least one atom from the group consisting of N, P, O and S;
each of R⁶, R⁷, R¹¹, and R¹² is independently C₁-C₂₂ alkyl, C₂-C₂₂ alkenyl, C₆-C₂₂ aryl, arylalkyl wherein alkyl has from 1 to 10 carbon atoms and aryl has from 6 to 20 carbon atoms, a heteroatom or a heteroatom-containing group (such as —OR¹⁶, —NR¹⁷₂, halogen, —SiR¹⁸₃ or five-, six- or seven-membered heterocyclic ring comprising at least one atom selected from the group consisting of N, P, O and S); wherein R⁶, R⁷, R¹¹, and R¹² are optionally substituted by halogen, —OR¹⁶, —NR¹⁷₂, or —SiR¹⁸₃, wherein R⁶ optionally bonds with R⁸, R¹¹ optionally bonds with R¹³, or R¹⁵ optionally bonds with R¹² in each case to independently form a five-, six- or seven-membered carbocyclic or heterocyclic ring, the heterocyclic ring comprising at least one atom from the group consisting of N, P, O and S; wherein at least one of R⁶, R⁷, R¹¹, and R¹² is independently a heteroatom or a heteroatom-containing group, or at least one of the R⁶, R⁷, R¹¹, and R¹² is not methyl, or if R¹¹ is H and R¹² is iPr, then at least one of R⁶ and R⁷ is not methyl;
each of R¹⁶, R¹⁷, and R¹⁸ is independently hydrogen, C₁-C₂₂ alkyl, C₂-C₂₂ alkenyl, C₆-C₂₂ aryl, arylalkyl where alkyl has from 1 to 10 carbon atoms and aryl has from 6 to 20 carbon atoms, or —SiR¹⁹₃, wherein each R¹⁶, R¹⁷, and R¹⁸ is independently optionally substituted by halogen, or two R¹⁶ radicals optionally bond to form a five- or six-membered ring, or two R¹⁷ radicals optionally bond to form a five- or six-membered ring, or two R¹⁸ radicals optionally bond to form a five- or six-membered ring;
each R¹⁹ is independently hydrogen, C₁-C₂₂ alkyl, C₂-C₂₂ alkenyl, C₆-C₂₂ aryl, arylalkyl where alkyl has from 1 to 10 carbon atoms and aryl has from 6 to 20 carbon atoms, or two R¹⁹ radicals optionally bond to form a five- or six-membered ring;
each of E¹, E², and E³ is independently carbon, nitrogen or phosphorus;
each of u¹, u², and u³ is independently 0 if E¹, E², or E³ is nitrogen or phosphorus, and each of u¹, u², and u³ is independently 1 if E¹, E², or E³ is carbon;
each of X¹ and X² is independently substituted hydrocarbyl, and the radicals X can be bonded with one another;
r is 1 or 2;
s is 1 or 2; D is a neutral donor; and
t is 0 to 2.
2. A supported catalyst system according to paragraph 1, wherein in the group 4 metallocycle containing metallocene complex:
   each of R²¹, R²², R²³, R²⁴, R²⁵, R²⁶, R²⁷, R²⁸, and R²⁹ is independently hydrogen, methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, nonyl, decyl, undecyl, docecyl, adamantanyl or an isomer thereof,
   X is chloro, fluoro, bromo, iodo methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, nonyl, decyl, undecyl, or docecyl;
   each of R³⁰ and R³¹ is independently hydrogen, such as methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, nonyl, or decyl or R³⁰ and R³¹ join to form a C₂-C₂₀ substituted or unsubstituted, saturated, partially unsaturated, or unsaturated cyclic or polycyclic substituent.
3. The supported catalyst system of paragraph 1, wherein at least one of R²¹, R²², R²³, R²⁴ is not hydrogen and at least one of R²⁵, R²⁶, R²⁷, R²⁸, and R²⁹ is not hydrogen.
4. The supported catalyst system of paragraph 1, wherein the group 4 metallocycle containing metallocene complex is present a molar ratio 1% to 99%, and the 2,6-bis(imino)pyridyl iron complex is present at a molar ratio of 99% to 1%, based on the combination of the catalyst compounds.
5. The supported catalyst system of paragraph 1, wherein the group 4 metallocycle containing metallocene complex is one or more of: (n-PrCp)(η5,κ1-C₅H₄CH₂CH₂CH₂—)Hf(n-Bu); (n-PrCp)(η5,κ1-C₅H₄CH₂CH₂CH₂—)Hf(n-Et); (Cp)(η5,κ1-C₅H₄CH₂CH₂CH₂—)Hf(n-Bu); (n-Me₃SiCH₂Cp)(η5,κ1-C₅H₄CH₂CH₂CH₂—)Hf(n-Bu); (n-PrCp)(η5,κ1-C₅H₄CH₂CH₂CH₂CH₂—)Hf(n-Bu); (n-BuCp)(η5,κ1-C₅H₄CH₂CH₂CH₂—)Hf(n-Bu); (1-Me,3-nBuCp)(η5,κ1-C₅H₄CH₂CH₂CH₂—)Hf(n-Bu); (Indenyl)(η5,κ1-C₅H₄CH₂CH₂CH₂—)Hf(n-Bu); and (Fluorenyl)(η5,κ1-C₅H₄CH₂CH₂CH₂—)Hf(n-Bu), where Cp is cyclopentadienyl.
6. The supported catalyst system of any of paragraphs 1 to 5, wherein the support comprises silica.
7. The supported catalyst system of any of paragraphs 1 to 6, wherein the catalyst system comprises less than 0.1 wt % aromatic solvent.
8. The supported catalyst system of any of paragraphs 1 to 7, wherein in the 2,6-bis(imino)pyridyl iron complex:
   each of E¹, E², and E³ is carbon;
   each of R¹ and R² is independently C₁-C₂₂ alkyl or C₆-C₂₂ aryl wherein each of R¹ and R² is optionally substituted by halogen; and
   each of R⁶, R⁷, R¹¹, and R¹² is independently selected from methyl, ethyl, tert-butyl, isopropyl, F, Br, C₁, and I.
9. The supported catalyst system of any of paragraphs 1 to 8, wherein the 2,6-bis(imino)pyridyl iron complex is one or more of: (1E,1′E)-1,1′-(pyridine-2,6-diyl)bis(N-(2-chloro-4,6-dimethylphenyl)ethan-1-imine)FeCl₃, the 2,6-bis(imino)pyridyl iron complex is one or more of: (1E,1′E)-1,1′-(pyridine-2,6-diyl)bis(N-(2-chloro-4,6-dimethylphenyl)ethan-1-imine)FeCl₃, (1E,1′E)-1,1′-(pyridine-2,6-diyl)bis(N-(2-chloro-4,6-dimethylphenyl)ethan-1-imine)FeCl₂, (1E,1′E)-1,1′-(pyridine-2,6-diyl)bis(N-(2-chloro-4,6-isopropylphenyl)ethan-1-imine)FeCl₂, (1E,1′E)-1,1′-(pyridine-2,6-diyl)bis(N-(2-chloro-4-methyl-6-tert-butylphenyl)ethan-1-imine)FeCl₂, (1E,1′E)-1,1′-(pyridine-2,6-diyl)bis(N-(2-chloro-6-methyl-phenyl)ethan-1-imine)FeCl₂, and (1E,1′E)-1,1′-(pyridine-2,6-diyl)bis(N-(2-chloro-6-methyl-phenyl)ethan-1-imine)FeCl₃.
10. A supported catalyst system according to any of the preceding paragraphs 1 to 9, wherein the support material has a surface area in the range of from 10 to 700 m²/g and an average particle diameter in the range of from 10 to 500 μm.
11. A supported catalyst system according to any of the preceding paragraphs 1 to 10, wherein the support material is selected from the group consisting of silica, alumina, silica-alumina, and combinations thereof.
12. A supported catalyst system of any of paragraphs 1 to 11, wherein the support material is flourided and preferably has a fluorine concentration in the range of 0.6 to 3.5 wt %, based upon the weight of the support material.
13. A supported catalyst system according to any of the preceding paragraphs 1 to 12, wherein the activator comprises alumoxane.
14. A supported catalyst system according to any of the preceding paragraphs 1 to 13, wherein the activator comprises a non-coordinating anion.
15. A supported catalyst system according to any of the preceding paragraphs 1 to 11, wherein the activator comprises one or more of N,N-dimethyl-anilinium [tetrakis(perfluorophenyl)borate], N,N-dimethylanilinium tetrakis(perfluoronaphthyl)borate, N,N-dimethylanilinium tetrakis(perfluorobiphenyl)borate, N,N-dimethylanilinium tetrakis(perfluorophenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, [Me₃NH⁺][B(C₆F₅)₄⁻]; 1-(4-(tris(pentafluorophenyl)borate)-2,3,5,6-tetrafluorophenyl) pyrrolidinium; 4-(tris(pentafluorophenyl)borate)-2,3,5,6-tetrafluoropyridine, N,N-di(hydrogenated tallow)methylammonium [tetrakis(perfluorophenyl) borate], N-methyl-4-nonadecyl-N-octadecylanilinium [tetrakis(perfluorophenyl)borate], N-methyl-4-hexadecyl-N-octadecylanilinium [tetrakis(perfluorophenyl)borate], N-methyl-4-tetradecyl-N-octadecylanilinium [tetrakis(perfluorophenyl)borate], N-methyl-4-dodecyl-N-octadecylanilinium [tetrakis(perfluorophenyl)borate], N-methyl-4-decyl-N-octadecylanilinium [tetrakis(perfluorophenyl)borate], N-methyl-4-octyl-N-octadecylanilinium [tetrakis(perfluorophenyl)borate], N-methyl-4-hexyl-N-octadecylanilinium [tetrakis(perfluorophenyl)borate], N-methyl-4-butyl-N-octadecylanilinium [tetrakis(perfluorophenyl)borate], N-methyl-4-octadecyl-N-decylanilinium [tetrakis(perfluorophenyl)borate], N-methyl-4-nonadecyl-N-dodecylanilinium [tetrakis(perfluorophenyl)borate], N-methyl-4-nonadecyl-N-tetradecylanilinium [tetrakis(perfluorophenyl)borate], N-methyl-4-nonadecyl-N-hexadecylanilinium [tetrakis(perfluorophenyl)borate], N-ethyl-4-nonadecyl-N-octadecylanilinium [tetrakis(perfluorophenyl)borate], N-methyl-N,N-dioctadecylammonium [tetrakis(perfluorophenyl)borate], N-methyl-N,N-dihexadecylammonium [tetrakis(perfluorophenyl)borate], N-methyl-N,N-ditetradecylammonium [tetrakis(perfluorophenyl)borate], N-methyl-N,N-didodecylammonium [tetrakis(perfluorophenyl)borate], N-methyl-N,N-didecylammonium [tetrakis(perfluorophenyl)borate], N-methyl-N,N-dioctylammonium [tetrakis(perfluorophenyl)borate], N-ethyl-N,N-dioctadecylammonium [tetrakis(perfluorophenyl)borate], N,N-di(octadecyl)tolylammonium [tetrakis(perfluorophenyl)borate], N,N-di(hexadecyl)tolylammonium [tetrakis(perfluorophenyl)borate], N,N-di(tetradecyl)tolylammonium [tetrakis(perfluorophenyl)borate], N,N-di(dodecyl)tolylammonium [tetrakis(perfluorophenyl)borate], N-octadecyl-N-hexadecyl-tolylammonium [tetrakis(perfluorophenyl)borate], N-octadecyl-N-hexadecyl-tolylammonium [tetrakis(perfluorophenyl)borate], N-octadecyl-N-tetradecyl-tolylammonium [tetrakis(perfluorophenyl)borate], N-octadecyl-N-dodecyl-tolylammonium [tetrakis(perfluorophenyl)borate], N-octadecyl-N-decyl-tolylammonium [tetrakis(perfluorophenyl)borate], N-hexadecyl-N-tetradecyl-tolylammonium [tetrakis(perfluorophenyl)borate], N-hexadecyl-N-dodecyl-tolylammonium [tetrakis(perfluorophenyl)borate], N-hexadecyl-N-decyl-tolylammonium [tetrakis(perfluorophenyl)borate], N-tetradecyl-N-dodecyl-tolylammonium [tetrakis(perfluorophenyl)borate], N-tetradecyl-N-decyl-tolylammonium [tetrakis(perfluorophenyl)borate], N-dodecyl-N-decyl-tolylammonium [tetrakis(perfluorophenyl)borate], N-methyl-N-octadecylanilinium [tetrakis(perfluorophenyl)borate], N-methyl-N-hexadecylanilinium [tetrakis(perfluorophenyl)borate], N-methyl-N-tetradecylanilinium [tetrakis(perfluorophenyl)borate], N-methyl-N-dodecylanilinium [tetrakis(perfluorophenyl)borate], N-methyl-N-decylanilinium [tetrakis(perfluorophenyl)borate], and N-methyl-N-octylanilinium [tetrakis(perfluorophenyl)borate].
16. A process for polymerization of olefin monomers comprising contacting one or more monomers with a supported catalyst system of any of paragraphs 1 to 15 and obtaining olefin polymer.
17. A process according to paragraph 16, wherein the first catalyst component and the second catalyst component show different hydrogen responses.
18. A process according to paragraph 16 or 17, wherein the monomer is selected from the group consisting of ethylene, propylene, 1-hexene, 1-octene and combinations thereof.
19. A process according to any of paragraphs 16 to 18, wherein the polymerization is carried out in slurry.
20. A process according to any of paragraphs 16 to 18, wherein the polymerization is carried out in gas phase.
21. A process according to any of paragraphs 16 to 20 further comprising obtaining a polyolefin having a multi-modal GPC trace.
22. A process to make an article comprising forming the olefin polymer obtain from the process of any of paragraphs 16 to 21 into an article.

### EXPERIMENTAL

### Test Methods

Melt Index (MI, I₂ or I_{2.16}) is determined according to ASTM D-1238 2.16 kg (MI), 190° C.

High Load Melt Index (HLMI, I₂₁ or I_{21.6}) is determined according to ASTM D-1238 21.6 kg (MI), 190° C.

Density is determined according to ASTM D1505, column density. Samples were molded under ASTM D4703-10a, Procedure C, then conditioned under ASTM D618-08 (23°±2° C. and 50±10% Relative Humidity) for 40 hours before testing.

Bulk Density is measured according to ASTM D1895.

Gel Permeation Chromotography “GPC” Characterization Procedure: Molecular Weight, Comonomer Composition and Long Chain Branching Determination by Polymer Char GPC-IR Hyphenated with Multiple Detectors:

Unless otherwise indicated, the distributions and the moments of molecular weight (Mw, Mn, Mw/Mn, etc.), the comonomer content (C₂, C₃, C₆, etc.) and the branching index (g′vis) are determined by using a high temperature Gel Permeation Chromatography (Polymer Char GPC-IR) equipped with a multiple-channel band-filter based Infrared detector IR5, an 18-angle Wyatt Dwan Heleos light scattering detector and a 4-capillary viscometer with Wheatstone bridge configuration. Three Agilent PLgel 10-μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1-μm Teflon filter and degassed with an online degasser before entering the GPC instrument. The nominal flow rate is 1.0 ml/min and the nominal injection volume is 200 μL. The whole system including transfer lines, columns, and viscometer detector are contained in ovens maintained at 145° C. The polymer sample is weighed and sealed in a standard vial with 80-μL flow marker (Heptane) added to it. After loading the vial in the autosampler, polymer is automatically dissolved in the instrument with 8 ml added TCB solvent. The polymer is dissolved at 160° C. with continuous shaking for about 2 hour. The concentration (c), at each point in the chromatogram is calculated from the baseline-subtracted IR5 broadband signal intensity (I), using the following equation: c=βI, where β is the mass constant. The mass recovery is calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10M gm/mole. The MW at each elution volume is calculated with following Equation (A):

$$log M = \frac{log ( {K}_{P S} / K )}{a + 1} + \frac{{a}_{P S} + 1}{a + 1} log {M}_{P S} \qquad ( A )$$

where the variables with subscript “PS” stand for polystyrene while those without a subscript are for the test samples. In this method, α_{PS}=0.67 and K_{PS}=0.000175, while α and K are for the reference linear polymer, which are, for purposes of this invention and claims thereto, α=0.705 and K=0.0002288 for linear propylene polymers, α=0.695 and K=0.000181 for linear butene polymers, α is 0.695 and K is 0.000579*(1−0.0087*w2b+0.000018*(w2b)\hat{ }2) for ethylene-butene copolymer where w2b is a bulk weight percent of butene comonomer, α is 0.695 and K is 0.000579*(1-0.0075*w2b) for ethylene-hexene copolymer where w2b is a bulk weight percent of hexene comonomer, α is 0.695 and K is 0.000579*(1−0.0077*w2b) for ethylene-octene copolymer where w2b is a bulk weight percent of octene comonomer, and α=0.695 and K=0.000579 for all other linear ethylene polymers. For other materials α and K are as calculated in the published in literature (see for example, Sun, T. et al. Macromolecules (2001) v.34, 6812). Concentrations are expressed in g/cm³, molecular weight is expressed in g/mole, and intrinsic viscosity (hence K in the Mark-Houwink equation) is expressed in dL/g unless otherwise noted. Here the concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards whose nominal value are predetermined by NMR or FTIR. In particular, this provides the methyl number per 1000 total carbons (CH₃/1000TC) as a function of molecular weight. The short-chain branch (SCB) content per 1000TC (SCB/1000TC) is then computed as a function of molecular weight by applying a chain-end correction to the CH₃/1000TC function, assuming each chain to be linear and terminated by a methyl group at each end.

The LS molecular weight (M) at each point in the chromatogram is determined by analyzing the LS output using the Zimm model for static light scattering

$$\frac{{K}_{o} c}{Δ R ( θ )} = \frac{1}{M P ( θ )} + 2 {A}_{2} c .$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and Kₒ is the optical constant for the system:

$${K}_{o} = \frac{4 {π}^{2} {{n}^{2} ( dn / dc )}^{2}}{{λ}^{4} {N}_{A}}$$

where N_{A} is Avogadro's number, and (dn/dc) is the refractive index increment for the system. The refractive index, n=1.500 for TCB at 145° C. and k=665 nm. For analyzing PE polymers, dn/dc=0.1048 ml/mg and A₂=0.0015.

A high temperature Polymer Char viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, η_{S}, for the solution flowing through the viscometer is calculated from their outputs. The intrinsic viscosity, [η], at each point in the chromatogram is calculated from the equation [η]=η_{S}/c, where c is concentration and is determined from the IR5 broadband channel output.

The branching index (g′ᵥᵢₛ) is calculated using the output of the GPC-IR5-LS-VIS method as follows. The average intrinsic viscosity, [η]_{avg}, of the sample is calculated by:

$${[ η ]}_{a v g} = \frac{\sum {{c}_{i} [ η ]}_{i}}{\sum {c}_{i}}$$

where the summations are over the chromatographic slices, i, between the integration limits. The branching index g′ᵥᵢₛ is defined as

$${g}_{vis}^{′} = \frac{{[ η ]}_{avg}}{K {M}_{v}^{α}} ,$$

where M_{V} is the viscosity-average molecular weight based on molecular weights determined by LS analysis and the K and α for the reference linear polymer are as described above for Equation (A).

Unless otherwise indicated, room/ambient temperature is approximately 23° C.

### Materials

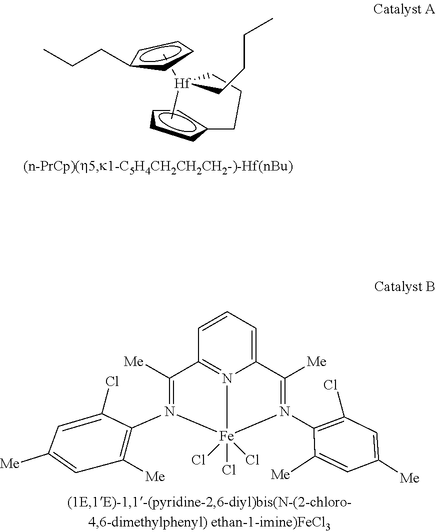

ES70™ silica was obtained from PQ Corporation (Conshohocken, Pennsylvania).

Methylalumoxane (MAO) was obtained from Grace (30 wt % in toluene).

Catalyst C (nPrCp)₂HfCl₂ was prepared and supported in a method similar to that described in U.S. Pat. No. 7,172,816 to obtain Catalyst C and MAO activator supported on silica.

### General Considerations and Reagents

All manipulations were performed under an inert atmosphere using glove box techniques unless otherwise stated. Toluene and Pentane (Sigma Aldrich) were degassed and dried over 3 Å molecular sieves overnight prior to use. Methylalumoxane was purchased from Grace and used as received.

Catalyst A ((propylcyclopentadienyl)(propylenecyclopentadienyl)hafnium n-butyl) was prepared in a manner similar to the procedure in Organometallics (2017) v.36, pp. 3443-3455. An amber solution of bis(n-propylcyclopentadienyl)hafnium dibutyl (4.00 g, 7.89 mmol) in toluene (40 mL) was heated to 90° C. The solution became clear pale violet after stirring 1 hour at 90° C. The reaction was clear violet after stirring 17 hours at 90° C. The reaction was allowed to cool to room temperature, and then was evaporated under vacuum, leaving a violet liquid. The liquid was extracted with pentane (30 mL, then 3×5 mL) and filtered through celite to give a magenta solution. The solution was evaporated under vacuum to give a magenta oil. Yield 3.54 g (99%). ¹H NMR (C₆D₆) δ 5.68 (m, 1H), 5.56 (m, 1H), 5.52 (m, 1H), 5.43 (m, 2H), 5.06 (m, 1H), 4.94 (m, 1H), 2.68-2.73 (m, 2H), 2.58-2.60 (m, 1H), 2.21-2.31 (m, 3H), 1.50-1.59 (m, 1H), 1.47 (q, 2H), 1.39 (m, 3H), 1.05 (t, 3H), 0.86 (t, 3H), 0.43 (m, 1H), 0.28 (m, 1H), 0.03 (m, 1H), −0.10 (m, 1H).

Catalyst B ((1E,1′E)-1,1′-(pyridine-2,6-diyl)bis(N-(2-chloro-4,6-dimethylphenyl) ethan-1-imine)FeCl₃,) was prepared as follows:

### (1E,1′E)-1,1′-pyridine-2,6-diyl)bis(N-(2-chloro-4,6-dimethylphenyl)ethan-1-imine

2,6-bisacetyl pyridine (4.409 g, 0.027 mol) and 2-chloro-4,6-dimethylaniline (9.252 g, 0.059 mol) were dissolved in ethanol and few drops of acetic acid were added to the mixture and the reaction mixture was refluxed for 3 days resulting in the formation of mono-substituted derivative. Another equivalent of aniline was added and refluxed in toluene in the presence of molecular sieves. The crude was filtered out and the solvent was dried under vacuum. The crude material was dissolved in minimal amount of toluene and product was crystallized out as a yellow solid. The product was isolated and washed with cold pentane and dried under vacuum (2.598 g, 60%). ¹H NMR (400 MHz, CD₂Cl₂, ppm) δ: 8.50, 7.99, 7.15, 7.03, 2.35, 2.10.

2,6-bis-[1-(2-chloro-4,6-dimethylphenylimino)ethyl]pyridine iron trichloride (Catalyst B): A 100 mL round-bottom flask containing a magnetic stirbar was charged with (1E,1′E)-1,1′-(pyridine-2,6-diyl)bis(N-(2-chloro-4,6-dimethylphenyl)ethan-1-imine) (5.00 g, 11.4 mmol) and THF (50 mL) to give a vibrant yellow solution. FeCl3 (1.85, 11.4 mmol) was weighed into a vial and then added to the yellow solution, immediately giving an intensely dark brown mixture. The resultant mixture was stirred at ambient temperature under N₂ for 21 hours before volatiles were removed by passing N₂ over the mixture. A dark brown oily substance remained, which was then washed with 3×50 mL portions of Et2O followed by 50 mL of pentane, resulting in a dark brown fine powder. The brown powder was briefly dried in vacuo to remove residual solvent. Next, approximately 50 mL of DCM were added to the flask containing the brown powder and stirred at ambient temperature overnight. After stirring overnight, the intensely dark brown mixture was filtered, removing a dark solid and giving a dark brown filtrate. The brown solid was then washed with excess DCM (3×150 mL) until only a small amount of dark insoluble solid remained on the filter. The dark brown filtrate was then taken to dryness by passing N₂ over the solution and subsequently drying the resultant solid in vacuo for 3 hours, yielding a dark brown powder in 5.07 g (74.0%) yield.

Bis(n-propylcyclopentadienyl)hafnium di-n-butyl (used for preparation of Catalyst A): To a dark amber suspension of bis(n-propylcyclopentadienyl)hafnium dichloride (5.74 g, 12.4 mmol, 1.00 eq) in toluene (50 mL) at −35° C. was added 2.48M n-butyllithium in hexanes (10.0 mL, 24.8 mmol, 2.00 eq) to give an amber solution. The reaction was cloudy amber after warming to room temperature and stirring for 2 hours. The mixture was evaporated under vacuum, leaving a brown liquid. The liquid was extracted with pentane (40 mL, then 3×5 mL) and filtered through celite to give a pale amber solution. The solution was evaporated under vacuum, leaving an amber liquid. Yield 6.22 g (99%). ¹H NMR (C₆D₆) δ 5.64 (m, 4H), 5.60 (m, 4H), 1.51 (m, 8H), 1.40 (m, 4H), 1.04 (t, 6H), 0.88 (t, 6H), 0.17 (m, 4H).

### Support of Catalysts A and B on Silica (50:50)

ES70™ Silica, calcined at 875° C. or more, (35 g) was loaded in a 500 ml Celestir™ followed by the addition of 100 ml of toluene. The mixture was stirred for few seconds to achieve homogeneity. MAO (42.0 g) was added to the Celstir™ through the side arm slowly over 15 minutes with constant stirring, resulting in an exothermic reaction. The resultant mixture was allowed to stir for 1 hour at room temperature under N₂. Then Catalyst A (427 mg) was added to the mixture in a single portion followed by the addition of Catalyst B (571 mg). The resultant mixture was stirred overnight at room temperature under N₂. After stirring overnight, the supported catalyst was collected on a frit funnel and washed with toluene and hexanes. The supported catalyst was pumped in vacuum overnight to remove residual solvent. The supported catalyst was slurried in Sonojell™ to give a 10% by wt. slurry.

### Support of Catalyst a on Silica

ES70™ Silica, calcined at 875° C. or more, (38.9 g) was loaded in a 500 ml Celestir™ followed by the addition of 100 ml of toluene. The mixture was stirred for few seconds to achieve homogeneity. MAO (472.0 g) was added to the Celstir™ through the side arm slowly over 15 minutes with constant stirring, resulting in an exothermic reaction. The resultant mixture was allowed to stir for 1 hour at room temperature under N₂. Then Catalyst A (614 mg) was added to the mixture in a single portion. The resultant mixture was stirred for three hours at room temperature under N₂. After stirring overnight, the supported catalyst was collected on a frit funnel and washed with toluene and hexanes. The supported catalyst was pumped in vacuum overnight to remove residual solvent. The supported catalyst was slurried in Sonojell™ to give a 10% by wt. slurry

### Polymerization

### Examples 1-2

Polymerization was performed in a 7 foot tall gas-phase fluidized bed reactor with a 4 foot tall 6″ diameter body and a 3 foot tall 10″ diameter expanded section. Cycle and feed gases were fed into the reactor body through a perforated distributor plate, and the reactor was controlled at 300 psi and 70 mol % ethylene. Reactor temperature was maintained by heating the cycle gas. Supported catalyst was fed as a 10 wt % slurry in Sono Jell® from Sonneborn (Parsippany, NJ). The slurry was delivered to the reactor by nitrogen and isopentane feeds in a ⅛″ diameter catalyst probe. Polymer was collected from the reactor as necessary to maintain the desired bed weight. Average process conditions are shown in Table 1A below.

The run began with no hydrogen or hexane feeds to the reactor, and any hydrogen produced was produced by catalyst. Comonomer (1-hexene) was then introduced and the product was allowed to stabilize before collecting data. Polymer characterization data are reported in Table 1B.

TABLE 1A
Average process conditions for collection

| | Example 1 | Example 2 |
|---|---|---|
| Supported Catalyst A/Catalyst B | (50:50) | (50:50) |
| PROCESS DATA | | |
| H2 conc. (molppm) | 14 | 14 |
| C6/C2 Ratio (mol %/mol %) | 0.0001 | 0.0195 |
| Comonomer conc. (mol %) | 0.00 | 1.37 |
| C2 conc. (mol %) | 70.0 | 70.3 |
| Comonomer/C2 Flow Ratio | 0.000 | 0.040 |
| C2 flow (g/hr) | 1685 | 1703 |
| C6/C2 Ratio (mol %/mol %) | 0.0001 | 0.0195 |
| H2/C2 Ratio | 2.9 | 11.4 |
| Rx. Pressure (psig) | 300 | 300 |
| Reactor Temp (F.) | 185 | 185 |
| Avg. Bedweight (g) | 2436 | 2434 |
| Production (g/hr) | 306 | 239 |
| Residence Time (hr) | 8.0 | 10.2 |
| C2 Utilization (gC2/gC2 poly) | 4.82 | 5.95 |
| Rx. Pressure SP (psig) | 300 | 300 |
| Reactor Temp SP (° F.) | 198 | 198 |
| Residence Time (hr) | 7.3 | 7.7 |
| Catalyst Feed (g/hr) | 0.211 | 0.289 |
| Cat Activity (g poly/g cat) | 1519 | 1020 |
| Melt Index (MI) g/10 min | 0.25 | 5.36 |
| Bulk Density g/cm³ | 0.3010 | 0.4110 |

TABLE 1B

| | Example 1 | Example 2 |
|---|---|---|
| Supported Catalyst A/Catalyst B | (50:50) | (50:50) |
| I₂ (g/10 min) | 0.25 | 5.36 |
| I₂₁ (g/10 min) | 57.7 | 516.5 |
| I₂₁/I₂ | 227.55 | 96.36 |
| Density (g/cm³) | — | 0.9563 |
| Mₙ (g/mol) | 7,763 | 6,052 |
| M_{w} (g/mol) | 215,681 | 133,049 |
| M_{z} (g/mol) | 1,681,236 | 1,490,276 |
| M_{w}/Mₙ | 27.8 | 22.0 |
| M_{z}/M_{w} | 0.54 | 11.2 |
| Hexene (wt %) | 0.07 | 2.86 |
| g′(ᵥᵢₛ) | 0.961 | 0.917 |
| Composition Distribution Index | 1.5 | 3.5 |
| Mh (g/mol) | 4,265,795 | 2,691,534 |

Co-supporting Catalyst A and Catalyst B provides active mixed catalyst systems with contribution from both catalyst types yielding polymers with broad multimodal behavior. Uniquely, Catalyst B is unresponsive to hydrogen, producing a low Mw high density PE component, while Catalyst A is responsive to hydrogen producing a higher Mw polymer, where the high molecular weight polymer component is controlled by process hydrogen in the reactor and dictates the molecular weight broadness and bimodality of the low density and high density populations.

As illustrated in FIG. 1, the polyethylene compositions of Example 1 and Example 2 are bimodal or multimodal in nature. There are at least two distinguishable peaks in molecular weight distribution curve (as determined by GPC) of polyethylene composition Example 1. For polyethylene composition Example 2, there is no obvious valley between the peaks, but the presence of two distinguishable polyethylene population can be seen from the shoulder-like curvature change on the high molecular weight side.

Also illustrated in FIG. 1 is the comonomer distribution of the polyethylene compositions of Example 1 and 2. Even at very low total comonomer concentration of less than 1 Wt. %, FIG. 1, Example 1 Wt. % C₆ shows the cononomer content is higher on the high molecular weight polyethylene fractions. The CDI of Example 1 is approximately 1.5, which is significantly higher than 1, and indicates the comonomer distribution type is BOCD in nature. With total comonomer concentration significantly higher at over 2 wt. %, FIG. 1, Example 2 Wt. % C₆ shows the cononomer content is predominately in the high molecular weight polyethylene fractions, to as much as about 10 wt % of C₆ for molecules over 250,000 g/mol. The CDI of Example 2 is approximately 3.5, which indicates very strong BOCD characteristics.

### Examples 3-8

Another campaign was conducted according to the polymerization procedure above with supported Catalyst A and supported Catalyst C, except that the polymerization was run at constant H₂ and varying C₆/C₂ feed ratio to the reactor to adjust resin density with no other process moves. Decreasing density resulted in increased MI and slightly increased, though still similar, resin bulk density. Catalyst A showed somewhat similar process behavior, though with slightly lower catalyst productivity at the same process conditions. The results for this campaign are shown in Table 2.

TABLE 2
Average process conditions for collection.

| Example | 3 | 4 | 5 | 6 | 7 | 8 |
|---|---|---|---|---|---|---|
| Supported Catalyst | C | C | C | A | A | A |
| PROCESS DATA | | | | | | |
| H2 conc. (molppm) | 365 | 366 | 364 | 365 | 365 | 365 |
| C₆/C₂ Ratio | 0.015 | 0.013 | 0.009 | 0.015 | 0.013 | 0.009 |
| (mol %/mol %) | | | | | | |
| Comonomer conc. | 1.07 | 0.88 | 0.61 | 1.07 | 0.88 | 0.63 |
| (mol %) | | | | | | |
| C_{₂}conc. (mol %) | 69.9 | 70.2 | 70.1 | 69.9 | 70.1 | 70.1 |
| Comonomer/C₂ Flow | 0.051 | 0.038 | 0.025 | 0.050 | 0.038 | 0.025 |
| Ratio | | | | | | |
| C₂ flow (g/hr) | 1636 | 1598 | 1612 | 1609 | 1907 | 1918 |
| Rx. Pressure (psig) | 300 | 300 | 300 | 300 | 300 | 300 |
| Reactor Temp (F.) | 185 | 185 | 185 | 185 | 185 | 185 |
| Residence Time (hr) | 4.6 | 5.1 | 5.0 | 4.6 | 4.0 | 4.2 |
| Cat Activity (g poly/g | 3125 | 2899 | 3217 | 2766 | 2567 | 2527 |
| cat) | | | | | | |
| Bulk Density g/cm³ | 0.4439 | 0.4398 | 0.4224 | 0.4396 | 0.4263 | 0.4295 |
| Product Data | | | | | | |
| Melt Index | 0.65 | 1.32 | 2.77 | 0.66 | 1.43 | 2.88 |
| (MI)g/10 min | | | | | | |
| HLMI g/10 min | 13.37 | 27.23 | 51.94 | 13.85 | 27.90 | 52.61 |
| HLMI/MI Ratio | 20.63 | 20.58 | 18.76 | 21.09 | 19.46 | 18.27 |
| Gradient Density | 0.9169 | 0.9226 | 0.9315 | 0.9178 | 0.9241 | 0.9302 |
| g/cm³ | | | | | | |
| Mₙ (g/mol) | 26,063 | 23,268 | 21,487 | 23,702 | 21,915 | 20,305 |
| M_{w} (g/mol) | 130,895 | 107,369 | 89,269 | 129,106 | 103,486 | 85,094 |
| M_{z} (g/mol) | 287,183 | 241,890 | 197,584 | 282,970 | 218,878 | 173,534 |
| M_{w}/Mₙ | 5.0 | 4.6 | 4.2 | 5.4 | 4.7 | 4.2 |
| M_{z}/M_{w} | 2.2 | 2.3 | 2.2 | 2.2 | 2.1 | 2.0 |
| hexene (wt %) | 7.9 | 5.5 | 3.6 | 7.4 | 5.3 | 3.6 |
| g′(ᵥᵢₛ) | 0.988 | 0.991 | 0.993 | 0.994 | 0.987 | 0.993 |

All documents described herein are incorporated by reference herein, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including.” Likewise whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa, e.g., the terms “comprising,” “consisting essentially of,” “consisting of” also include the product of the combinations of elements listed after the term.

What is claimed is:

1. A supported catalyst system comprising: (i) at least one first catalyst component comprising a group 4 metallocycle containing metallocene complex; (ii) at least one second catalyst component comprising a 2,6-bis(imino)pyridyl iron complex; (iii) activator; and (iv) support; wherein, the group 4 metallocycle containing metallocene complex is represented by Formula (A): 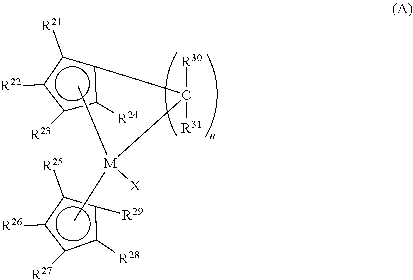
wherein:
M is hafnium;
each of R²¹, R²², R²³, R²⁴, R²⁵, R²⁶, R²⁷, R²⁸, and R²⁹ is independently hydrogen, alkoxide, C₁ to C₄₀ hydrocarbyl, or C₁ to C₄₀ substituted hydrocarbyl or any of two of R²¹, R²², R²³, and R²⁴ or any two of R²⁵, R²⁶, R²⁷, R²⁸, and R²⁹ may form a cyclic or multicyclic groups;
X is a univalent anionic ligand;
each of R³⁰ and R³¹ is independently hydrogen, a C₁-C₂₀ hydrocarbyl, a C₁-C₂₀ substituted hydrocarbyl, or R³⁰ and R³¹ join to form a C₂-C₄₀ substituted or unsubstituted, saturated, partially unsaturated, or unsaturated cyclic or polycyclic substituent;
n is 1, 2, 3, 4, 5, or 6; and
the 2,6-bis(imino)pyridyl iron complex is represented by Formula (I): 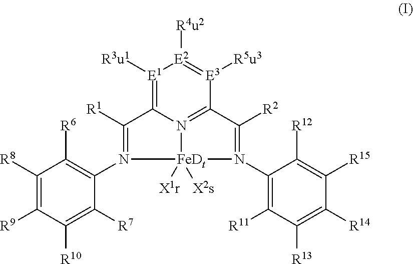
wherein:
each of R¹ and R² is independently hydrogen, C₁-C₂₂ alkyl, C₂-C₂₂ alkenyl, C₆-C₂₂ aryl, arylalkyl wherein alkyl has from 1 carbon atom to 10 carbon atoms and aryl has from 6 carbon atoms to 20 carbon atoms, or five-, or six-, or seven-membered heterocyclic ring comprising at least one atom selected from the group consisting of N, P, O and S; wherein each of R¹ and R² is optionally substituted by halogen, —OR¹⁶, —NR¹⁷₂, or —SiR¹⁸₃; wherein R¹ optionally bonds with R³, and R² optionally bonds with R⁵, in each case to independently form a five-, six-, or seven-membered ring;
each of R³, R⁴, R⁵, R⁸, R⁹, R¹⁰, R¹³, R¹⁴, and R¹⁵ is independently hydrogen, C₁-C₂₂ alkyl, C₂-C₂₂ alkenyl, C₆-C₂₂ aryl, arylalkyl wherein alkyl has from 1 to 10 carbon atoms and aryl has from 6 to 20 carbon atoms, —OR¹⁶, —NR¹⁷₂, halogen, —SiR¹⁸₃ or five-, six- or seven-membered heterocyclic ring comprising at least one atom selected from the group consisting of N, P, O and S;
wherein R³, R⁴, R⁵, R⁸, R⁹, R¹⁰, R¹³, R¹⁴, and R¹⁵ are optionally substituted by halogen, —OR¹⁶, —NR¹⁷₂ or —SiR¹⁸₃; wherein R³ optionally bonds with R⁴, R⁴ optionally bonds with R⁵, R⁷ optionally bonds with R¹⁰, R¹⁰ optionally bonds with R⁹, R⁹ optionally bonds with R⁸, R⁸ optionally bonds with R⁶, R¹⁵ optionally bonds with R¹⁴, R¹⁴ optionally bonds with R¹³, and R¹³ optionally bonds with R¹¹, in each case to independently form a five-, six- or seven-membered carbocyclic or heterocyclic ring, the heterocyclic ring comprising at least one atom from the group consisting of N, P, O and S;
each of R⁶, R⁷, R¹¹, and R¹² is independently C₁-C₂₂ alkyl, C₂-C₂₂ alkenyl, C₆-C₂₂ aryl, arylalkyl wherein alkyl has from 1 to 10 carbon atoms and aryl has from 6 to 20 carbon atoms, a heteroatom or a heteroatom-containing group (such as —OR¹⁶, —NR¹⁷₂, halogen, —SiR¹⁸₃ or five-, six- or seven-membered heterocyclic ring comprising at least one atom selected from the group consisting of N, P, O and S); wherein R⁶, R⁷, R¹¹, and R¹² are optionally substituted by halogen, —OR¹⁶, —NR¹⁷₂, or —SiR¹⁸₃, wherein R⁶ optionally bonds with R⁸, R¹¹ optionally bonds with R¹³, or R¹⁵ optionally bonds with R¹² in each case to independently form a five-, six- or seven-membered carbocyclic or heterocyclic ring, the heterocyclic ring comprising at least one atom from the group consisting of N, P, O and S; wherein at least one of R⁶, R⁷, R¹¹, and R¹² is independently a heteroatom or a heteroatom-containing group, or at least one of the R⁶, R⁷, R¹¹, and R¹² is not methyl, or if R¹¹ is H and R¹² is iPr, then at least one of R⁶ and R⁷ is not methyl;
each of R¹⁶, R¹⁷, and R¹⁸ is independently hydrogen, C₁-C₂₂ alkyl, C₂-C₂₂ alkenyl, C₆-C₂₂ aryl, arylalkyl where alkyl has from 1 to 10 carbon atoms and aryl has from 6 to 20 carbon atoms, or —SiR¹⁹₃, wherein each R¹⁶, R¹⁷, and R¹⁸ is independently optionally substituted by halogen, or two R¹⁶ radicals optionally bond to form a five- or six-membered ring, or two R¹⁷ radicals optionally bond to form a five- or six-membered ring, or two R¹⁸ radicals optionally bond to form a five- or six-membered ring;
each R¹⁹ is independently hydrogen, C₁-C₂₂ alkyl, C₂-C₂₂ alkenyl, C₆-C₂₂ aryl, arylalkyl where alkyl has from 1 to 10 carbon atoms and aryl has from 6 to 20 carbon atoms, or two R¹⁹ radicals optionally bond to form a five- or six-membered ring;
each of E¹, E², and E³ is independently carbon, nitrogen or phosphorus;
each of u¹, u², and u³ is independently 0 if E¹, E², or E³ is nitrogen or phosphorus, and each of u¹, u², and u³ is independently 1 if E¹, E², or E³ is carbon;
each of X¹ and X² is independently substituted hydrocarbyl, and the radicals X can be bonded with one another;
r is 1 or 2;
s is 1 or 2;
D is a neutral donor; and
t is 0 to 2.

2. A supported catalyst system according to claim 1, wherein in the group 4 metallocycle containing metallocene complex:
each of R²¹, R²², R²³, R²⁴, R²⁵, R²⁶, R²⁷, R²⁸, and R²⁹ is independently hydrogen, methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, nonyl, decyl, undecyl, docecyl, adamantanyl or an isomer thereof;
X is chloro, fluoro, bromo, iodo methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, nonyl, decyl, undecyl, or docecyl;
each of R³⁰ and R³¹ is independently hydrogen, such as methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, nonyl, or decyl or R³⁰ and R³¹ join to form a C₂-C₂₀ substituted or unsubstituted, saturated, partially unsaturated, or unsaturated cyclic or polycyclic substituent.

3. The supported catalyst system of claim 1, wherein at least one of R²¹, R²², R²³, R²⁴, is not hydrogen and at least one of R²⁵, R²⁶, R²⁷, R²⁸, and R²⁹ is not hydrogen.

4. The supported catalyst system of claim 2, wherein the group 4 metallocycle containing metallocene complex is present a molar ratio 1% to 99%, and the 2,6-bis(imino)pyridyl iron complex is present at a molar ratio of 99% to 1%, based on the combination of the catalyst compounds.

5. The supported catalyst system of claim 1, wherein the group 4 metallocycle containing metallocene complex is one or more of:
(n-PrCp)(η5,κ1-C₅H₄CH₂CH₂CH₂—)Hf(n-Bu);
(n-PrCp)(η5,κ1-C₅H₄CH₂CH₂CH₂—)Hf(n-Et);
(Cp)(η5,κ1-C₅H₄CH₂CH₂CH₂—)Hf(n-Bu);
(n-Me₃SiCH₂Cp)(η5,κ1-C₅H₄CH₂CH₂CH₂—)Hf(n-Bu);
(n-PrCp)(η5,κ1-C₅H₄CH₂CH₂CH₂CH₂—)Hf(n-Bu);
(n-BuCp)(η5,κ1-C₅H₄CH₂CH₂CH₂—)Hf(n-Bu);
(1-Me,3-nBuCp)(η5,κ1-C₅H₄CH₂CH₂CH₂—)Hf(n-Bu);
(Indenyl)(η5,κ1-C₅H₄CH₂CH₂CH₂—)Hf(n-Bu); and
(Fluorenyl)(η5,κ1-C₅H₄CH₂CH₂CH₂—)Hf(n-Bu), where Cp is cyclopentadienyl.

6. The supported catalyst system of claim 1, wherein the support comprises silica.

7. The supported catalyst system of claim 1, wherein the catalyst system comprises less than 0.1 wt % aromatic solvent.

8. The supported catalyst system of claim 1, wherein in the 2,6-bis(imino)pyridyl iron complex:
each of E¹, E², and E³ is carbon;
each of R¹ and R² is independently C₁-C₂₂ alkyl or C₆-C₂₂ aryl wherein each of R¹ and R² is optionally substituted by halogen; and
each of R⁶, R⁷, R¹¹, and R¹² is independently selected from methyl, ethyl, tert-butyl, isopropyl, F, Br, Cl, and I.

9. The supported catalyst system of claim 1, wherein the 2,6-bis(imino)pyridyl iron complex is one or more of:
(1E,1′E)-1,1′-(pyridine-2,6-diyl)bis(N-(2-chloro-4,6-dimethylphenyl)ethan-1-imine)FeCl₃, (1E,1′E)-1,1′-(pyridine-2,6-diyl)bis(N-(2-chloro-4,6-dimethylphenyl)ethan-1-imine)FeCl₂, (1E,1′E)-1,1′-(pyridine-2,6-diyl)bis(N-(2-chloro-4,6-isopropylphenyl)ethan-1-imine)FeCl₂, (1E,1′E)-1,1′-(pyridine-2,6-diyl)bis(N-(2-chloro-4-methyl-6-tert-butylphenyl)ethan-1-imine)FeCl₂, (1E,1′E)-1,1′-(pyridine-2,6-diyl)bis(N-(2-chloro-6-methyl-phenyl)ethan-1-imine)FeCl₂, and (1E,1′E)-1,1′-(pyridine-2,6-diyl)bis(N-(2-chloro-6-methyl-phenyl)ethan-1-imine)FeCl₃.

10. A supported catalyst system according to claim 1, wherein the support material has a surface area in the range of from 10 to 700 m²/g and an average particle diameter in the range of from 10 to 500 μm.

11. A supported catalyst system according to claim 1, wherein the support material is selected from the group consisting of silica, alumina, silica-alumina, and combinations thereof.

12. A supported catalyst system of claim 1, wherein the support material is flourided and preferably has a fluorine concentration in the range of 0.6 to 3.5 wt %, based upon the weight of the support material.

13. A supported catalyst system according to claim 1, wherein the activator comprises alumoxane.

14. A supported catalyst system according to claim 1, wherein the activator comprises a non-coordinating anion.

15. A supported catalyst system according to claim 11, wherein the activator comprises alumoxane.

16. A process for polymerization of olefin monomers comprising contacting one or more monomers with a supported catalyst system of claim 1 and obtaining olefin polymer, wherein the olefin polymer optionally has a multi-modal GPC trace.

17. A process according to claim 16, wherein the first catalyst component and the second catalyst component show different hydrogen responses.

18. A process according to claim 16, wherein the monomer is selected from the group consisting of ethylene, propylene, 1-hexene, 1-octene and combinations thereof.

19. A process according to claim 16, wherein the polymerization is carried out in slurry phase or in gas phase.

20. (canceled)

21. (canceled)

22. A process to make an article comprising forming the olefin polymer obtained from the process of claim 16 into an article.
